(19) United States
(12) Patent Application Publication
(10) Pub. No.: US 2016/0170482 A1
(43) Pub. Date: Jun. 16, 2016

(54) DISPLAY APPARATUS, AND CONTROL METHOD FOR DISPLAY APPARATUS

(71) Applicant: SEIKO EPSON CORPORATION, Tokyo (JP)

(72) Inventors: Kenro YAJIMA, Matsumoto-shi (JP); Yutaka FUJIMAKI, Matsumoto-shi (JP); Yuichi MORI, Minowa-machi (JP)

(73) Assignee: SEIKO EPSON CORPORATION, Tokyo (JP)

(21) Appl. No.: 14/968,384

(22) Filed: Dec. 14, 2015

(30) Foreign Application Priority Data
Dec. 15, 2014 (JP) 2014-253100
Feb. 27, 2015 (JP) 2015-038654
Nov. 6, 2015 (JP) 2015-218180

(51) Int. Cl. G06F 3/01; G02B 27/00; G02B 27/01

(52) U.S. Cl. CPC G06F 3/012; G02B 27/0172; G02B 27/0093; G06F 3/013; G02B 2027/0138; G02B 2027/014; G02B 2027/0178

(57) ABSTRACT

A head mounted display apparatus includes an image display section that irradiates the eyes of a user with image light, and a first sensor and a second sensor as a plurality of motion sensors that are disposed at positions deviated relative to the user's body in a mounting state of the display apparatus.

### BACKGROUND

1. Technical Field

The present invention relates to a display apparatus, and a control method for the display apparatus.

2. Related Art

In the related art, a display apparatus mounted on the head is known (for example, refer to JP-A-2011-2753). A display disclosed in JP-A-2011-2753 is a display in which a see-through light guide portion is provided at a spectacle type frame, and an imaging device is attached to the frame. The display generates correction data by matching an image captured by the imaging device with an image of a target object which is visually recognized by a user through the light guide portion, and matches imaging data with a user's visual field on the basis of the correction data. Consequently, an augmented reality (AR) technique is realized in which various data regarding the target object is displayed so as to overlap the image of the target object.

An example is known in which an apparatus mounted on the head detects a motion of the head (for example, refer to JP-A-2014-137522). JP-A-2014-137522 discloses a spectacle type operation device which is provided with a spectacle type frame and in which sensors are provided at temples of the spectacles. The device detects an action such as a user moving the head or moving the eyes on the basis of detection signals from the sensors.

As disclosed in JP-A-2011-2753, in the display apparatus mounted on the head, display may be controlled in accordance with a motion of the head. In this case, a motion may be detected by using a sensor as disclosed in JP-A-2014-137522. If a motion at a movement center can be directly detected, an action quantity or a direction of an action can be simply and accurately obtained, but it is not generally easy to dispose a sensor at a position corresponding to the movement center in a user's body.

### SUMMARY

An advantage of some aspects of the invention is to provide a head mounted display apparatus which can rapidly perform a process corresponding to a motion at a movement center in relation to a motion of a user's body.

An aspect of the invention is directed to a head mounted display apparatus mounted on the head of a user, the display apparatus including a display unit that irradiates the eyes of the user with image light; and a plurality of motion sensors that are disposed at positions deviated relative to the user's body in a mounting state of the display apparatus.

According to the aspect of the invention, in a case where the user's body is moved, it is possible to rapidly obtain a motion amount or a direction of the motion at the center of the motion (movement center) by using detection results from the plurality of motion sensors disposed at the deviated positions.

The plurality of motion sensors may be disposed at positions deviated relative to each other with respect to a reference location of the head or the neck of the user. More specifically, relative positions of the plurality of motion sensors may be deviated by using a neck joint serving as the center when the head of the user is moved, or the center of the head as a reference. In this case, in a case where the head of the user is moved, it is possible to analyze the motion of the head of the user on the basis of a difference between detection values of the plurality of motion sensors caused by the motion. Consequently, for example, it is possible to obtain a motion at the neck joint as the center of the motion, or at the center of the head.

In the display apparatus of the aspect of the invention, one of the motion sensors may be located on one side of the center of the head, and the other motion sensor may be located on the other side of the center of the head, in the mounting state.

According to the aspect of the invention with this configuration, in a case where the user's body is moved, it is possible to rapidly obtain a motion amount or a direction of the motion at the center of the motion (movement center) by using detection results from the plurality of motion sensors disposed on one side and the other side of the center of the head.

Here, the center of the head indicates the center of the head in the horizontal plane perpendicular to the height of the user, but may indicate the center in the horizontal plane at the height position of both eyes, and may be a three-dimensional center of the head of the user.

In the display apparatus of the aspect of the invention, one of the motion sensors may be located on the left side of the center of the head, and the other motion sensor may be located on the right side of the center of the head, in the mounting state.

According to the aspect of the invention with this configuration, in a case where the head of the user is moved, it is possible to rapidly obtain a motion amount or a direction of the motion at the movement center of the head.

In the display apparatus of the aspect of the invention, in the mounting state, one of the motion sensors may be located on one side of a movable portion serving as the center of a motion of the head of the user, and the other motion sensor may be located on the other side of the movable portion.

According to the aspect of the invention with this configuration, in a case where the user's body is moved, it is possible to rapidly obtain a motion amount or a direction of the motion at the movement center by using detection results from the plurality of motion sensors which are disposed on one side and the other side with respect to the movement center.

Here, the movable portion indicates a portion of the user's body which is moved, and corresponds to, for example, a joint of the neck or the like. In the aspect of the invention, the movable portion is a portion which can serve as a movement center in a horizontal plane perpendicular to the height of the user, but, for example, the movable portion may indicate a movement center in the horizontal plane at the height position of both eyes, and may be a three-dimensional center in the user's body. In a case where a motion of the user is a motion including a rotational movement component and a parallel (translational) movement component, the center of the rotational movement may be set as the movement center.

For example, in a case where the movable portion is a joint of the neck of the user (more specifically, an intervertebral joint between the first cervical vertebra (atlas vertebra) and the second cervical vertebra (axis vertebra)), a motion amount, a direction of a motion, and the like can be obtained so as to correspond to the motion of the head of the user centering on the neck. Consequently, in a case where the head of the user is moved, it is possible to rapidly obtain a motion amount or a direction of the motion at the neck which is a movement center.

In the display apparatus of the aspect of the invention, the movable portion may be a location which is set assuming a neck joint of the user.

According to the aspect of the invention with this configuration, a motion amount, a direction of a motion, and the like can be obtained so as to correspond to the motion of the head of the user centering on the neck.

In the display apparatus of the aspect of the invention, the plurality of motion sensors may be disposed so that a distance between one of the motion sensors and the movable portion may be different from a distance between the other motion sensor and the movable portion in the mounting state of the display apparatus.

According to the aspect of the invention with this configuration, a difference between the relative positions of the movable portion and the motion sensors is likely to be reflected in a difference between detection values of the motion sensors. Consequently, it is possible to obtain a position of a movement center, or a motion amount at the movement center with higher accuracy on the basis of the detection values of the plurality of motion sensors.

In the display apparatus of the aspect of the invention, the display unit may include an optical element having a display region which emits image light toward the eyes of the user, and the plurality of motion sensors and a central position of the display region of the optical element may be linearly arranged.

According to the aspect of the invention with this configuration, it is possible to rapidly obtain a motion amount and a direction of a motion at a movement center so as to correspond to the motion having a position of the optical element constituting the display region as the movement center.

In the display apparatus of the aspect of the invention, the optical element may include a half mirror as the display region for emitting image light toward the eyes of the user.

According to the aspect of the invention with this configuration, it is possible to rapidly obtain a motion amount and a direction of a motion at a movement center so as to correspond to the motion having the center of an image visually recognized by the user as the movement center.

The display apparatus of the aspect of the invention may further include a main body that hung in front of both the eyes of the user, and at least two of the motion sensors may be disposed at the positions which are symmetrical to each other with respect to the center of the main body.

According to the aspect of the invention with this configuration, there is a high possibility that the plurality of motion sensors can detect a motion of the user on both sides of a movement center, and thus it is possible to rapidly obtain a motion amount and a direction of a motion.

In the display apparatus of the aspect of the invention, the main body may include a right portion located in front of the right eye of the user; a left portion located in front of the left eye of the user; and a connecting portion that is disposed at the center of the main body and connects the right portion to the left portion, and at least two of the motion sensors may be disposed at positions which are symmetrical to each other with respect to the connecting portion.

According to the aspect of the invention with this configuration, it is possible to rapidly obtain a motion amount and a direction of a motion at a movement center so as to correspond to the motion having the center of the spectacle type display apparatus as the movement center.

In the display apparatus of the aspect of the invention, the plurality of motion sensors may include at least an optical sensor and an inertial sensor.

According to the aspect of the invention with this configuration, by using detection results from different kinds of sensors, it is possible to obtain information regarding a motion of the head of the user and to use detection values of the sensors to other applications.

In the display apparatus of the aspect of the invention, the plurality of motion sensors may be constituted of a single kind of optical sensor or inertial sensor.

According to the aspect of the invention with this configuration, by using a detection result of the same kind of sensor, it is possible to more easily obtain information regarding a motion of the head of the user.

The display apparatus of the aspect of the invention may further include a motion detection unit that obtains a motion at the center of the motion in relation to the motion of the user on the basis of detection values of the plurality of motion sensors.

According to the aspect of the invention with this configuration, it is possible to accurately obtain a motion of the user by using the plurality of motion sensors and thus to rapidly perform a process corresponding to the motion.

In the display apparatus of the aspect of the invention, the motion detection unit may obtain a motion at the center of the motion on the basis of each of the detection values of the plurality of motion sensors and a position of the motion sensor.

According to the aspect of the invention with this configuration, it is possible to more accurately obtain a motion of the user by using the plurality of motion sensors and thus to rapidly perform a process corresponding to the motion.

The display apparatus of the aspect of the invention may further include an imaging unit that images an imaging region which includes at least a part of a visual field of the user, and the motion detection unit may specify a position of the center of a motion of the user on the basis of detection values of the plurality of motion sensors, and obtain a relative position between the imaging region of the imaging unit and a visual field of the user on the basis of the specified position of the center of the motion.

According to the aspect of the invention with this configuration, it is possible to obtain a correspondence between an imaging region of the imaging unit and a visual field of the user and thus to perform control based on a captured image.

In the display apparatus of the aspect of the invention, the motion detection unit may determine whether or not the motion at the center of the motion is a motion based on a cognitive action of the user, and correct a captured image obtained by the imaging unit in a case where it is determined that the motion is not a motion based on the cognitive action of the user.

According to the aspect of the invention with this configuration, it is possible to discriminate a motion which is intended by the user from a motion which is not intended, and thus to correct blurring or the like in a captured image based on the motion which is not intended by the user.

In the display apparatus of the aspect of the invention, the motion detection unit may specify a position of the center of the motion of the user on the basis of the detection values of the plurality of motion sensors, estimate positions of the eyes of the user on the basis of the specified position of the center of the motion, specify a position of the display unit on the basis of a position of the motion sensor, and obtain a relative position between the display unit and the positions of the eyes of the user on the basis of the specified position of the display unit and the estimated positions of the eyes of the user.

According to the aspect of the invention with this configuration, it is possible to obtain a relative position between the display unit and positions of the eyes of the user with high accuracy. Thus, for example, in a case where the position of the display unit is not appropriate, it is possible to prompt the user to correct the position of the display unit.

The display apparatus of the aspect of the invention may further include a display unit main body that is mounted on the head of the user and includes the display unit; an imaging unit that is connected to the display unit main body so as to be displaced as the motion sensor; a detection unit that detects a position or displacement of the imaging unit relative to the display unit main body; and a control unit that obtains a relative position between the display unit main body and the imaging unit by using the detection unit.

According to the aspect of the invention with this configuration, the imaging unit which can be displaced with respect to the display unit main body is provided, and thus an imaging region can be changed. Since a relative position between the display unit main body and the imaging unit is obtained in a case where the imaging unit is moved, it is possible to perform a process such as necessary correction according to the motion of the imaging unit. In a case where the user's body is moved, it is possible to rapidly obtain a motion amount or a direction of the motion at a movement center.

The display apparatus of the aspect of the invention may further include a display unit that is provided with a display unit main body mounted on the head of the user; an imaging unit that is connected to the display unit main body so as to be displaced; a detection unit that detects a position or displacement of the imaging unit relative to the display unit main body; and a control unit that obtains a relative position between the display unit main body and the imaging unit by using the detection unit.

According to the aspect of the invention with this configuration, the imaging unit which can be displaced with respect to the display unit main body is provided, and thus an imaging region can be changed. Since a relative position between the display unit main body and the imaging unit is obtained in a case where the imaging unit is moved, it is possible to perform a plurality of such as necessary correction according to the motion of the imaging unit.

The display apparatus of the aspect of the invention may further include a connecting portion via which the imaging unit and the display unit main body are connected to each other so as to be rotationally moved, and the detection unit may detect the magnitude of an angle or a change in the angle between the imaging unit and the display unit main body at the connecting portion.

According to the aspect of the invention with this configuration, it is possible to easily realize a configuration in which the imaging unit is connected to the display unit main body so as to be movable and thus a position or displacement of the imaging unit is detected.

The display apparatus of the aspect of the invention may further include a plurality of the detection units, and the control unit may obtain a relative position between the display unit main body and the imaging unit on the basis of detection values of the plurality of detection units.

According to the aspect of the invention with this configuration, it is possible to more accurately detect a position of displacement of the imaging unit by using the plurality of detection units.

The display apparatus of the aspect of the invention may further include a display processing unit that displays the content on the display unit on the basis of a captured image obtained by the imaging unit.

According to the aspect of the invention with this configuration, it is possible to display the content on the basis of an image captured by the imaging unit, and also to change an imaging region by displacing the imaging unit.

In the display apparatus of the aspect of the invention, the display processing unit may adjust a display position of the content on the basis of the relative position between the display unit main body and the imaging unit, obtained by the control unit.

According to the aspect of the invention with this configuration, it is possible to display the content on the basis of an image captured by the imaging unit, and also to maintain display matching by adjusting a display position in a case where the imaging unit is displaced. Therefore, it is possible to displace the imaging unit in a state in which the display of the content is continuously being performed.

In the display apparatus of the aspect of the invention, the display processing unit may adjust a display position of the content so as to compensate for a deviation between a central axis of a visual field of the user and an optical axis of the imaging unit on the basis of the relative position between the display unit main body and the imaging unit.

According to the aspect of the invention with this configuration, it is possible to correct a position of the content which is displayed on the basis of an image captured by the imaging unit, to a position suitable for a visual line of the user.

In the display apparatus of the aspect of the invention, the control unit may determine whether or not adjustment of a display position of the content is necessary on the basis of detection results from the detection unit.

According to the aspect of the invention with this configuration, it is possible to control the display position of the content with appropriate accuracy.

In the display apparatus of the aspect of the invention, the display processing unit may perform a notification process before adjusting the display position of the content.

According to the aspect of the invention with this configuration, it is possible to improve convenience for a user who wears and uses the display unit main body.

The display apparatus of the aspect of the invention may further include a coupling unit that couples the imaging unit to the control unit in a wired manner and via which a captured image obtained by the imaging unit is transmitted to the control unit, and the coupling unit may be disposed along a connecting portion which connects the imaging unit to the display unit main body.

According to the aspect of the invention with this configuration, it is possible to more reliably transmit an image captured by the imaging unit to the control unit.

The display apparatus of the aspect of the invention may further include a wireless communication unit that wirelessly transmits a captured image obtained by the imaging unit to the control unit.

According to the aspect of the invention with this configuration, it is possible to displace the imaging unit with a higher degree of freedom.

Another aspect of the invention provides a control method for a display apparatus which is mounted on the head of a user, and includes a display unit that irradiates the eyes of the user with image light, and a plurality of motion sensors, the method including causing the display apparatus to obtain a motion at a movement center of the head on the basis of detection values of the plurality of motion sensors.

According to the aspect of the invention, in a case where the head of the user is moved, it is possible to rapidly obtain a motion amount or a direction of the motion at a movement center and to perform a process corresponding to the motion.

In the control method for a display apparatus of the aspect of the invention, a motion at the center of the motion may be obtained on the basis of a detection value of each of the plurality of motion sensors and a position of the motion sensor.

According to the aspect of the invention with this configuration, it is possible to accurately obtain a motion of the user by using the plurality of motion sensors and thus to rapidly perform a process corresponding to the motion.

In the control method for a display apparatus of the aspect of the invention, the display apparatus may further include an imaging unit that is connected to a display unit main body so as to be displaced, the display unit main body being mounted on the head of the user and including the display unit, and the display apparatus may obtain a relative position between the display unit main body and the imaging unit by detecting a position or displacement of the imaging unit relative to the display unit main body.

According to the aspect of the invention with this configuration, it is possible to obtain a relative position between the display unit main body and the imaging unit.

Still another aspect of the invention provides a control method for a display apparatus which includes a display unit main body mounted on the head of a user and provided with a display unit, and an imaging unit connected to the display unit main body so as to be displaced, the method including obtaining a relative position between the display unit main body and the imaging unit by detecting a position or displacement of the imaging unit relative to the display unit main body.

According to the aspect of the invention, it is possible to change an imaging region by moving the imaging unit with respect to the display unit main body. Since a relative position between the display unit main body and the imaging unit is obtained in a case where the imaging unit is moved, it is possible to perform a process such as necessary correction according to the motion of the imaging unit.

### BRIEF DESCRIPTION OF THE DRAWINGS

The invention will be described with reference to the accompanying drawings, wherein like numbers reference like elements.

FIG. 1 is a diagram illustrating an exterior configuration of a head mounted display apparatus.

FIG. 2 is a diagram illustrating a configuration of an optical system of an image display section.

FIG. 3A is a plan view schematically illustrating a state in which the image display section is mounted on the user's head.

FIG. 3B is a side view schematically illustrating a state in which the image display section is mounted on the user's head.

FIG. 4A is a plan view schematically illustrating a state in which the image display section is mounted on the user's head.

FIG. 4B is a side view schematically illustrating a state in which the image display section is mounted on the user's head.

FIG. 5A is a plan view illustrating an example of a state in which a sensor is disposed.

FIG. 5B is a side view illustrating an example of a state in which a sensor is disposed.

FIG. 6A is a plan view illustrating another example of a state in which a sensor is disposed.

FIG. 6B is a side view illustrating another example of a state in which a sensor is disposed.

FIG. 7 is a functional block diagram of each section constituting the head mounted display apparatus.

FIG. 8 is a flowchart illustrating an operation of the head mounted display apparatus.

FIGS. 9A and 9B are diagrams illustrating an example of a relative position between an imaging region and a visual field of a user.

FIG. 10 is a flowchart illustrating an operation of the head mounted display apparatus.

FIG. 11 is a flowchart illustrating an operation of the head mounted display apparatus.

FIGS. 12A and 12B are diagrams illustrating an example of an influence of a motion of the user's head.

FIG. 13 is a flowchart illustrating an operation of the head mounted display apparatus.

FIG. 14 is a functional block diagram of each section constituting a head mounted display apparatus of a second embodiment.

FIG. 15 is a flowchart illustrating an operation of the head mounted display apparatus of the second embodiment.

FIGS. 16A and 16B are diagrams illustrating modification examples of first and second embodiments.

FIG. 17 is a diagram illustrating an exterior configuration of a head mounted display apparatus of a third embodiment.

FIG. 18 is a diagram illustrating a configuration of an optical system of an image display section of the third embodiment.

FIG. 19 is a functional block diagram of each section constituting the head mounted display apparatus of the third embodiment.

FIGS. 20A and 20B are side views illustrating states in which the head mounted display apparatus is mounted.

FIG. 21 is a flowchart illustrating an operation of the head mounted display apparatus of the third embodiment.

FIG. 22 is a functional block diagram of each section constituting the head mounted display apparatus of a fourth embodiment.

FIG. 23 is a side view illustrating a schematic configuration of the head mounted display apparatus of the fourth embodiment.

FIG. 24 is a functional block diagram of each section constituting a head mounted display apparatus of a fifth embodiment.

FIGS. 25A to 25D are diagrams illustrating states in which the head mounted display apparatus of the fifth embodiment is mounted.

FIG. 26 is a diagram illustrating an exterior configuration of a head mounted display apparatus of a sixth embodiment.

FIG. 27 is a functional block diagram of each section constituting the head mounted display apparatus of the sixth embodiment.

FIG. 28 is a diagram illustrating an exterior configuration of a head mounted display apparatus of a seventh embodiment.

FIG. 29 is a functional block diagram of each section constituting the head mounted display apparatus of the seventh embodiment.

### DESCRIPTION OF EXEMPLARY EMBODIMENTS

### First Embodiment

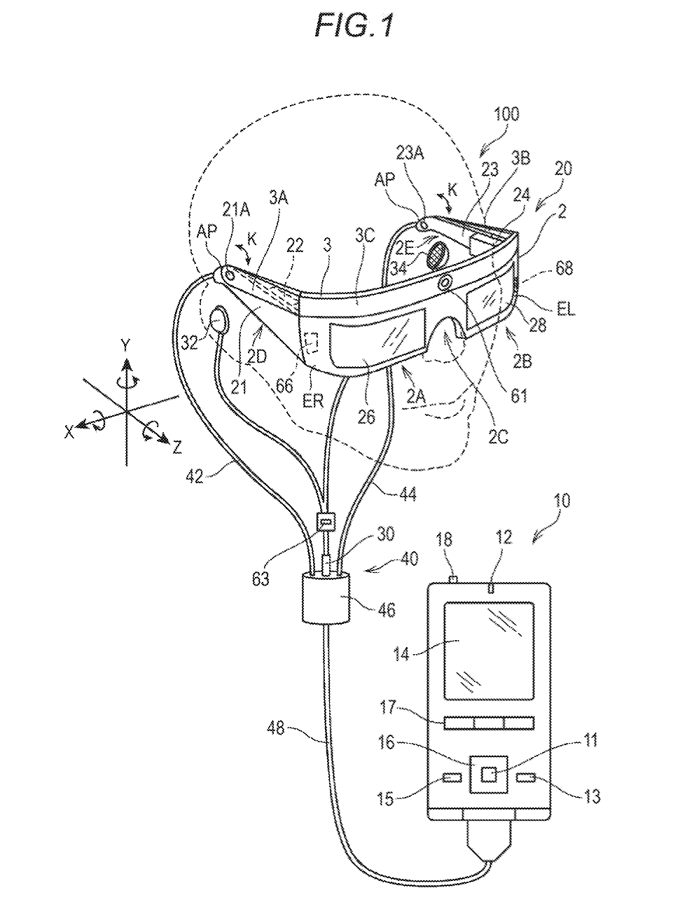

FIG. 1 is a diagram illustrating an exterior configuration of a head mounted display apparatus 100 (display apparatus) related to an embodiment to which the invention is applied.

The head mounted display apparatus 100 includes an image display section 20 (display unit) which enables a user to visually recognize a virtual image in a state of being mounted on the head of the user, and a control device 10 which controls the image display section 20. The control device 10 also functions as a controller used for the user to operate the head mounted display apparatus 100.

The image display section 20 is a mounting body which is mounted on the head of the user, and includes a spectacle type frame 2 (main body) in the present embodiment. The frame 2 is provided with a right holding unit 21, and a left holding unit 23. The right holding unit 21 is a member which is provided so as to extend over a position corresponding to the temporal region of the user from the other end part ER which is the other end of a right optical image display unit 26 when the user wears the image display section 20. Similarly, the left holding unit 23 is a member which is provided so as to extend over a position corresponding to the temporal region of the user from the other end part EL of a left optical image display unit 28 when the user wears the image display section 20. The right holding unit 21 comes into contact with the right ear or the vicinity thereof on the head of the user, and the left holding unit 23 comes into contact with the left ear or the vicinity thereof of the user, so as to hold the image display section 20 on the head of the user.

The frame 2 is provided with a right display driving unit 22, a left display driving unit 24, the right optical image display unit 26, the left optical image display unit 28, and a microphone 63.

In the present embodiment, as an example of a main body, the spectacle type frame 2 will be described. A shape of the main body is not limited to a spectacle shape, and may be any shape as long as the main body is mounted on and fixed to the head of the user, and is more preferably a shape which causes the main body to be hung in front of both the eyes of the user. For example, in addition to the spectacle shape described here, a shape of the main body may be a snow goggle shape covering the upper part of the face of the user, and may be a shape which is disposed in front of each of the right and left eyes of the user, such as binoculars.

The spectacle type frame 2 includes a right portion 2A located in front of the right eye of the user, and a left portion 2B located in front of the left eye of the user, and has a shape in which the right portion 2A and the left portion 2B are connected to each other via a bridge portion 2C (connecting portion). The bridge portion 2C connects the right portion 2A to the left portion 2B at the position corresponding to the glabella of the user when the user wears the image display section 20.

The right portion 2A and the left portion 2B are respectively connected to temple portions 2D and 2E. The temple portions 2D and 2E hold the frame 2 on the head of the user in the same manner as temples of spectacles. The temple portion 2D of the present embodiment is formed of the right holding unit 21, and the temple portion 2E is formed of the left holding unit 23.

The right optical image display unit 26 which is disposed at the right portion 2A and the left optical image display unit 28 which is disposed at the left portion 2B, are respectively located in front of the right and left eyes of the user when the user wears the image display section 20.

The right display driving unit 22 and the left display driving unit 24 are disposed on sides facing the head of the user when the user wears the image display section 20. The right display driving unit 22 and the left display driving unit 24 are collectively simply referred to as “display driving units”, and the right optical image display unit 26 and the left optical image display unit 28 are collectively simply referred to as “optical image display units”.

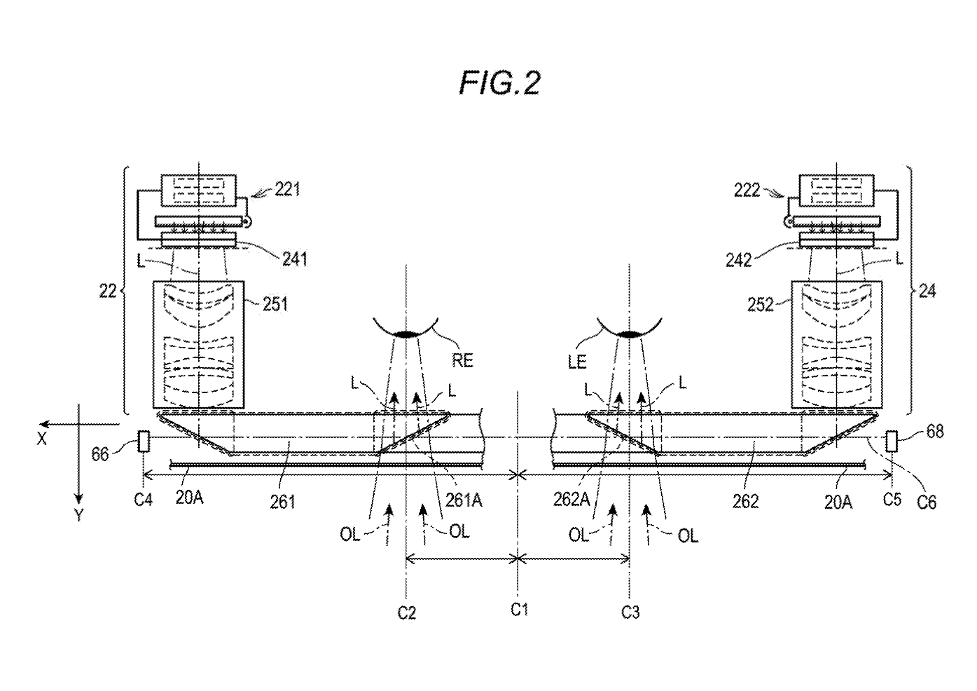

The display driving units 22 and 24 respectively include liquid crystal displays 241 and 242 (hereinafter, referred to as “LCDs 241 and 242”), projection optical systems 251 and 252 which will be described later with reference to FIG. 2, and the like.

The right optical image display unit 26 and left optical image display unit 28 respectively include light guide plates 261 and 262 (FIG. 2) and dimming plates 20A. The light guide plates 261 and 262 are made of a light-transmitting resin material or the like, and guide image light output from the display driving units 22 and 24 to the eyes of the user. Each of the dimming plates 20A is a thin plate-shaped optical element, and is disposed so as to cover a surface side of the image display section 20 which is an opposite side to the eye side of the user. As the dimming plate 20A, various dimming plates including one which has almost no light transmittance, one which is substantially transparent, one through which light is transmitted by attenuating of an amount of light, one which attenuates or reflects light with a specific wavelength, and the like. Optical characteristics (light transmittance and the like) of the dimming plates 20A are selected as appropriate in order to adjust an amount of external light entering the right optical image display unit 26 and the left optical image display unit 28, and thus the extent of visually recognizing a virtual image can be controlled. In the present embodiment, a description will be made of a case of using the dimming plates 20A which has light transmittance to the extent to which the user wearing the image display section 20 can visually recognize at least external scenery. The dimming plates 20A protect the right light guide plate 261 and the left light guide plate 262, which are optical elements, so as to prevent the right light guide plate 261 and the left light guide plate 262 from being damaged, contaminated, or the like.

The dimming plates 20A may be attachable to and detachable from the right optical image display unit 26 and the left optical image display unit 28, may be attached by exchanging a plurality of dimming plates 20A, and may be omitted.

The frame 2 is provided with a camera unit 3. The camera unit 3 includes a camera pedestal portion 3C in which an upper camera 61 is disposed, and arm portions 3A and 3B supporting the camera pedestal portion 3C. The arm portion 3A is connected to the right holding unit 21 so as to be rotationally moved via a hinge 21A provided at a tip portion AP of the right holding unit 21. The arm portion 3B is connected to the left holding unit 23 so as to be rotationally moved via a hinge 23A provided at a tip portion AP of the left holding unit 23. For this reason, the camera unit 3 can be rotationally moved as a whole in a direction indicated by an arrow K, that is, vertically in a mounting state. The camera unit 3 comes into contact with the frame 2 at a lower end of a rotatable movement range. An upper end of the rotatable movement range of the camera unit 3 is determined on the basis of a specification or the like of the hinges 21A and 23A.

The camera pedestal portion 3C is a plate-like or rod-like member located on upper parts of the right portion 2A, the left portion 2B, and the bridge portion 2C, and the upper camera 61 is provided in an embedded manner at a position corresponding to the upper part of the bridge portion 2C. The upper camera 61 is a digital camera including an imaging element such as a CCD or a CMOS, and an imaging lens, and may be a monocular camera and may be stereo cameras.

The upper camera 61 images at least a part of external scenery in the surface side of the head mounted display apparatus 100, that is, in a visual field direction of the user in a state in which the user wears the image display section 20. A range of an angle of view of the upper camera 61 may be set as appropriate, but an imaging region of the upper camera 61 preferably includes the external world which is visually recognized by the user through the right optical image display unit 26 and the left optical image display unit 28 at the lower end of the rotatable movement range of the camera unit 3. More preferably, an imaging region of the upper camera 61 is set to image the entire visual field of the user through the dimming plates 20A.

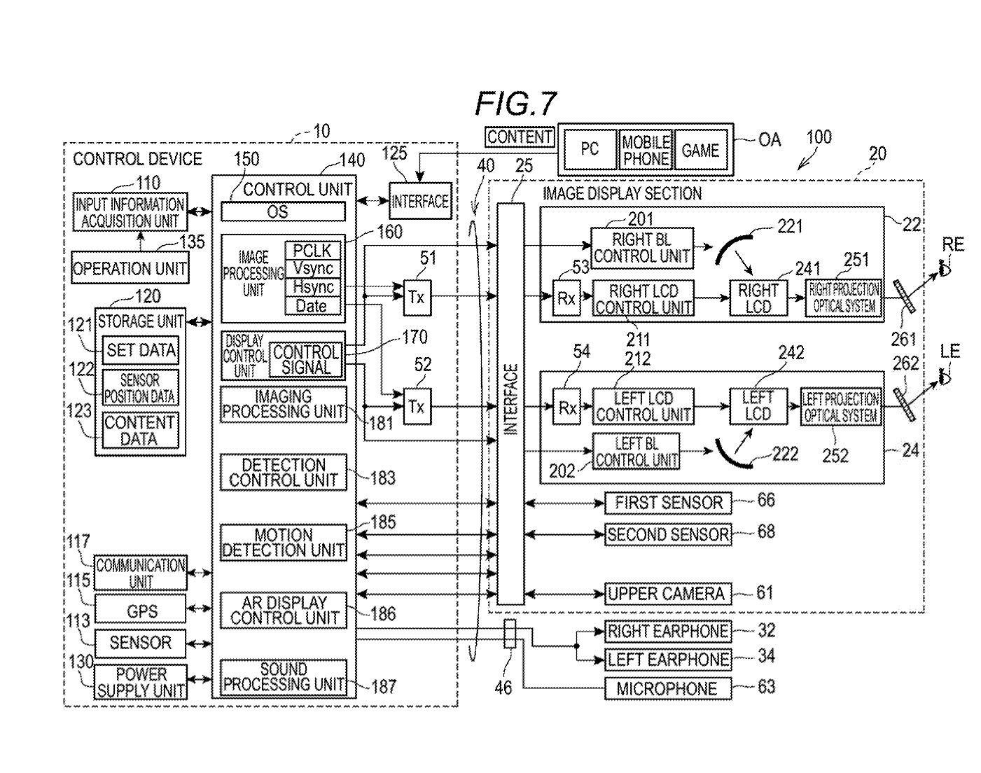

The upper camera 61 performs imaging under the control of an imaging processing unit 181 (FIG. 7) included in a control unit 140, and outputs captured image data to the imaging processing unit 181.

The image display section 20 is coupled to the control device 10 via a coupling unit 40. The coupling unit 40 includes a main cord 48 that is coupled to the control device 10, right cord 42, a left cord 44, and a connecting member 46. The right cord 42 and the left cord 44 are two cords into which the main cord 48 branches. The right cord 42 is inserted into a chassis of the right holding unit 21 from the tip portion AP in the extending direction of the right holding unit 21 and is coupled to the right display driving unit 22. Similarly, the left cord 44 is inserted into a chassis of the left holding unit 23 from the tip portion AP in the extending direction of the left holding unit 23 and is coupled to the left display driving unit 24.

The connecting member 46 is provided at a branching point of the main cord 48, the right cord 42, and the left cord 44, and includes a jack for coupling to an earphone plug 30. A right earphone 32 and a left earphone 34 extend from the earphone plug 30. The microphone 63 is provided near the earphone plug 30. The earphone plug 30 and the microphone 63 are put together in a single cord, and cords into which the cord from the microphone 63 branches are respectively connected to the right earphone 32 and the left earphone 34.

For example, as illustrated in FIG. 1, a sound collecting unit of the microphone 63 is disposed so as to be directed in the visual line direction of the user, and the microphone 63 collects sound and outputs an audio signal to a sound processing unit 187 (FIG. 7). For example, the microphone 63 may be a monaural microphone, a stereo microphone, a directive microphone, or a non-directive microphone.

The right cord 42, the left cord 44, and the main cord 48 may be ones which can transmit digital data, and may be formed of, for example, a metal cable or an optical fiber. The right cord 42 and the left cord 44 may be collected as a single cord.

The image display section 20 and the control device 10 transmit various signals via the coupling unit 40. An end portion of the main cord 48 opposite to the connecting member 46 and the control device 10 are provided with connectors (not illustrated) engaging with each other, respectively. The control device 10 and the image display section 20 are connected to or disconnected from each other by engagement or disengagement between the connector of the main cord 48 and the connector of the control device 10.

The control device 10 controls the head mounted display apparatus 100. The control device 10 is provided with switches including a determination key 11, a lighting unit 12, a display change key 13, a luminance change key 15, a direction key 16, a menu key 17, and a power switch 18. The control device 10 also includes a track pad 14 on which the user performs a touch operation with the user's finger.

The determination key 11 detects a pressing operation and outputs a signal for determining content which is operated in the control device 10. The lighting unit 12 includes a light source such as a light emitting diode (LED), and performs a notification of an operation state (for example, ON and OFF states of the supply of power) of the head mounted display apparatus 100 by using its lighting state. The display change key 13 outputs, for example, a signal for switching image display modes according to a pressing operation.

The track pad 14 has an operation surface for detecting a touch operation, and outputs a signal according to an operation on the operation surface. A detection method on the operation surface is not limited, and may employ an electrostatic type, a pressure detection type, an optical type, and the like. The luminance change key 15 outputs a signal for changing luminance of the image display section 20 according to a pressing operation. The direction key 16 outputs an operation signal according to a pressing operation on a key corresponding to upper, lower, left, and right directions. The power switch 18 is a switch for switching turning-on and turning-off and the supply of power to the head mounted display apparatus 100.

FIG. 2 is a main portion plan view illustrating a configuration of an optical system included in the image display section 20. For description, FIG. 2 illustrates the left eye LE and the right eye RE of the user.

The left display driving unit 24 includes a left backlight 222, a left LCD 242, and a left projection optical system 252. The left backlight 222 includes a light source such as an LED, and a diffusion plate. The left LCD 242 is disposed on an optical path of light emitted from the diffusion plate of the left backlight 222, and is a transmissive liquid crystal panel in which a plurality of pixels are arranged in a matrix. The left projection optical system 252 includes a lens group and the like which guide image light L having been transmitted through the left LCD 242.

The left projection optical system 252 includes a collimator lens which converts the image light L emitted from the left LCD 242 into parallel light beams. The image light L converted into the parallel light beams by the collimator lens is incident to the left light guide plate 262 (optical element). The left light guide plate 262 is a prism in which a plurality of reflective surfaces reflecting the image light L are formed, and the image light L is guided to the left eye LE through reflection performed for multiple times inside the left light guide plate 262. The left light guide plate 262 is provided with a half mirror 262A (reflective surface) located in front of the left eye LE.

The image light L reflected by the half mirror 262A is emitted from the left optical image display unit 28 toward the left eye LE, and the image light L forms an image on the retina of the left eye LE so that the user visually recognizes the image.

The right display driving unit 22 is configured symmetrically to the left display driving unit 24. The right display driving unit 22 includes a right backlight 221, a right LCD 241, and a right projection optical system 251. The right backlight 221 includes a light source such as an LED, and a diffusion plate. The right LCD 241 is disposed on an optical path of light emitted from the diffusion plate of the right backlight 221, and is a transmissive liquid crystal panel in which a plurality of pixels are arranged in a matrix. The right projection optical system 251 includes a lens group and the like which guide image light L having been transmitted through the right LCD 241.

The right projection optical system 251 includes a collimator lens which converts the image light L emitted from the right LCD 241 into parallel light beams. The image light L converted into the parallel light beams by the collimator lens is incident to the right light guide plate 261 (optical element). The right light guide plate 261 is a prism in which a plurality of reflective surfaces reflecting the image light L are formed, and the image light L is guided to the right eye RE through reflection performed for multiple times inside the right light guide plate 261. The right light guide plate 261 is provided with a half mirror 261A (reflective surface) located in front of the right eye RE.

The image light L reflected by the half mirror 261A is emitted from the right optical image display unit 26 toward the right eye RE, and the image light L forms an image on the retina of the right eye RE so that the user visually recognizes the image.

The image light L reflected by the half mirror 261A and external light OL having been transmitted through the dimming plate 20A are incident to the right eye RE of the user. The image light L reflected by the half mirror 262A and external light OL having been transmitted through the dimming plate 20A are incident to the left eye LE of the user. As mentioned above, the head mounted display apparatus 100 causes the image light L of an image which is processed therein and the external light OL to overlap each other and to be incident to the eyes of the user, and the user observes external scenery through the dimming plates 20A and visually recognizes the image based on the image light L overlapped on the external scenery. As mentioned above, the head mounted display apparatus 100 functions as a see-through type display apparatus.

The left projection optical system 252 and the left light guide plate 262 are collectively referred to as a “left light guide unit”, and the right projection optical system 251 and the right light guide plate 261 are collectively referred to as a “right light guide unit”. Configurations of the right light guide unit and the left light guide unit are not limited to the above-described examples, and any method may be used as long as a virtual image is formed in front of the eyes of the user using the image light. For example, a diffraction grating may be used, and a transflective film may be used.

As illustrated in FIGS. 1 and 2, two motion sensors are attached to the frame 2. The motion sensors of the first embodiment are inertial sensors, and are specifically a first sensor 66 and a second sensor 68. The first sensor 66 and the second sensor 68 as motion sensors are disposed at positions which are deviated relative to the user's body in the head mounted display apparatus 100. More specifically, the first sensor 66 is disposed at an end of the right portion 2A on the temple portion 2D side, and the second sensor 68 is disposed at an end of the left portion 2B on the temple portion 2E side. The first sensor 66 and the second sensor 68 are inertial sensors such as acceleration sensors or angular velocity sensors (gyro sensors), and are three-axis gyro sensors in the present embodiment.

The first sensor 66 and the second sensor 68 detect a rotation (pitch) around an X axis, a rotation (yaw) around a Y axis, and a rotation (roll) around a Z axis which will be described later, at measurement reference points of detection mechanisms built therein. In the following description, positions of the first sensor 66 and the second sensor 68 indicate positions of the measurement reference points.

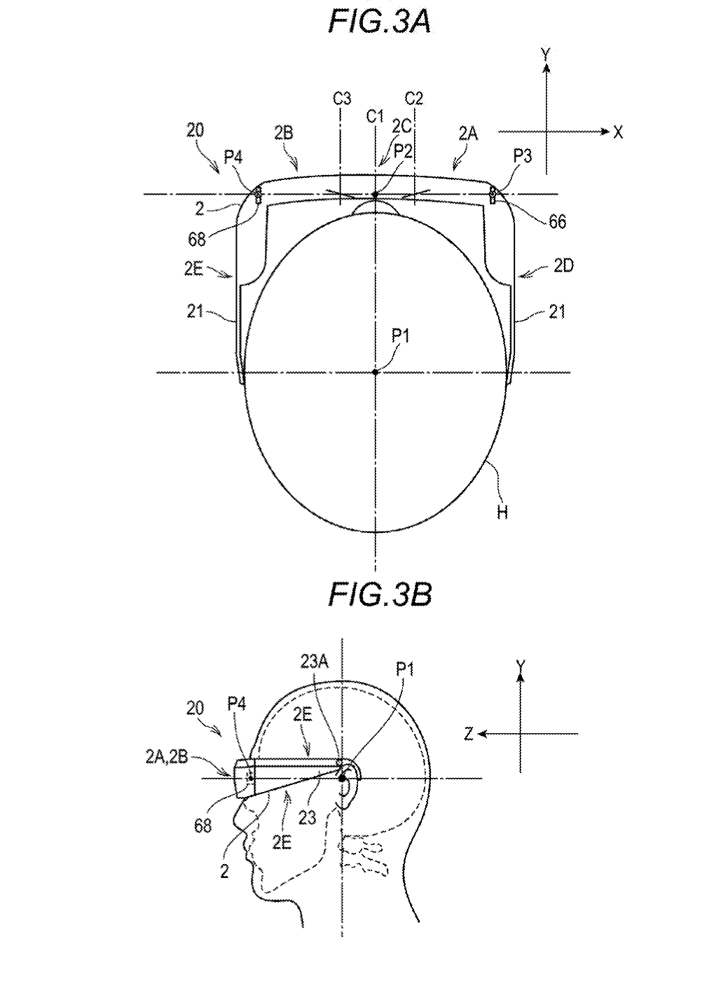

FIGS. 3A and 3B are respectively a plan view and a side view schematically illustrating a state in which the image display section 20 is mounted on the head of the user.

In the head mounted display apparatus 100, the first sensor 66 and the second sensor 68 are disposed with a position of the center (movement center) of a motion of the user's body as a reference. In the example illustrated in FIGS. 3A and 3B, the center of the head is regarded as the movement center.

One of the first sensor 66 and the second sensor 68 is disposed on one side of the center of the head of the user, and the other sensor is disposed on the other side of the center of the head of the user. Specifically, the first sensor 66 is disposed on the right side of the head of the user, and the second sensor 68 is disposed on the left side thereof.

In the present embodiment, the center of the head indicates the center of the head on a horizontal plane perpendicular to the height of the user. Regarding positions of the first sensor 66 and the second sensor 68 on the horizontal plane, the first sensor 66 and the second sensor 68 are located on the right side and the left side with the center of the head interposed therebetween on the horizontal plane.

In the head mounted display apparatus 100, the center of the head may be specified in a height direction (a direction of the height; the Y axis direction in FIGS. 3A and 3B), and, in this case, for example, the center on the horizontal plane at a height position of both of the eyes may be set as the “center of the head”. For example, a three-dimensional center of the head of the user may be obtained assuming that the head is defined from the top of the head to the upper end of the cervical vertebra, and the center may be set as the “center of the head”. As illustrated in FIG. 3B, the positions of the first sensor 66 and the second sensor 68 in the height direction may be used as the center in the height direction of the center of the head.

A position of the center of the head of the user may be obtained through actual measurement, and may be estimated on the basis of the height or the circumference of the head of the user. For example, in a case where a parameter or a calculation expression for estimating a position of the center of the head on the basis of the height or the circumference of the head is obtained in advance according to a statistical method, a position of the center of the head may be obtained by using the parameter or the calculation expression.

More preferably, as illustrated in FIGS. 2 and 3A, in the present embodiment, the first sensor 66 is disposed on the lateral side of the right light guide plate 261, and the second sensor 68 is disposed on the lateral side of the left light guide plate 262. If a central position of the frame 2 in the left and right directions is set to C1, a center C2 of the half mirror 261A as a display region which enables the user to visually recognize the image light and a center C3 of the half mirror 262A as a display region are located at positions which symmetrical to each other with respect to the central position C1. In other words, the central position C1 is located at a middle point between the center C2 of the half mirror 261A and the center C3 of the half mirror 262A.

As described above, the first sensor 66 and the second sensor 68 are preferably disposed at the positions which are symmetrical to each other with respect to the central position C1. A straight line connecting the position of the first sensor 66 to the position of the second sensor 68 passes through the half mirrors 261A and 262A. In other words, the position of the first sensor 66, the position of the second sensor 68, the center C2 of the half mirror 261A, and the center C3 of the half mirror 262A are arranged on the same straight line.

The positional relationship in the horizontal plane including the centers of the half mirrors 261A and 262A has been described, but a positional relationship in a vertical direction (height direction) perpendicular to the horizontal plane is not particularly limited. The positions of the first sensor 66 and the second sensor 68 and the centers of the half mirrors 261A and 262A are preferably close to each other in the vertical direction. For example, the first sensor 66 and the second sensor 68 may be located on the lateral sides of the half mirrors 261A and 262A. The first sensor 66 and the second sensor 68 and the centers of the half mirrors 261A and 262A are more preferably located at the same positions in the height direction.

As illustrated in FIG. 1, as axes for the first sensor 66 to detect angular velocity, with respect to the head of the user on which the image display section 20 is mounted, an axis in left and right directions is set to an X axis, an axis in front and rear directions is set to a Z axis, and an axis in upper and lower directions is set to a Y axis. The X axis, the Y axis, and the Z axis form an orthogonal coordinate system which is virtually set to correspond to the head of the user. More specifically, the image display section 20 is located at a horizontal position perceived by the user with respect to the right and left eyes in a mounting state of the head mounted display apparatus 100. In this mounting state, the detection axes (the X axis, the Y axis, and the Z axis) of the first sensor 66 and the second sensor 68 respectively match the left and right sides, the front and rear sides, and the upper and lower sides perceived by the user. If the position where the image display section 20 is mounted is tilted or deviated relative to the head of the user, the detection axes of the first sensor 66 and the second sensor 68 are deviated relative to the left and right sides, the front and rear sides, and the upper and lower sides, but this problem is easily removed by the user adjusting tilt or deviation of the image display section 20.

The head mounted display apparatus 100 detects motions of the head of the user by using the first sensor 66 and the second sensor 68 in a mounting state of the image display section 20. The motions detected by the motion sensors are a motion at the measurement reference point (P3 in FIGS. 3A and 3B) of the first sensor 66 and a motion at the measurement reference point (P4 in FIGS. 3A and 3B) of the second sensor 68.

In a case of displaying AR content by using a function of an AR display control unit 186 which will be described later, the head mounted display apparatus 100 performs detection (head tracking) of a motion of the head of the user, and changes a display aspect so as to correspond to the detected motion of the head of the user.

In the head tracking, preferably, a reference location of a movement (motion) of the head is assumed, and a motion at the reference location is obtained. As described above, when a human moves the head thereof, the center (corresponding to a position P1 in FIGS. 3A and 3B) of the head or a front portion (corresponding to a position P2 in FIGS. 3A and 3B) of the head serves as the center or a motion or a reference for the most part. Here, the center of a motion, or a location used as a reference is referred to as a movement center. A case where the head mounted display apparatus 100 detects a motion includes not only a case where only the head of the user is moved, but also a case a motion is detected when the head and body portions other than the head are moved together. Therefore, a motion detected by the head mounted display apparatus 100 is a motion of the head, but the movement center of the motion may be located outside the head of the user.

In a process of the head tracking, a motion at the movement center is obtained. In order to directly detect a motion at the movement center, the sensor is required to be disposed at a location which tends to be the movement center, for example, the position P1 or the position P2, and thus this is not realistic. Therefore, the head mounted display apparatus 100 calculates a motion at the movement center through a calculation process based on detection results from the first sensor 66 and the second sensor 68. A calculation expression, a table, a parameter, and the like used for the calculation process are stored in advance as sensor position data 122 which will be described later.

In a case where positions of the first sensor 66 and the second sensor 68 satisfy a certain type of condition, the calculation process of calculating a motion at the movement center is facilitated and can thus be performed with a reduced load so that a motion at the movement center (for example, the position P1 or P2) can be calculated more accurately.

This condition is that, as described above, one of the first sensor 66 and the second sensor 68 is located on one side of the center of the head of the user and the other sensor is located on the other side of the center of the head of the user. In this case, if a movement having the center P1 of the head as the movement center is performed, it is possible to easily calculate a motion at the movement center.

More preferably, the first sensor 66 is disposed on the lateral side of the right light guide plate 261, and the second sensor 68 is disposed on the lateral side of the left light guide plate 262. The first sensor 66 and the second sensor 68 are more preferably disposed at positions which are symmetrical to each other with respect to the central position C1. The position of the first sensor 66, the position of the second sensor 68, the center C2 of the half mirror 261A, and the center C3 of the half mirror 262A are further preferably arranged on the same straight line. In this case, if a movement having the center P1 of the head or the front center P2 as the movement center is performed, it is possible to easily calculate a motion at the movement center. From another viewpoint, the first sensor 66 and the second sensor 68 are located at positions deviated relative to the head of the user, and particularly at positions deviated relative to the position P1 which can be regarded as a position of a movement center.

In terms of a positional relationship in the vertical direction (height direction), the positions of the first sensor 66 and the second sensor 68 and the centers of the half mirrors 261A and 262A are preferably close to each other in the vertical direction. More preferably, the first sensor 66 and the second sensor 68 and the centers of the half mirrors 261A and 262A are located at the same position in the height direction.

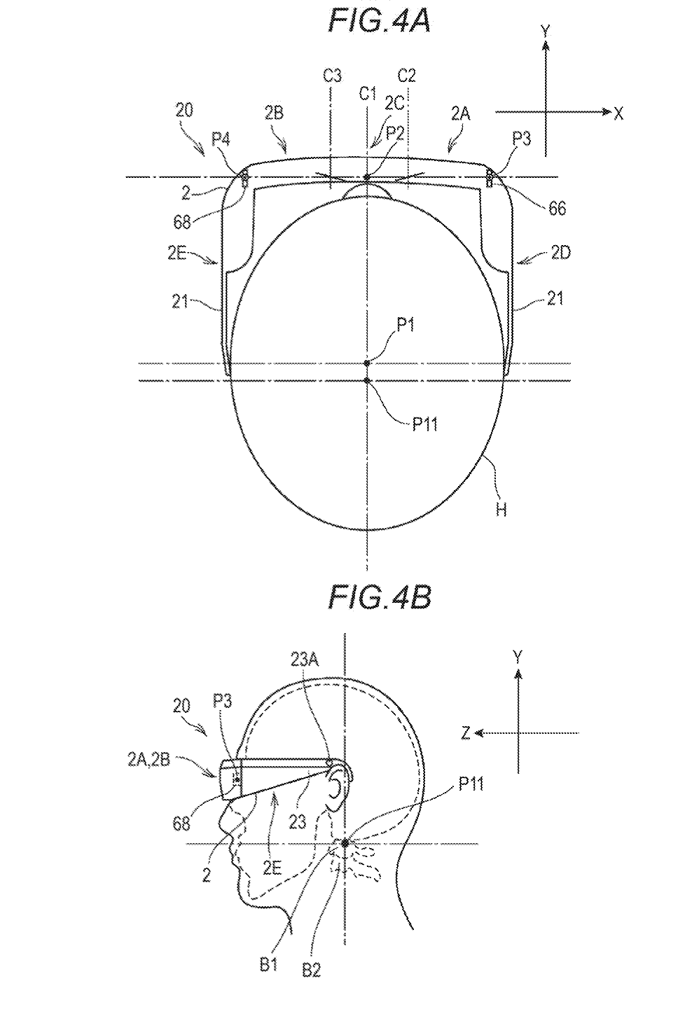

FIGS. 4A and 4B are diagrams illustrating an example in which a movement center is set to positions other than the center of the head, and are diagrams schematically illustrating a state in which the image display section 20 is mounted on the head of the user. FIG. 4A is a plan view, and FIG. 4B is a side view.

FIGS. 4A and 4B illustrate an example in which a location having the cervical vertebra as a reference is regarded as a movement center in the head of the user.

The head mounted display apparatus 100 of the present embodiment causes a detection control unit 183 which will be described later to detect rotational movements and/or translational movements corresponding to the three axes by using the first sensor 66 and the second sensor 68. The rotational movements corresponding to the three axes are specifically a rotation (pitch) around the X axis, a rotation (yaw) around the Y axis, and a rotation (roll) around the Z axis.

In the configuration illustrated in FIGS. 3A and 3B, the first sensor 66 and the second sensor 68 are disposed focusing on the fact that the center (corresponding to the position P1 in FIGS. 3A and 3B) of the head or the front portion (corresponding to the position P2 in FIGS. 3A and 3B) of the head frequently serves as the center of a motion when a human moves the head thereof.

In contrast, for example, in order to correspond to a motion centering on a movable portion of the user's body with high accuracy, such as the user shaking the head from side to side, the first sensor 66 and the second sensor 68 may be disposed at positions having the movable portion of the user as a reference.

FIGS. 4A and 4B illustrate an example in which a plurality of motion sensors are disposed with a position of a movable portion serving as a movement center in the user's body as a reference. In this case, some of the motion sensors are located on one side of the movable portion serving as a movement center, and the other motion sensors are disposed on the other side of the movable portion. The movable portion indicates a portion of the user's body which is moved, and corresponds to, for example, a joint of the neck or the like. The movable portion may be a portion which can serve as a movement center in a horizontal plane perpendicular to the height of the user. For example, the movable portion may be a movement center in the horizontal plane at the height position of both eyes, and may be a three-dimensional center in the user's body. In a case where a motion of the user is a motion including a rotational movement component and a parallel (translational) movement component, the center of the rotational movement may be set as the movement center. A typical example of the movable portion is a joint of the neck of the user, and is, for example, an intervertebral joint between the first cervical vertebra (atlas vertebra) and the second cervical vertebra (axis vertebra). In this case, a motion amount, a direction of a motion, and the like can be obtained so as to correspond to the motion of the head of the user centering on the neck. Consequently, in a case where the head of the user is moved, it is possible to rapidly obtain a motion amount or a direction of the motion at the neck which is a movement center.

In other words, in the example illustrated in FIGS. 3A and 3B, arrangement of the motion sensors is illustrated in a case where the position P1 or P2 is regarded as a movement center (the center of a motion), and FIGS. 4A and 4B illustrate arrangement of the motion sensors in a case where the position P11 is regarded as a movement center.

In the example illustrated in FIGS. 4A and 4B, in head tracking, a reference location of a movement (motion) of the head is set at the position of the cervical vertebra, particularly, the position P11 which is the atlantoaxial joint. The position P11 in the height direction (Y axis direction) can be easily specified as illustrated in FIG. 4B.

A position of the cervical vertebra or the atlantoaxial joint of the user may be obtained through actual measurement, and may be estimated on the basis of the height or the circumference of the head of the user. For example, in a case where a parameter or a calculation expression for estimating a position of the center of the head on the basis of the height or the circumference of the head is obtained in advance according to a statistical method, a position of the center of the head may be obtained by using the parameter or the calculation expression.

In the above-described head tracking process, the head mounted display apparatus 100 may calculate a motion at a movement center with the position P11 as a movement center, through a calculation process based on detection results from the first sensor 66 and the second sensor 68. A calculation expression, a table, a parameter, and the like used for the calculation process are stored in advance as the sensor position data 122 which will be described later.

In the example illustrated in FIGS. 4A and 4B, preferably, one of the first sensor 66 and the second sensor 68 is disposed on one side with respect to the cervical vertebra of the user, particularly, the position P11, and the other sensor is disposed on the other side with respect to the position P11. From another viewpoint, the first sensor 66 and the second sensor 68 are located at positions deviated relative to the head of the user, and particularly at positions deviated relative to the position P11 which can be regarded as a position of a movement center. Also in the configuration illustrated in FIGS. 4A and 4B, since positions of the first sensor 66 and the second sensor 68 satisfy the above-described condition, the calculation process of calculating a motion at the movement center is facilitated and can thus be performed with a reduced load so that a motion at the movement center (for example, the position P11) can be calculated more accurately.

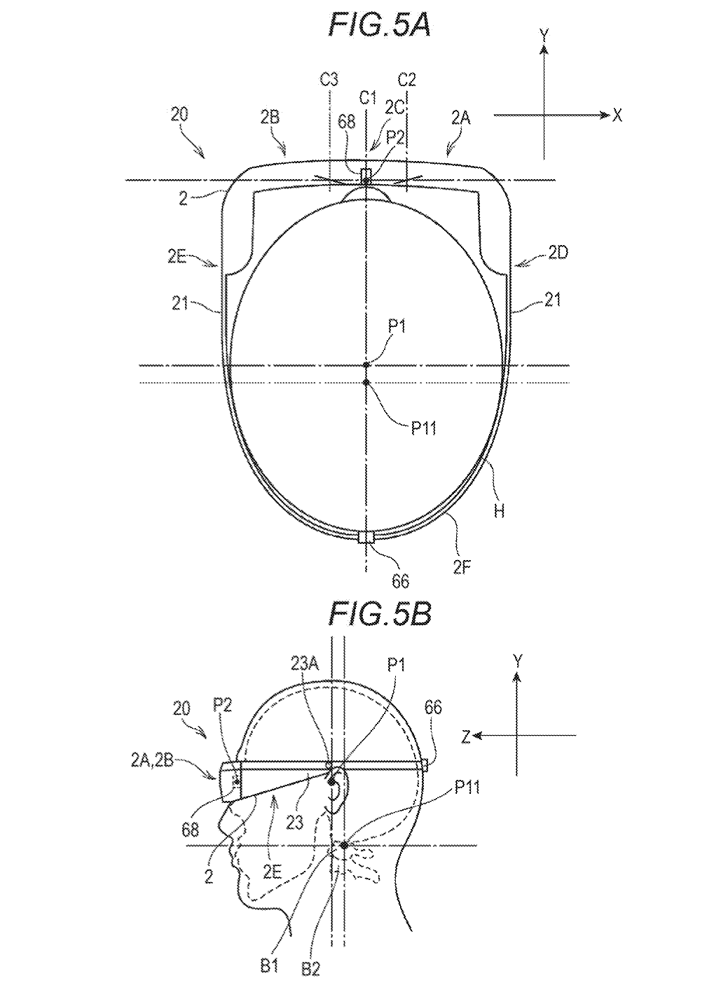

FIGS. 5A and 5B are diagrams illustrating another example of a state in which the sensors are disposed in the head mounted display apparatus 100. FIG. 5A is a plan view, and FIG. 5B is a side view.

FIGS. 5A and 5B illustrate an example in which one of the first sensor 66 and the second sensor 68 is disposed on the back side of the head of the user. In the example illustrated in FIGS. 5A and 5B, one motion sensor (first sensor 66) is disposed at a position which comes into contact with the back of the head of the user.

The other motion sensor (second sensor 68) may be disposed at a position deviated relative to the position P11 corresponding to a movable portion, and is more preferably disposed on an opposite side to the first sensor 66 with respect to the position P11. Specifically, the second sensor 68 is located in front of the face of the user. In the example illustrated in FIGS. 5A and 5B, the second sensor 68 is disposed the position P2 corresponding to the center of the front surface of the frame 2. The upper camera 61 is disposed at the position P2, but the second sensor 68 may be provided on the inside or the lower side of the upper camera 61 so as to be adjacent to the upper camera 61.

In the example illustrated in FIGS. 5A and 5B, a belt 2F is fixed to the tip of the right holding unit 21 and the tip of the left holding unit 23. Both ends of the belt 2F are respectively fixed to, for example, the hinges 21A and 23A, and the belt 2F forms a loop surrounding the head of the user along with the frame 2. A material of the belt 2F is not particularly limited, and may be, for example, a synthetic resin, a metal, cloth, non-woven fabric, leather, or a combination thereof. The belt 2F may be a rigid member which maintains a loop form in a state in which an external force is not applied thereof, or an elastic member. The belt 2F may be a flexible member which can be easily deformed. The belt 2F may be an expandable member.

The belt 2F is located on the circumference of the head of the user as illustrated in FIG. 5B in a state in which the user wears the image display section 20.

The first sensor 66 is attached to the belt 2F. The first sensor 66 is fixed to the belt 2F, or is accommodated in a case (not illustrated) fixed to the belt 2F.

In the example illustrated in FIGS. 5A and 5B, the first sensor 66 and the second sensor 68 are disposed at the positions deviated relative to the position P11 which is a position of a movable portion. As is clear from FIGS. 5A and 5B, a distance between the first sensor 66 and the position P11 is longer than a distance between the second sensor 68 and the position P11. As mentioned above, if a distance between one motion sensor and the movable portion is disposed so as to be different from a distance between the other motion sensor and the movable portion, a difference between relative positions of the movable portion and the motion sensors is likely to be reflected in a difference between detection values of the motion sensors. In other words, since the distances of the first sensor 66 and the second sensor 68 from the position P11 are different from each other, in a case where the head of the user is moved, there is a great difference between a detection value of the first sensor 66 and a detection value of the second sensor 68. For this reason, a motion detection unit 185 which will be described later can obtain a position of a movement center or a motion amount at the movement center on the basis of the difference between the detection values of the first sensor 66 and the second sensor 68.

Instead of the belt 2F, an arm (not illustrated) which is made of a synthetic resin or a metal and is rigid so as not to be easily deformed, or which is elastic, may be used. The arm has a configuration in which one end thereof is fixed to the end of the right holding unit 21 or the left holding unit 23, and the other end thereof is close to the back of the head of the user, and the first sensor 66 is disposed at the other end of the arm.

In this configuration, one of the first sensor 66 and the second sensor 68 is disposed on the front side of the head of the user, and the other sensor is disposed on the back of the head of the user. In other words, the first sensor 66 and the second sensor 68 are disposed at positions deviated relative to the position P1 or the position P11. In other words, one of the first sensor 66 and the second sensor 68 is disposed on one side of the position P1 or the position P11, and the other sensor is disposed on the other side of the position P1 or the position P11.

Therefore, in the same manner as in the configurations illustrated in FIGS. 1 to 4B, there is an advantage in that a motion at a movement center can be easily calculated.

In the configuration illustrated in FIGS. 5A and 5B, the second sensor 68 located on the front side of the head of the user may be disposed at the position P2 of the bridge portion 2C.

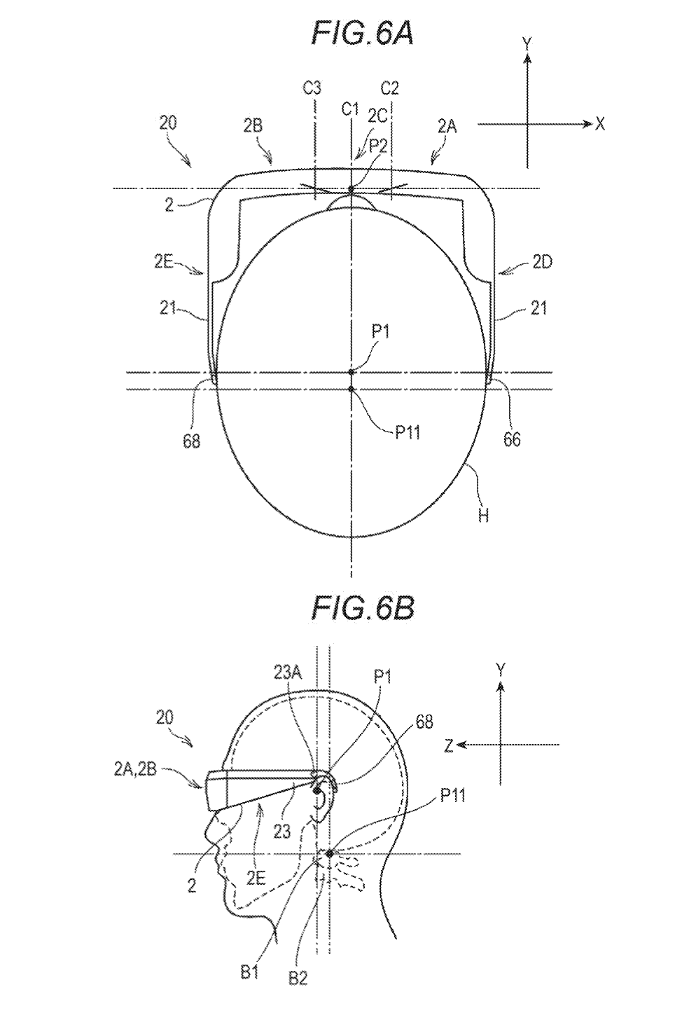

FIGS. 6A and 6B are diagrams illustrating still another example of a state in which the sensors are disposed in the head mounted display apparatus 100. FIG. 6A is a plan view, and FIG. 6B is a side view.

FIGS. 6A and 6B illustrate an example in which the first sensor 66 and the second sensor 68 are disposed near the center in the Z axis direction.

In the configuration example illustrated in FIGS. 6A and 6B, the first sensor 66 is disposed at the tip of the right holding unit 21, and the second sensor 68 is disposed at the tip of the left holding unit 23. The tips of the right holding unit 21 and the left holding unit 23 may be formed in hollow shapes, and the first sensor 66 and the second sensor 68 may be respectively accommodated in the tip of the right holding unit 21 and the tip of the left holding unit 23. Cases for accommodating the sensors may be respectively fixed to the tip of the right holding unit 21 and the tip of the left holding unit 23, and the first sensor 66 and the second sensor 68 may be accommodated in the cases.

In this configuration, one of the first sensor 66 and the second sensor 68 is located on the left head of the user, and the other sensor is located on the right head of the user. In other words, the first sensor 66 and the second sensor 68 are located at positions deviated relative to the position P1 or the position P11. In other words, one of the first sensor 66 and the second sensor 68 is disposed on one side of the position P1 or the position P11, and the other sensor is disposed on the other side of the position P1 or the position P11.

Therefore, in the same manner as in the configurations illustrated in FIGS. 1 to 4B, there is an advantage in that a motion at a movement center can be easily calculated.

In the example illustrated in FIGS. 6A and 6B, the first sensor 66 and the second sensor 68 are disposed at the positions of the ears of the user, or near the ears. In a case where the user wears the image display section 20, the tips of the right holding unit 21 and the left holding unit 23 are unlikely to be greatly deviated relative to the ears of the user. Therefore, it is possible to detect a motion of the head of the user at the positions which are unlikely to be influenced by the mounting state of the image display section 20. For example, in a case where a plurality of detection values which are detected at temporally different timings are compared with each other or are calculated, it is possible to obtain a more accurate result due to not being influenced by the mounting state. Since a motion can be detected at the substantially same height positions by using the first sensor 66 and the second sensor 68, there is advantageous in that a load of a process of calculation or the like of a movement center based on detection values is reduced.

A method of locating the first sensor 66 and the second sensor 68 at the positions of the ears of the user, or near the ears is not limited to the example illustrated in FIGS. 6A to 6B, and, for example, there may be a configuration in which the first sensor 66 is disposed at the right earphone 32, and the second sensor 68 is disposed at the left earphone 34. In this case, the first sensor 66 and the second sensor 68 are held in the positions of the cavities of the ears of the user, and can thus be stabilized at the positions which are still more unlikely to be influenced by the mounting state of the image display section 20.

In the configurations illustrated in FIGS. 5A to 6B, the first sensor 66 and the second sensor 68 may be replaced with each other. In the configuration illustrated in FIGS. 5A and 5B, the first sensor 66 and the second sensor 68 may be disposed as illustrated in FIGS. 1 to 4B, and then a third sensor may be fixed to the belt 2F. In the configuration illustrated in FIGS. 6A and 6B, the first sensor 66 and the second sensor 68 may be respectively disposed at the positions P3 and P4, and a third sensor and a fourth sensor may be respectively provided at the tip of the right holding unit 21 and the tip of the left holding unit 23.

FIG. 7 is a functional block diagram of the respective sections constituting the head mounted display apparatus 100.

The head mounted display apparatus 100 includes an interface 125 which couples the control device 10 to the various external apparatuses OA which are content supply sources. As the interface 125, for example, an interface associated with wired connection, such as a USB interface, a micro-USB interface, or a memory card interface may be used, and the interface 125 may be configured as a wireless communication interface. The external apparatuses OA are image supply apparatuses which supply images to the head mounted display apparatus 100, and include, for example, a personal computer (PC), a mobile phone, and a portable game machine.

The control device 10 includes the control unit 140, an input information acquisition unit 110, a storage unit 120, a transmission unit (Tx) 51, and a transmission unit (Tx) 52.

The input information acquisition unit 110 is coupled to an operation unit 135. The operation unit 135 includes the track pad 14, the direction key 16, the power switch 18, and the like, and the input information acquisition unit 110 acquires input content on the basis of a signal which is input from the operation unit 135. The control device 10 includes a power source unit (not illustrated), and supplies power to each unit of the control device 10 and the image display section 20.

The storage unit 120 is a nonvolatile storage device, and stores various computer programs and data related to the programs. The storage unit 120 may store data regarding still images or moving images which are displayed on the image display section 20.

The storage unit 120 stores set data 121. The set data 121 includes set values related to various processes performed by the control unit 140. For example, the set data 121 includes a set value such as a resolution in a case where an image processing unit 160 and a display control unit 170 process image signals. Set values included in the set data 121 may be a value which is input through an operation on the operation unit 135 in advance, and set values may be received from the external apparatuses OA or other apparatuses (not illustrated) via a communication unit 117 or the interface 125 and may be stored.

The storage unit 120 stores sensor position data 122 and content data 123. The sensor position data 122 includes calculation expressions, parameters, and the like used for a calculation process in the motion detection unit 185 which will be described later. The content data 123 includes image (still image or moving image) data for content which is AR-displayed by the AR display control unit 186, and/or audio data.

The control unit 140 is coupled to a sensor 113, a GPS 115, and the communication unit 117. The sensor 113 includes an inertial sensor such as an acceleration sensor or an angular velocity sensor, and the control unit 140 acquires a detection value of the sensor 113. The sensor 113 may be constituted of, for example, a three-axis acceleration sensor, or a nine-axis sensor including a three-axis acceleration sensor, a three-axis angular velocity sensor, and a three-axis magnetic sensor.

The GPS 115 includes an antenna (not illustrated), receives a global positioning system (GPS) signal, and calculates a current position of the control device 10. The GPS 115 outputs the current position or the current time obtained on the basis of a GPS signal, to the control unit 140. The GPS 115 may have a function of acquiring the current time on the basis of information included in a GPS signal, and of correcting a time point counted by the control unit 140.

The communication unit 117 performs wireless data communication conforming to a wireless communication standard such as a wireless LAN (WiFi (registered trademark)), Miracast (registered trademark), or Bluetooth (registered trademark).

In a case where the external apparatuses OA are wirelessly connected to the communication unit 117, the control unit 140 acquires the content data 123 from the communication unit 117 and displays an image on the image display section 20. On the other hand, in a case where the external apparatuses OA are connected to the interface 125 in a wired manner, the control unit 140 acquires the content data 123 from the interface 125 and displays an image on the image display section 20. Therefore, the communication unit 117 and the interface 125 function as a data acquisition unit DA which acquires the content data 123 from the external apparatuses OA.

The control unit 140 includes a CPU (not illustrated) which executes a program, a RAM (not illustrated) which temporarily stores the program executed by the CPU or data, and a ROM (not illustrated) which stores a fundamental control program executed by the CPU or data in a nonvolatile manner. The control unit 140 controls each unit of the head mounted display apparatus 100 by the CPU executing a control program. The control unit 140 reads a computer program stored in the storage unit 120 and executes the computer program, so as to realize various functions of the control unit 140. In other words, the control unit 140 functions as an operating system (OS) 150, the image processing unit 160, the display control unit 170, the imaging processing unit 181, the detection control unit 183, the motion detection unit 185, the AR display control unit 186, and the sound processing unit 187.

The image processing unit 160 acquires an image signal included in the content. The image processing unit 160 separates a synchronization signal such as the vertical synchronization signal VSync or the horizontal synchronization signal HSync from the acquired image signal. The image processing unit 160 generates a clock signal PCLK through the use of a PLL circuit or the like (not illustrated) on the basis of a cycle of the separated vertical synchronization signal VSync or horizontal synchronization signal HSync. The image processing unit 160 converts an analog image signal from which the synchronization signal is separated into a digital image signal by the use of an A/D conversion circuit or the like (not illustrated). The image processing unit 160 stores the converted digital image signal as image data (Data in FIG. 7) of a target image in the RAM of the control unit 140 for each frame. The image data is, for example, RGB data.

The image processing unit 160 may perform a resolution conversion process of converting a resolution of the image data into a resolution suitable for the right display driving unit 22 and the left display driving unit 24 as necessary. The image processing unit 160 may perform an image adjustment process of adjusting luminance or chroma of the image data, and a 2D/3D conversion process of creating 2D image data from 3D image data or creating 3D image data from 2D image data.

The image processing unit 160 transmits the clock signal PCLK, the vertical synchronization signal VSync, the horizontal synchronization signal HSync, and the image data Data stored in the RAM via the transmission units 51 and 52. The transmission units 51 and 52 function as transceivers for performing serial transmission between the control device 10 and the image display section 20. The image data Data transmitted via the transmission unit 51 is referred to as “right eye image data” and the image data Data transmitted via the transmission unit 52 is referred to as “left eye image data”.

The display control unit 170 generates a control signal for controlling the right display driving unit 22 and the left display driving unit 24, and controls generation and emission of image light of each of the right display driving unit 22 and the left display driving unit 24 by using the control signal. Specifically, the display control unit 170 controls the right LCD control portion 211 to control ON and OFF of driving of the right LCD 241 and controls the right backlight control portion 201 to control ON and OFF of driving of the right backlight 221. The display control unit 170 controls the left LCD control portion 212 to control ON and OFF of driving of the left LCD 242 and controls the left backlight control portion 202 to control ON and OFF of driving of the left backlight 222.

The imaging processing unit 181 controls the upper camera 61 to perform imaging so as to acquire captured image data.

The detection control unit 183 drives each of the first sensor 66 and the second sensor 68 so as to acquire detection values therefrom. For example, the first sensor 66 and the second sensor 68 are initialized so as to be brought into a detection possible state when power starts to be supplied to the head mounted display apparatus 100. The detection control unit 183 acquires a detection value of each of the first sensor 66 and the second sensor 68 in a preset sampling cycle. In the present embodiment, each of the first sensor 66 and the second sensor 68 outputs detection values of angular velocity of a rotation (pitch) around the X axis, a rotation (yaw) around the Y axis, and a rotation (roll) around the Z axis. The detection values may include a size and a rotation direction of angular velocity.

The motion detection unit 185 calculates a motion amount at a movement center on the basis of the detection values of the first sensor 66 and the second sensor 68, acquired by the detection control unit 183. The movement center is the center of a motion of the head of the user or a reference location, obtained on the basis of the motion detected by the first sensor 66 and the second sensor 68. For example, in a case where the head of the user is rotated, the center of the rotation corresponds to a movement center. For example, in a case where the head of the user is moved forward straight, a position of a movement center is not defined as a single specific point, but, in this case, for convenience, the movement center (P1 in FIGS. 3A and 3B or P11 in FIGS. 4A and 4B) is set as a movement center.

The motion detection unit 185 performs calculation of head tracking by using the sensor position data 122 stored in the storage unit 120. The sensor position data 122 includes data indicating a relative positional relationship between or absolute positions of the position P3 of the first sensor 66 and the position P4 of the second sensor 68. The sensor position data 122 may include data indicating a positional relationship between each of the position P3 and the position P4, and the position P1 (or P11) and/or the position P2. The sensor position data 122 includes a calculation expression, a table, a parameter, and the like used to calculate a motion amount at a movement center and a motion direction on the basis of the detection values of the first sensor 66 and the second sensor 68. Here, the motion detection unit 185 may calculate a position of a movement center on the basis of detection results from the first sensor 66 and the second sensor 68. Alternatively, a motion amount at a movement center may be calculated instead of calculating the position of the movement center. The motion amount may be velocity, may include velocity and time, and may be a movement amount.

For example, the motion detection unit 185 obtains a component around the X axis, a component around the Y axis, and a component around the Z axis on the basis of the detection values of the angular velocity from the first sensor 66 and the second sensor 68. The motion detection unit 185 obtains the center of the rotation around the X axis, the center of the rotation around the Y axis, and the center of the rotation around the Z axis on the basis of the detection values of the first sensor 66 and the second sensor 68, and the positions of the first sensor 66 and the second sensor 68 of the sensor position data 122. The motion detection unit 185 obtains the center of a three-dimensional motion, that is, a position of a movement center, a direction of the motion at the movement center, and the magnitude (or strength) of the motion at the movement center.

The motion detection unit 185 may obtain not only a direction and a magnitude of a motion at a movement center but also a direction and/or a magnitude of a motion at a predefined point. For example, a direction and/or a magnitude of a motion at the position P1 (or position P11) may be obtained. In a case where the motion detection unit 185 is set to obtain a direction and/or a magnitude of a motion at the position P1 (or position P11), the motion detection unit 185 calculates and outputs a direction and/or a magnitude of a motion at the position P1 on the basis of a direction and/or a magnitude of a motion at a movement center if the movement center does not overlap the position P1 (or P11). The position P1 (or P11) is not limited to a position in the horizontal plane, and a direction and/or a magnitude of a motion may be obtained at a three-dimensional position which specifies a position of the user in the height direction (Z axis direction).

As an example of a process of obtaining a movement center by using the first sensor 66 and the second sensor 68, there is a method of using positions before and after a motion (movement) of the user's body (especially, the head) is performed in order to detect the motion by using the first sensor 66 and the second sensor 68. In this method, a position of the first sensor 66 and a position of the second sensor 68 before a movement is performed are connected via a straight line (referred to as a first straight line), a middle point thereof is obtained, and a straight line (referred to as a second straight line) which passes through the middle point and is perpendicular to the first straight line is obtained. In addition, a position of the first sensor 66 and a position of the second sensor 68 after the movement is performed are connected via a straight line (referred to as a third straight line), a middle point thereof is obtained, and a straight line (referred to as a fourth straight line) which passes through the middle point of the third straight line and is perpendicular to the third straight line is obtained. An intersection between the second straight line and the fourth straight line may be obtained as a position of a movement center.

As an example of a process of detecting a motion of the head at the center of a movement in a case of detecting the motion of the head of the user by using the first sensor 66 and the second sensor 68, there is a process of obtaining an angle of a rotational movement. In this process, for example, a straight line (referred to as a fifth straight line) which connects a position of the first sensor 66 before a movement is performed to a position of the first sensor 66 after the movement is performed is obtained, and position coordinates of a middle point of the fifth straight line are obtained. Next, (I) a distance (DY) between the position coordinates of the middle point of the fifth straight line and the movement center is obtained. (II) A distance (DX) between the position of the first sensor 66 before the movement is performed to the position of the first sensor 66 after the movement is performed is obtained. Calculation using the following Equation (1) is performed on the distance DX and the distance DY so that an angle θ of the rotational movement of the first sensor 66 can be obtained. The angle θ is a rotation angle (momentum) in a rotational movement of the first sensor 66 centering on the movement center.

θ=2 arctan(DX/2DY) (1)

The method using the above Equation (1) is also applicable to a case of obtaining an angle of a rotational movement of the second sensor 68. An average value of an angle of a rotational movement of the first sensor 66 and an angle of a rotational movement of the second sensor 68 may be obtained, and the average value may be obtained as a rotation angle at a movement center.

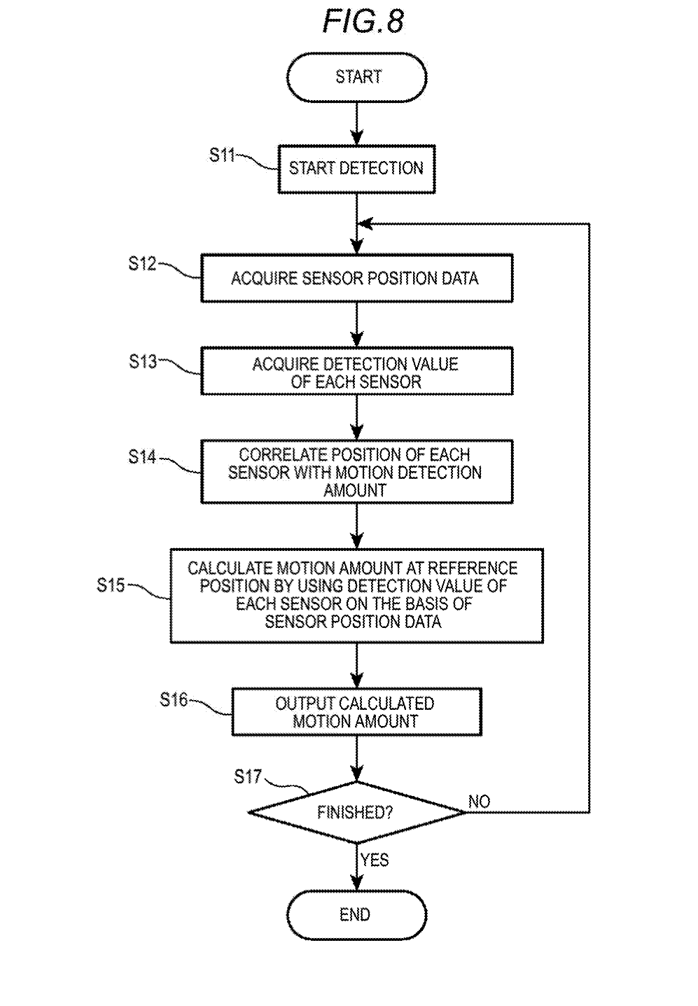

The exemplified method may be performed, for example, in step S15 of FIG. 8 which will be described later.

The AR display control unit 186 reads the content data 123 stored in the storage unit 120, and controls the image processing unit 160 and the display control unit 170 so that the image display section 20 displays an AR display image. In a case where the content data 123 includes audio data, the AR display control unit 186 controls the sound processing unit 187 so that the right earphone 32 and the left earphone 34 output audio content.

The AR display control unit 186 controls display of AR content on the basis of data indicating a direction of a motion and a motion amount at a movement center which are output from the motion detection unit 185.

The AR display control unit 186 displays the AR content in a state in which the user sees a target object through the image display section 20. The AR display control unit 186 performs AR display for displaying an image or text at a position corresponding to the target object so as to provide information regarding the target object, or so as to change the way of viewing a shape of the target object which is seen through the image display section 20. The AR content includes data regarding an image or text displayed at the position corresponding to the target object. The AR content may include data for specifying a target object, data regarding a display position of an image or text, and the like. The display position of the AR content may be a position where the AR content overlaps the target object, and may be the vicinity of the target object. The target object may be an object, a real estate such as a building, a moving object such as an automobile or an electric train, or a living thing such as a human or an animal. The AR display control unit 186 detects a target object located in a visual field of the user from captured image data acquired by the imaging processing unit 181. The AR display control unit 186 determines a display position of AR content corresponding to the detected target object, and displays the AR content at the position.

The AR display control unit 186 performs a process of changing a display position of the AR content or a process of switching the AR content in accordance with a motion of the head of the user wearing the image display section 20. For example, in a case where the head of the user performs a rotational movement around the Z axis at angular velocity which exceeds a set value, the AR display control unit 186 erases the display of the AR content. In a case where there is such a motion of the head, there is a high possibility that a visual field of the user is considerably moved, and thus the target object of the AR display disappears from the visual field. For example, in a case where the head of the user is moved in the X axis direction, the AR display control unit 186 enlarges or reduces a display size of the AR content. In a case where there is such a motion of the head, the enlarged target object of the AR display appears large to the user. For this reason, the AR display control unit 186 causes the AR content to be easily viewed by enlarging the AR content, and may reduce the AR content so that the target object is easily viewed.

A method in which the AR display control unit 186 changes a display aspect of the AR content so as to correspond to a motion of the head of the user may be set in advance by a set value included in the set data 121. The method may be set by a program executed by the control unit 140.

Here, display control performed by the AR display control unit 186 is designed to be performed according to a process corresponding to a motion at the center (P1 in FIGS. 3A and 3B) of the head of the user, the center (P2 in FIG. 3A) of the front portion of the head, or the cervical vertebra (P11 in FIGS. 4A and 4B). This is because, if the control is performed in accordance with a motion at the center of the head, the center of the front portion of the head, or the cervical vertebra, a display change can be easily generated as an image when the display change is designed, the control is simple and thus an error is unlikely to occur, and an effective display change can be designed. For this reason, a set value of a motion at the center of the head of the user, the center of the front portion of the head, or the cervical vertebra is set in the set data 121. The AR display control unit 186 processes a motion at the center of the head of the user, the center of the front portion of the head, or the cervical vertebra, calculated by the motion detection unit 185, through comparison and contrast with the set data 121.

As a method which is different from the above-described method, display control performed by the AR display control unit 186 may be designed so as to correspond to a motion at the positions of the first sensor 66 and the second sensor 68 which actually detect a motion. For example, set values regarding detection values of the first sensor 66 and the second sensor 68 are set in the set data 121, and the AR display control unit 186 performs a process on the basis of the set values. Also in this case, display can be controlled so as to correspond to a motion of the head of the user. However, these set values are values fixed to the positions of the first sensor 66 and the second sensor 68, and new set values are necessary in a case where the positions or the number of the sensors are changed due to a specification change of the head mounted display apparatus 100.

In contrast, in the method of calculating a reference location for a motion, and a motion at the reference location on the basis of detection values of the first sensor 66 and the second sensor 68, set values are not specific to the apparatus and are generally used. Therefore, there is an advantage in that control of a display aspect of the AR content is facilitated, and thus effective AR display can be performed.

The sound processing unit 187 acquires a sound signal included in the content, amplifies the acquired sound signal, and supplies the amplified sound signal to the right earphone 32 and the left earphone 34 under the control of the AR display control unit 186. The sound processing unit 187 acquires sound collected by the microphone 63 and converts the sound into digital audio data. The sound processing unit 187 may perform a preset process on the digital audio data.

The image display section 20 includes an interface 25, the right display driving unit 22, the left display driving unit 24, the right light guide plate 261 as the right optical image display unit 26, and the left light guide plate 262 as the left optical image display unit 28. The image display section 20 includes the upper camera 61, the first sensor 66, and the second sensor 68 described above. The upper camera 61 is provided in the camera unit 3 separately from the frame 2 (FIG. 1), but is coupled to the interface 25.

The interface 25 includes a connector to which the right cord 42 and the left cord 44 are coupled. The interface 25 outputs the clock signal PCLK, the vertical synchronization signal VSync, the horizontal synchronization signal HSync, and the image data Data transmitted from the transmission unit 51, to corresponding reception portions (Rx) 53 and 54. The interface 25 outputs the control signal transmitted from the display control unit 170 to the corresponding reception portions 53 and 54, and the right backlight control portion 201 or the left backlight control portion 202.

The interface 25 is an interface which couples the upper camera 61, the first sensor 66, and the second sensor 68 to each other. Captured image data or an imaging signal from the upper camera 61, detection results from the first sensor 66 and the second sensor 68, and the like are sent to the control unit 140 via the interface 25.

The right display driving unit 22 includes the right backlight 221, the right LCD 241, and the right projection optical system 251 described above. The right display driving unit 22 includes the reception portion 53, a right backlight (BL) control portion 201 which controls the right backlight (BL) 221, and a right LCD control portion 211 which controls the right LCD 241.

The reception portion 53 operates as a receiver corresponding to the transmission unit 51 so as to perform serial transmission between the control device 10 and the image display section 20. The right backlight control portion 201 drives the right backlight 221 on the basis of an input control signal. The right LCD control portion 211 drives the right LCD 241 on the basis of the clock signal PCLK, the vertical synchronization signal VSync, the horizontal synchronization signal HSync, and the right eye image data Data, which are input via the reception portion 53.

The left display driving unit 24 has the same configuration as that of the right display driving unit 22. The left display driving unit 24 includes the left backlight 222, the left LCD 242, and the left projection optical system 252 described above. The left display driving unit 24 includes the reception portion 54, a left backlight control portion 202 which drives the left backlight 222, and a left LCD control portion 212 which drives the left LCD 242.

The reception portion 54 operates as a receiver corresponding to the transmission unit 52 so as to perform serial transmission between the control device 10 and the image display section 20. The left backlight control portion 202 drives the left backlight 222 on the basis of an input control signal. The left LCD control portion 212 drives the left LCD 242 on the basis of the clock signal PCLK, the vertical synchronization signal VSync, the horizontal synchronization signal HSync, and the left eye image data Data, which are input via the reception portion 54.

The right backlight control portion 201, the right LCD control portion 211, the right backlight 221, and the right LCD 241 are collectively referred to as a right “image light generation unit”. Similarly, the left backlight control portion 202, the left LCD control portion 212, the left backlight 222, and the left LCD 242 are collectively referred to as a left “image light generation unit”.

FIG. 8 is a flowchart illustrating an operation of the head mounted display apparatus 100, and, particularly illustrates an operation in which the control unit 140 obtains a motion of the head of the user.

During the supply of to the head mounted display apparatus 100, the control unit 140 starts detection in the sensors when display of the AR content is started or when an instruction for starting the detection is given through an operation on the operation unit 135 (step S11). The motion detection unit 185 of the control unit 140 acquires the sensor position data 122 from the storage unit 120 (step S12), and the detection control unit 183 acquires detection values of the first sensor 66 and the second sensor 68 (step S13).

The motion detection unit 185 correlates the detection value of the first sensor 66 acquired by the detection control unit 183 with data regarding the position of the first sensor 66 included in the sensor position data 122 (step S14). In step S14, the motion detection unit 185 correlates the detection value of the second sensor 68 acquired by the detection control unit 183 with data regarding the position of the second sensor 68 included in the sensor position data 122.

The detection control unit 183 acquires the detection values of the first sensor 66 and the second sensor 68 in a preset sampling frequency. In a case where the control unit 140 repeatedly executes steps S11 to S17 of FIG. 8, and an execution cycle is longer than the sampling frequency in the detection control unit 183, the detection control unit 183 may output a value such as a sum value, an average value, or a median of detection values for multiple times in step S13. In this case, in step S14, the motion detection unit 185 correlates the value such as a sum value, an average value, or a median obtained on the basis of the detection values for multiple times, with the data regarding the position of each sensor.

The motion detection unit 185 calculates a direction of the motion and an amount of the motion at the movement center by using the detection values of the first sensor 66 and the second sensor 68 on the basis of the sensor position data 122 (step S15). The motion detection unit 185 outputs data regarding the calculated direction of the motion and amount of the motion to the AR display control unit 186 (step S16), and proceeds to step S17.

In step S15, for example, as described above, a process may be performed in which a position of the movement center is obtained on the basis of positions of the first sensor 66 and the second sensor 68 before and after a movement is performed. As described above, as a process of detecting a motion of the head at a movement center, a process may be performed in which an angle of a rotational movement is obtained by using the above Equation (1).

In step 17, the control unit 140 determines whether or not a motion detection finish condition is satisfied (step S17), and finishes the present process if the finish condition is satisfied (YES in step S17). If the finish condition is not satisfied (NO in step S17), the flow returns to step S12.

In the process illustrated in FIG. 8, the detection values of the first sensor 66 and the second sensor 68 are acquired via the interface 25 through the operation of the detection control unit 183, and are processed by the motion detection unit 185. Here, the detection values which are acquired by the detection control unit 183 and are processed by the motion detection unit 185 may be added with information for specifying a sensor detecting the value or information indicating a timing at which the detection values is acquired. In this case, when the first sensor 66 and/or the second sensor 68 output(s) the detection values to the interface 25, data indicating whether a sensor detecting the detection values is the first sensor 66 or the second sensor 68, and data indicating timing at which the detection values are acquired may be added to the detection values. Alternatively, when the detection control unit 183 acquires the detection values of the first sensor 66 and/or the second sensor 68, data indicating whether a sensor detecting the detection values is the first sensor 66 or the second sensor 68, and data indicating timing at which the detection values are acquired may be added to the detection value.

When the motion detection unit 185 acquires the detection values of the detection control unit 183, data indicating whether a sensor detecting the detection values is the first sensor 66 or the second sensor 68, and data indicating timing at which the detection values are acquired may be added to the detection value.

The control unit 140 can perform control AR display performed by the image display section 20 or a process regarding a captured image acquired by the upper camera 61 by using the position of the movement center obtained through the process illustrated in FIG. 8.

Hereinafter, the process will be described.

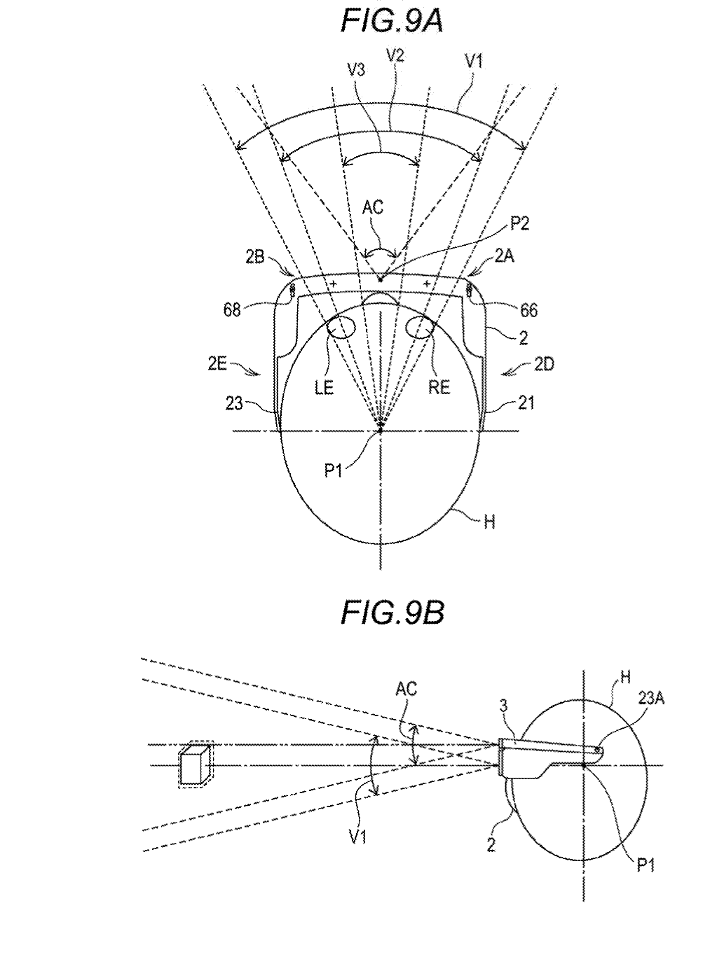

FIGS. 9A and 9B are diagrams illustrating an example of a relative position between an imaging region of the upper camera 61 and a visual field of the user. FIG. 9A is a plan view, and FIG. 9B is a side view.

In the example illustrated in FIGS. 9A and 9B, a position of a movement center will be described as the position P1 of the center of the head H. The upper camera 61 is disposed at the position P2, the first sensor 66 is located at the left end of the front surface of the frame 2, and the second sensor 68 is located at the right end of the front surface of the frame 2.

A range which can be visually recognized by the user, that is, a visual field of the user is a range which spreads forward centering on the position of the right eye RE and the position of the left eye LE. In a case where the position P1 corresponding to the center of the head or the position P11 corresponding to the cervical vertebra is specified as a position of a movement center, a visual field of the user can be estimated with the position P1 or the position P11 as a reference. Both of the positions P1 and P11 are roughly located on a central line of the right eye RE and the left eye LE, and are located on the rear side of the right eye RE and the left eye LE. Therefore, if a range which spreads forward at a predetermined angle from the position P1 or P11, this range relatively highly matches the visual field of the user. In other words, it is possible to spuriously obtain a range which roughly corresponds to the visual field of the user by using the position P1 or P11 as a reference.

Generally, a human visual field has a range of about 200 degrees in the horizontal direction and about 125 degrees in the vertical direction. A discrimination visual field close to the center of the range is a central region in which the most excellent visual function such as eyesight is exhibited, and has a range of about ±5 degrees with respect to a visual line direction. An effective visual field which provides a lot of information is wider than the discrimination visual field and has an angle of about 30° in the horizontal direction and about 20° in the vertical direction. A stable gazing field in which a gazing point at which a human gazes is rapidly stabilized and is viewed has a range from 60 degrees to 90 degrees in the horizontal direction and a range from 45 degrees to 70 degrees in the vertical direction. As mentioned above, regarding a visual field, the numerical values obtained empirically on the basis of physiologically or anatomically statistics of the human visual characteristics are generally known. On the basis of the numerical values, parameters for defining directions and angles of the stable gazing field, the effective visual field, and the discrimination visual field when using the position P1 or P11 as a reference can be obtained, and thus the parameters can be stored in, for example, the storage unit 120 in advance.

In the example illustrated in FIG. 9A, visual fields V1 to V3 of the user are specified with the position P1 of the movement center specified through the process illustrated in FIG. 8 are specified. Accurately, the visual fields V1 to V3 illustrated in FIG. 9A are visual fields which are estimated on the basis of the parameters stored in the head mounted display apparatus 100, but are considered to roughly match real visual fields of the user.

The widest visual field V1 corresponds to the stable gazing field of the user, the visual field V2 corresponds to the effective visual field, and the visual field V3 corresponds to the discrimination visual field. The control unit 140 performs a process of obtaining one or more of the visual fields V1 to V3.

Here, an imaging region (angle of view) of the upper camera 61 is indicated by the reference sign AC in FIG. 9B. The imaging region of the upper camera 61 is defined by optical characteristics of an imaging lens (not illustrated) of the upper camera 61, sizes of imaging elements (not illustrated) included in the upper camera 61, and the like. The position of the upper camera 61 is in front of the right eye RE and the left eye LE. For this reason, relative positions of the visual field of the user and the imaging region of the upper camera 61 may not match each other.

It cannot be said that the position of the upper camera 61 in the height direction matches the positions of the right eye RE and the left eye LE in the height direction. In a case where the upper camera 61 is disposed in the camera unit 3 on the frame 2, the upper camera 61 is located over the right eye RE and the left eye LE. In this case, as illustrated in FIG. 9B, the visual field (for example, the stable gazing field V1) of the user and the imaging region AC of the upper camera 61 are deviated relative to each other in the height direction.

A position of the upper camera 61 is not limited to the position P2 corresponding to the center on the front surface side of the frame 2, and the upper camera 61 may be provided at, for example, the end of the frame 2 on the right portion 2A side or the end of the frame 2 on the left portion 2B side. In this case, a position of the center of the imaging region of the upper camera 61 in the horizontal direction and a position of the center of the visual field of the user are deviated relative to each other, and thus the visual field (for example, the stable gazing field V1) of the user is deviated relative to the imaging region AC of the upper camera 61 in the horizontal direction.

Through the operation illustrated in FIG. 8, the motion detection unit 185 calculates a direction of the motion and an amount of the motion at the movement center (step S15), and outputs data regarding the calculated direction of the motion and amount of the motion to the AR display control unit 186 (step S16). The AR display control unit 186 controls display of AR content on the image display section 20 on the basis of the data regarding the calculated direction of the motion and amount of the motion, which is output from the motion detection unit 185. In this case, if a display position or the like of the AR content is adjusted in consideration of a relative position between the visual field of the user and the imaging region of the upper camera 61, the AR content can be displayed at a position matching the visual field of the user. Consequently, it can be expected that visibility of the AR content is improved.

The AR display control unit 186 may detect a target object from a captured image data acquired by the upper camera 61, and may display the AR content at a display position corresponding to the detected target object. In this case, by performing a process in consideration of a relative position between the imaging region of the upper camera 61 and the visual field of the user, it is possible to more accurately obtain a position where the target object detected from the captured image data is visually recognized by the user.

As mentioned above, since a relative position between the imaging region of the upper camera 61 and the visual field of the user is obtained on the basis of the position of the movement center specified by the motion detection unit 185, and the relative position is used, a higher visual effect can be expected by increasing accuracy of AR display.

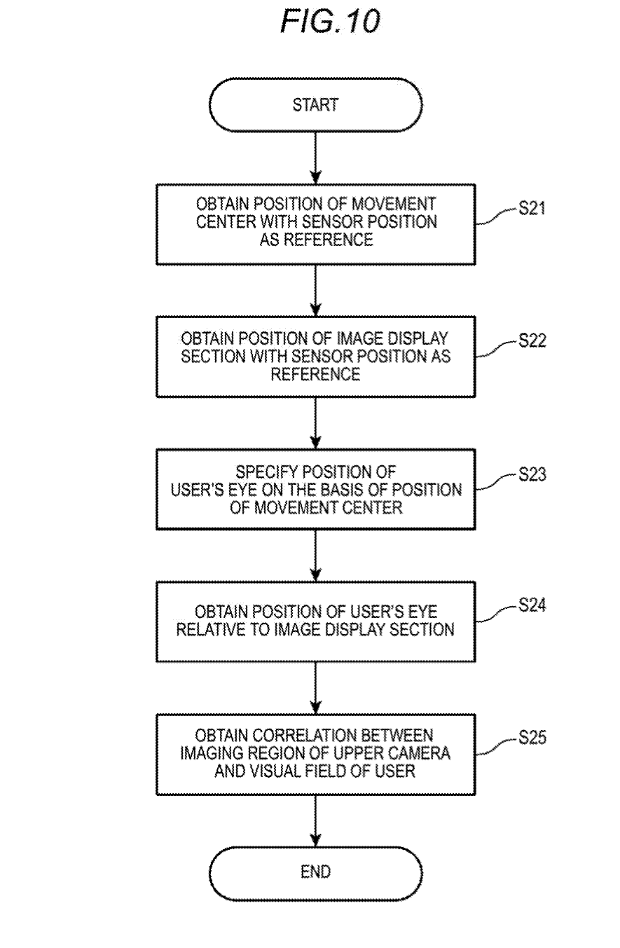

FIG. 10 is a flowchart illustrating an operation of the head mounted display apparatus 100, and, particularly, illustrating a process of obtaining a relative position between an imaging region of the upper camera 61 and a visual field of the user.

For example, when a motion amount at a movement center (reference location; herein, the position P1 or P11) is obtained on the basis of detection values of each motion sensor in step S15 of FIG. 8, the motion detection unit 185 obtains a position of the movement center. The position may be calculated on the basis of the sensor position data 122 indicating the positions of the first sensor 66 and the second sensor 68, for example. As mentioned above, the motion detection unit 185 obtains the position of the movement center with the positions of the first sensor 66 and the second sensor 68 as a reference on the basis of the sensor position data 122 (step S21).

Next, the motion detection unit 185 obtains a relative position of the image display section 20 relative to the positions of the first sensor 66 and the second sensor 68 on the basis of the sensor position data 122 (step S22). The motion detection unit 185 specifies positions of the right eye RE and the left eye LE of the user by using the position of the movement center obtained in step S21 (step S23).

The motion detection unit 185 obtains positions of the right eye RE and the left eye LE of the user relative to the image display section 20 on the basis of the position obtained in step S22 and the positions obtained in step S23 (step S24). The relative positions obtained here indicate mounting states (mounting positions) in which the user wears the image display section 20 (specifically, the frame 2), and reflect positional relationships between the right eye RE and the left eye LE, and a display regions in which the right optical image display unit 26 and the left optical image display unit 28 display images.

The motion detection unit 185 obtains a correspondence relationship between the imaging region of the upper camera 61 and the visual field of the user on the basis of data indicating the position of the upper camera 61 in the image display section 20 and the relative positions obtained in step S24 (step S25). The position of the upper camera 61 in the image display section 20 is fixed, and data indicating the position may be stored in the storage unit 120. In a case where the camera unit 3 is moved with respect to the frame 2, a position of the camera unit 3 relative to the frame 2 may be obtained according to methods described in third to seventh embodiments which will be described later. In this case, a result of the process of obtaining the position of the camera unit 3 relative to the frame 2 may be used in step S25.

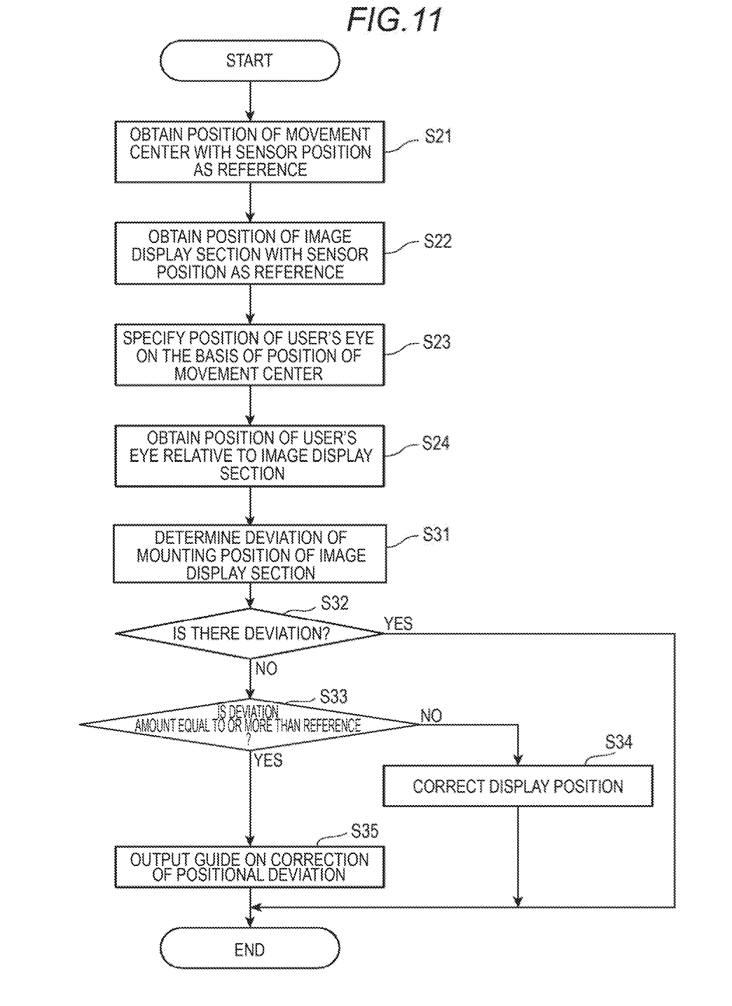

FIG. 11 is a flowchart illustrating an operation of the head mounted display apparatus 100, and, particularly, illustrating a process of determining a state in which the user wears the frame 2.

In the example illustrated in FIG. 11, it is determined whether or not a mounting position of the image display section 20 is deviated on the head of the user and is thus deviated relative to an expected position according to the same method as in the process described in FIG. 10.

In FIG. 11, steps S21 to S24 are the same as described with reference to FIG. 10.

The motion detection unit 185 determines a mounting position of the image display section 20 on the basis of the relative positions of the right eye RE and the left eye LE relative to the image display section 20 obtained in step S24 (step S31). In step S31, for example, the positions of the right eye RE and the left eye LE relative to the image display section 20 are converted into a value of a deviation amount indicating a positional difference, and the value is compared with a threshold value which is stored in the storage unit 120 in advance.

The motion detection unit 185 determines whether or not the mounting position of the image display section 20 is deviated (step S32). The motion detection unit 185 determines whether or not the mounting position of the image display section 20 is deviated on the basis of the threshold value or a reference value stored in the storage unit 120.

If it is determined that the mounting position of the image display section 20 is deviated (NO in step S32), the motion detection unit 185 determines whether or not the deviation amount is equal to or larger than a reference amount (step S33). If it is determined that the deviation amount is smaller than the reference amount (NO in step S33), the motion detection unit 185 outputs data indicating the deviation amount to the AR display control unit 186, and the AR display control unit 186 corrects a position of AR display so as to compensate for the deviation (step S34).

If it is determined that the deviation amount is equal to or larger than the reference amount (YES in step S33), a guide on the user is output so that the deviation of the mounting position of the image display section 20 is corrected under the control of the control unit 140 (step S35). For example, the motion detection unit 185 outputs a command for giving an instruction for outputting the guide, to the AR display control unit 186, and the AR display control unit 186 displays a message for prompting correction of the deviation of the mounting position of the image display section 20. The control unit 140 may cause the sound processing unit 187 to output sound for correction of the deviation of the mounting position of the image display section 20 from the right earphone 32 and the left earphone 34.

In a case where it can be regarded that the mounting position of the image display section 20 is not deviated (YES in step S32), the motion detection unit 185 finishes the present process.

As mentioned above, in a case where the control unit 140 obtains the position of the movement center on the basis of the detection values of the first sensor 66 and the second sensor 68, it is possible to determine whether or not a mounting state of the image display section 20 is appropriate on the basis of the obtained position of the movement center. It is possible to prompt the user to correct a position of AR display or to correct the mounting state of the image display section 20 according to the mounting state of the image display section 20.

In the operation illustrated in FIG. 11, positions of the right eye RE and the left eye LE relative to the image display section 20 are obtained in step S24, but a slope of the image display section 20 may be directly detected. For example, as illustrated in FIGS. 6A and 6B, in a case where the first sensor 66 and the second sensor 68 are respectively disposed at the tips of the right holding unit 21 and the left holding unit 23, acceleration or angular velocity can be detected substantially at the same height by the first sensor 66 and the second sensor 68. For this reason, it is possible to more easily determine a mounting state of the image display section 20 on the basis of detection values of the first sensor 66 and the second sensor 68. As described above, the same effect can also be achieved in the configuration in which the first sensor 66 and the second sensor 68 are respectively provided at the right earphone 32 and the left earphone 34.

The control unit 140 may correct blurring in an image captured by the upper camera 61 by using detection values of the first sensor 66 and the second sensor 68.

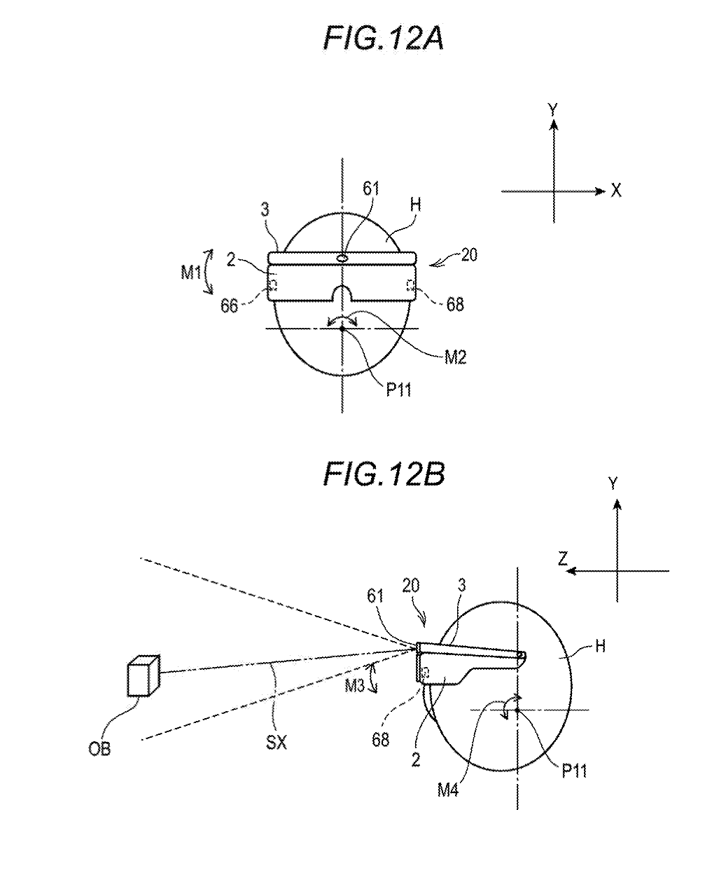

FIGS. 12A and 12B are diagrams illustrating an influence of a motion of the head of the user, in which FIG. 12A is a front view and FIG. 12B is a side view. FIGS. 12A and 12B exemplify that the position P11 is specified as a position of a movement center.

If the head of the user is moved while the upper camera 61 is performing imaging, blurring occurs in a captured image. For example, in a case where the head of the user is moved around the Z axis as indicated by an arrow M1 in FIG. 12A, this motion causes blurring in an image captured by the upper camera 61 in the left and right directions. In a case where the head of the user is moved around the X axis as indicated by an arrow M3 in FIG. 12B, this motion causes blurring in a captured image in the upper and lower directions. Although not illustrated, in a case where the head of the user is moved around the Y axis, the motion causes blurring in an image captured by the upper camera 61 in the left and right directions.

For example, through the process illustrated in FIG. 8, the motion in the direction of the arrow M1 can be obtained as a motion in a direction of an arrow M2 at the position P11 of the movement center. Similarly, the motion in the direction of the arrow M3 can be obtained as a motion in a direction of an arrow M4 at the position P11 of the movement center.

As mentioned above, in the head mounted display apparatus 100, a motion of the head of the user which causes blurring in an image captured by the upper camera 61 can be obtained as a motion at a movement center.

A motion of the head of the user includes a case where the user moves the head in order to intentionally move a visual line direction. Such a motion is referred to as a motion based on a cognitive action of the user. The cognitive action is a motion in which the user intentionally moves the head in order to recognize a target object OB which is out of the center of a visual field of the user. In contrast, the head or the body of the user may be moved without having an intention to move a visual line thereof. This motion can be said to be a motion not being based on a cognitive action.

In a case where the user performs a cognitive action, an imaging region of the upper camera 61 is preferably moved in tracking of a motion of the head. In contrast, if an imaging region of the upper camera 61 is moved due to a motion which is not a cognitive action, a motion in a captured image is so-called blurring, and the motion in the captured image is preferably slight.

Therefore, the head mounted display apparatus 100 of the present embodiment obtains a motion at a movement center on the basis of detection values of the first sensor 66 and the second sensor 68 which are a plurality of motion sensors, and determines whether or not the obtained motion corresponds to a cognitive action.

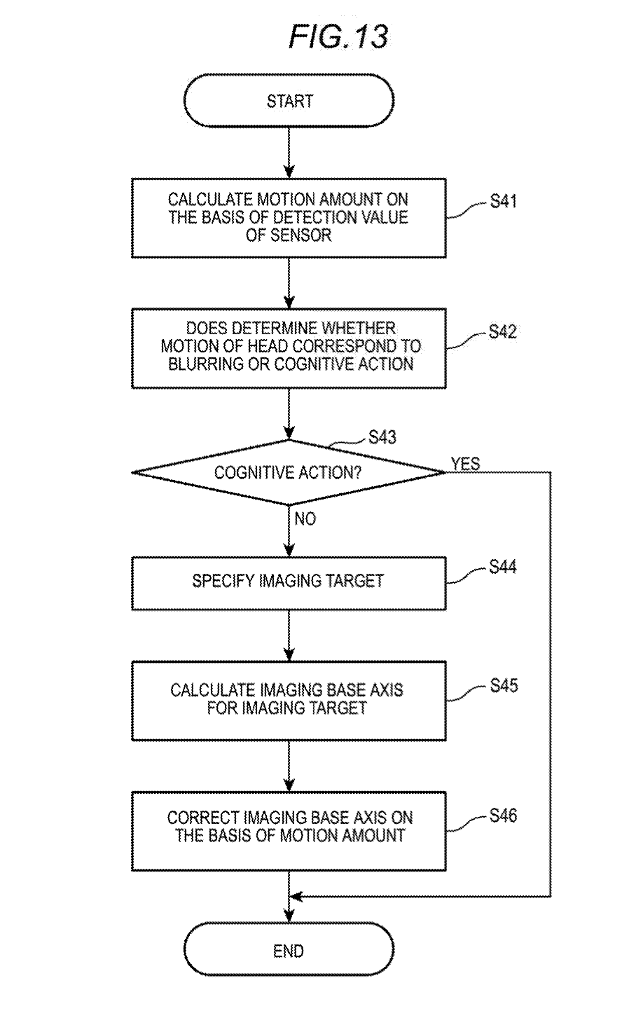

FIG. 13 is a flowchart illustrating an operation of the head mounted display apparatus 100, and, particularly, illustrating a process of determining whether or not a motion of the head of the user is a cognitive action.

The motion detection unit 185 calculates a motion amount at the movement center (a reference location; herein, the position P1 or P11) on the basis of the detection values of each motion sensor, for example, through the process in step S15 of FIG. 8 (step S41). The motion detection unit 185 determines whether the detected motion is a motion (blurring) which is not based on a cognitive action or a motion based on the cognitive action on the basis of the motion amount obtained in step S41 (step S42). In step S42, the determination is performed by comparing the motion amount obtained in step S41 and a direction of the motion with comparison data defining a motion amount and a pattern of a motion of the blurring. The comparison data may be stored, for example, in the storage unit 120 in advance.

In a case where the motion corresponds to the cognitive action as a result of the determination (YES in step S43), the motion detection unit 185 finishes the present process.

In a case where the motion does not correspond to the cognitive action (NO in step S43), that is, the motion calculated in step S41 is blurring, the motion detection unit 185 starts correction of the blurring by using the imaging processing unit 181.

The imaging processing unit 181 detects an image of the target object OB from the captured image data acquired by the upper camera 61, and specifies a position of the imaging target in the captured image (step S44). The imaging processing unit 181 calculates an imaging base axis which is a straight line connecting the specified imaging target to the upper camera 61 (step S45). An example of the imaging base axis is indicated by the reference sign SX in FIG. 12B. The imaging base axis SX is an axis which connects the upper camera 61 to the target object OB, and does not match an optical axis of the upper camera 61. The imaging base axis SX is a virtually obtained axis, and may use a position of the imaging element (not illustrated) of the upper camera 61 as a reference or may use a position of the imaging lens (not illustrated) of the upper camera 61 as a reference.

In a case where the imaging base axis obtained in step S45 is moved, the imaging processing unit 181 corrects the captured image data so as to compensate for the motion (step S46). For example, the imaging processing unit 181 incorporates captured image data obtained by the upper camera 61 every predetermined time, and corrects the captured image data on the basis of the motion amount and the direction of the motion calculated in step S41. The motion of the imaging base axis SX is cancelled out by the correction. Specifically, the captured image data is corrected so that a position of an image of the target object OB in the captured image data is not moved.

Consequently, since blurring in a captured image from the upper camera 61 is minimized or removed, in a case where the AR display control unit 186 performs display by using the captured image, blurring in the displayed image is minimized and thus it is possible to prevent or reduce motion sickness in a user. Also in a case where a captured image from the upper camera 61 is stored in the storage unit 120 as a moving image (video image), and the stored moving image is reproduced by the head mounted display apparatus 100 or other apparatuses, it is possible to prevent or reduce motion sickness in a viewer.

As described above, the head mounted display apparatus 100 which is mounted on the head of the user includes the image display section 20 which irradiates the eyes of the user with image light, and the first sensor 66 and the second sensor 68 as a plurality of motion sensors. The first sensor 66 and the second sensor 68 are disposed at positions deviated relative to the user's body in a mounting state of the head mounted display apparatus 100. Consequently, it is possible to rapidly obtain a motion amount or a direction of a motion at the center of the motion (movement center) in a case where the user's body is moved by using detection results from the first sensor 66 and the second sensor 68 at the deviated positions. The first sensor 66 and the second sensor 68 may be disposed at positions deviated relative to each other with respect to the reference location of the head or the neck of the user. More specifically, relative positions of the first sensor 66 and the second sensor 68 may be deviated positions by using a neck joint serving as the center when the head of the user is moved, or the center of the head as a reference. In this case, in a case where the head of the user is moved, it is possible to analyze the motion of the head of the user on the basis of a difference between detection values of the first sensor 66 and the second sensor 68 caused by the motion. Consequently, for example, it is possible to obtain a motion at the neck joint as the center of the motion, or at the center of the head.

There may be a configuration in which one of the first sensor 66 and the second sensor 68 as a plurality of motion sensors is located on one side of the center of the head, and the other motion sensor is located on the other side of the center of the head, in a mounting state. In this case, in a case where the head of the user is moved, it is possible to rapidly obtain a motion amount or a direction of the motion at the center of the head which is a movement center. Here, the center of the head indicates the center of the head in the horizontal plane perpendicular to the height of the user, but may indicate the center in the horizontal plane at the height position of both eyes, and may be a three-dimensional center of the head of the user.

In the head mounted display apparatus 100, one of the first sensor 66 and the second sensor 68 is located on the left side of the center of the head, and the other motion sensor is located on the right side of the center of the head, in a mounting state. For this reason, it is possible to rapidly obtain a motion at the movement center of the head on the basis of detection results from the motion sensors.

One of the first sensor 66 and the second sensor 68 is located on one side of a movable portion serving as a movement center, and the other of the first sensor 66 and the second sensor 68 is located on the other side of the movable portion, in a mounting state. Consequently, in a case where the body of the user is moved, it is possible to rapidly obtain a motion amount or a direction of the motion at the movement center by using detection results from the first sensor 66 and the second sensor 68 which are disposed on one side and the other side with respect to the movement center.

The movable portion indicates a portion of the user's body which is moved, and corresponds to, for example, a joint of the neck or the like. In the present embodiment, an example has been described in which the movable portion is a portion which can serve as a movement center in a horizontal plane perpendicular to the height of the user. For example, a movement center in the horizontal plane at the height position of both eyes may be set as a movable portion, and a three-dimensional center in the user's body may be set as a movable portion. In a case where a motion of the user is a motion including a rotational movement component and a parallel (translational) movement component, the center of the rotational movement may be set as the movement center. For example, in a case where the movable portion is a joint of the neck of the user (more specifically, an intervertebral joint between the first cervical vertebra (atlas vertebra) and the second cervical vertebra (axis vertebra)), a motion amount, a direction of a motion, and the like can be obtained so as to correspond to the motion of the head of the user centering on the neck. Consequently, in a case where the head of the user is moved, it is possible to rapidly obtain a motion amount or a direction of the motion at the neck which is a movement center.

The movable portion may be a location which is set assuming a neck joint of the user, and, in this case, a motion amount, a direction of a motion, and the like can be obtained so as to correspond to the motion of the head of the user centering on the neck.

The first sensor 66 and the second sensor 68 are disposed so that a distance between one of the first sensor 66 and the second sensor 68 is different from a distance between the other of the first sensor 66 and the second sensor 68 and the movable portion in a mounting state of the head mounted display apparatus 100.

Consequently, a difference between the relative positions of the movable portion and the first sensor 66 and the second sensor 68 is likely to be reflected in a difference between detection values of the first sensor 66 and the second sensor 68. Consequently, it is possible to obtain a position of a movement center, or a motion amount at the movement center with higher accuracy on the basis of the detection values of the first sensor 66 and the second sensor 68.

The image display section 20 includes the right light guide plate 261 and the left light guide plate 262 having the half mirrors 261A and 262A which emit image light toward the eyes of the user. The first sensor 66 and the second sensor 68, and central positions of the half mirrors 261A and 262A are linearly arranged. For this reason, it is possible to rapidly obtain a motion amount and a direction of a motion at a movement center so as to correspond to the motion having positions of the right light guide plate 261 and the left light guide plate 262 constituting a display region as the movement center on the basis of detection values of the first sensor 66 and the second sensor 68.

The right light guide plate 261 and the left light guide plate 262 respectively include the half mirrors 261A and 262A as display regions for emitting image light toward the eyes of the user. In a configuration of including an optical element which applies image light by using the half mirrors, a plurality of motion sensors are linearly arranged with the central positions of the half mirrors. For this reason, it is possible to rapidly obtain a motion amount and a direction of a motion at a movement center so as to correspond to the motion having the center of an image visually recognized by the user as the movement center.

The image display section 20 includes the spectacle type frame 2, and the first sensor 66 and the second sensor 68 are disposed at the positions which are symmetrical to each other with respect to the center of the frame 2. It is possible to rapidly obtain a motion amount and a direction of a motion at a movement center so as to correspond to the motion having the center of the spectacle type frame 2 as the movement center.

The frame 2 includes the right portion 2A located in front of the right eye of the user, the left portion 2B located in front of the left eye of the user, and the bridge portion 2C which connects the right portion 2A to the left portion 2B. The first sensor 66 and the second sensor 68 are disposed at the positions which are symmetrical to each other with respect to the bridge portion 2C. Thus, it is possible to rapidly obtain a motion amount and a direction of a motion at a movement center so as to correspond to the motion having the center of the frame 2 as the movement center.

The head mounted display apparatus 100 includes the upper camera 61 which images an imaging region which includes at least a part of a visual field of the user. The motion detection unit 185 specifies a position of a movement center of the user on the basis of detection values of the first sensor 66 and the second sensor 68, and obtains a relative position between the imaging region of the upper camera 61 and the visual field of the user on the basis of the specified position of the movement center. Consequently, it is possible to obtain a correspondence between the imaging region of the upper camera 61 and the visual field of the user and thus to perform control based on a captured image.

The motion detection unit 185 determines whether or not a motion at the movement center is a motion based on a cognitive action of the user, and corrects a captured image from the upper camera 61 in a case where it is determined that the motion is not a motion based on the cognitive action of the user. Consequently, it is possible to discriminate a motion which is intended by the user from a motion which is not intended, and thus to correct blurring or the like in a captured image based on the motion which is not intended by the user.

The motion detection unit 185 specifies a position of a movement center of the user on the basis of detection values of the first sensor 66 and the second sensor 68, and estimates positions of the eyes of the user on the basis of the specified position of the movement center. The motion detection unit 185 specifies a position of the image display section 20 based on the positions of the first sensor 66 and the second sensor 68, and obtains a relative position between the image display section 20 and the positions of the eyes of the user on the basis of the specified position of the image display section 20 and the estimated positions of the eyes of the user. Consequently, it is possible to obtain the relative position between the image display section 20 and the positions of the eyes of the user with high accuracy. Thus, for example, in a case where the position of the image display section 20 is not appropriate, it is possible to prompt the user to correct the position of the image display section 20.

A plurality of movement centers of the head may occur in a case where the head is moved in a complex manner, such as a case where the user moves the head along with the user's body. For example, if a rotational motion centering on the position P1 or P11 and a rotational motion centering on the user's waist are performed together, the position P1 or P11 and a position of the waist respectively correspond to movement centers. In this case, the motion detection unit 185 may obtain a motion amount and a direction of a motion at each of the plurality of movement centers, and may obtain a position of each movement center. There may be a case where motions at all movement centers cannot be obtained on the basis of detection values of the first sensor 66 and the second sensor 68. This is because, in a case where there are a plurality of movement centers, the number of variables of a calculation expression for obtaining motions at the movement centers increases. In such a case, the motion detection unit 185 may cause the detection control unit 183 to acquire detection values of each sensor for multiple times at predetermined time intervals, and may obtain motions at the movement centers on the basis of the detection values for multiple times.

In the first embodiment, the configuration has been described in which the first sensor 66 and the second sensor 68 which are two inertial sensors are provided as an example of a motion sensor. The invention is not limited thereto, and an optical sensor may be used as the motion sensor.

For example, a motion at a movement center may be obtained by using a plurality of motion sensors including an inertial sensor and an optical sensor. For example, a motion at a movement center may be obtained by using a plurality of optical sensors.

Such a case will be described as a second embodiment.

### Second Embodiment

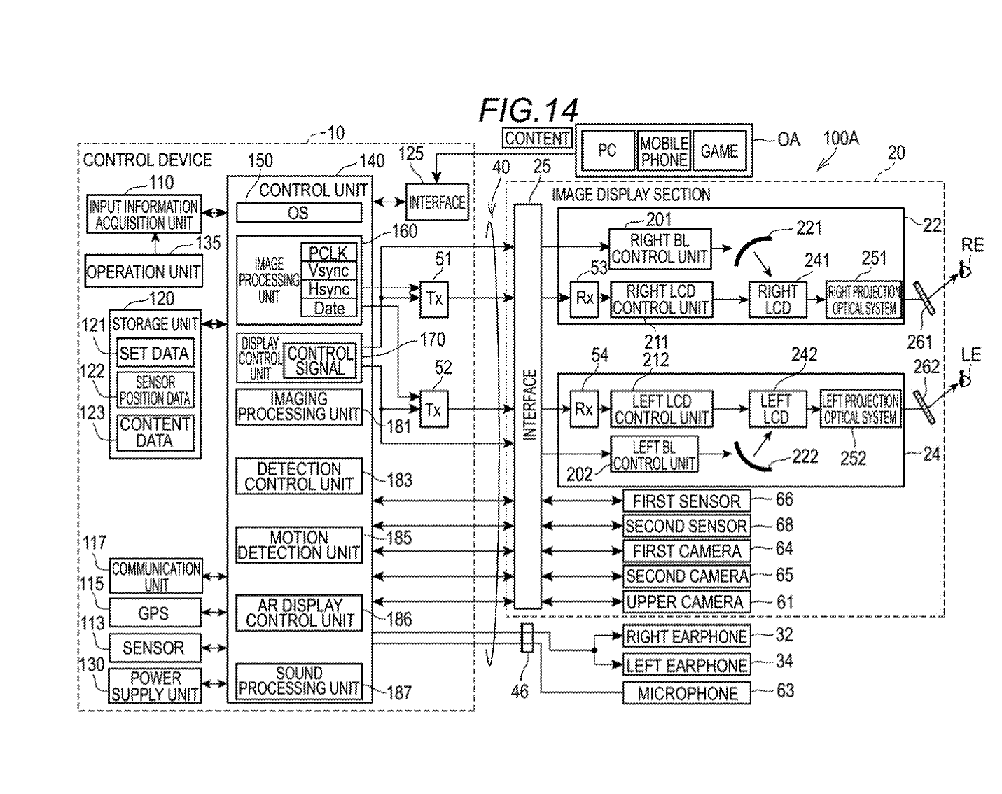

FIG. 14 is a functional block diagram of each unit constituting a head mounted display apparatus 100A according to the second embodiment.

The head mounted display apparatus 100A of the second embodiment includes an image display section 200 instead of the image display section 20. The image display section 200 has a configuration in which a first camera 64 and a second camera 65 are provided in the image display section 20, and the remaining units have common configurations. Therefore, in the head mounted display apparatus 100A, constituent elements common to the head mounted display apparatus 100 of the first embodiment are given the same reference numerals, and illustration and description thereof will be omitted.

Each of the first camera 64 and the second camera 65 is a digital camera including an imaging element such as a CCD or a CMOS, and an imaging lens, and may be a monocular camera and may be a stereo camera. Both of the first camera 64 and the second camera 65 are not limited to cameras which receive visible light rays, and may be cameras which perform imaging with light which is not included in the visible region, such as an ultraviolet camera or an infrared camera. The first camera 64 and the second camera 65 are an example of optical sensors, and function as motion sensors.

The first camera 64 is disposed in front of the first sensor 66 in the right portion 2A. The second camera 65 is disposed in front of the second sensor 68 in the left portion 2B. Preferably, an angle of view of the first camera 64 includes a region which is visually recognized by the right eye of the user through the right optical image display unit 26, and an angle of view of the second camera 65 includes a region which is visually recognized by the left eye of the user through the left optical image display unit 28. The angles of view of the first camera 64 and the second camera 65 may include a range which overlaps an angle of view of the upper camera 61, and may include a range which does not overlap the angle of view thereof.

The imaging processing unit 181 controls the first camera 64 and the second camera 65 to perform imaging so as to acquire captured image data. The sensor position data 122 stored in the storage unit 120 includes data regarding positions of the first camera 64 and the second camera 65. The motion detection unit 185 obtains a direction of a motion and a motion amount at the position of the first camera 64 or the second camera 65 on the basis of captured image data acquired by the imaging processing unit 181.

In the head mounted display apparatus 100A, a motion at a movement center may be obtained by combining the first camera 64, the second camera 65, the first sensor 66, and the second sensor 68, which are four motion sensors.

There are various combinations of the motion sensors, but, at least the motion sensor on the right side of the head of the user and the motion sensor on the left side of the head of the user are preferably combined with each other. In the head mounted display apparatus 100A, there are four combinations including a combination of the first camera 64 and the second camera 65, a combination of the first camera 64 and the second sensor 68, a combination of the first sensor 66 and the second camera 65, and a combination of the first sensor 66 and the second sensor 68. Among the combinations, an example of using the first sensor 66 and the second sensor 68 has been described as the first embodiment.

In the above-described combinations, a selected motion sensor on the right side of the head of the user is referred to as a right sensor, and a motion sensor on the left side of the head of the user is referred to as a left sensor.

Preferably, a position of the right sensor is the position of the first sensor 66 described in the first embodiment, and a position of the left sensor is the position of the second sensor 68 described in the first embodiment. In other words, if a central position of the frame 2 in the left and right directions is set to C1, the right sensor and the left sensor are preferably located at positions which symmetrical to each other with respect to the central position C1. A straight line connecting the position of the right sensor to the position of the left sensor more preferably passes through the half mirrors 261A and 262A. Still more preferably, the position of the right sensor, the position of the left sensor, the center C2 of the half mirror 261A, and the center C3 of the half mirror 262A are arranged on the same straight line.

The positional relationship in the horizontal plane including the centers of the half mirrors 261A and 262A is the same as described above. In a vertical direction (height direction) perpendicular to the horizontal plane, the positions of the first sensor 66 and the second sensor 68 and the centers of the half mirrors 261A and 262A are preferably close to each other in the vertical direction. For example, the right sensor and the left sensor may be located on the lateral sides of the half mirrors 261A and 262A. The first sensor 66 and the second sensor 68 and the centers of the half mirrors 261A and 262A are more preferably located at the same positions in the height direction.

In the present embodiment, a configuration of including all of the first camera 64, the second camera 65, the first sensor 66, and the second sensor 68 are provided will be described as an example. This is only an example, and the invention is also applicable to a configuration in which a single motion sensor corresponding to the right sensor and a single motion sensor corresponding to the left sensor are provided. Therefore, there may be a configuration in which one or two of the first camera 64, the second camera 65, the first sensor 66, and the second sensor 68 are omitted.

The sensor position data 122 includes data indicating a relative positional relationship between or absolute positions of the motion sensors used to detect a motion at a movement center among the motion sensors included in the head mounted display apparatus 100A.

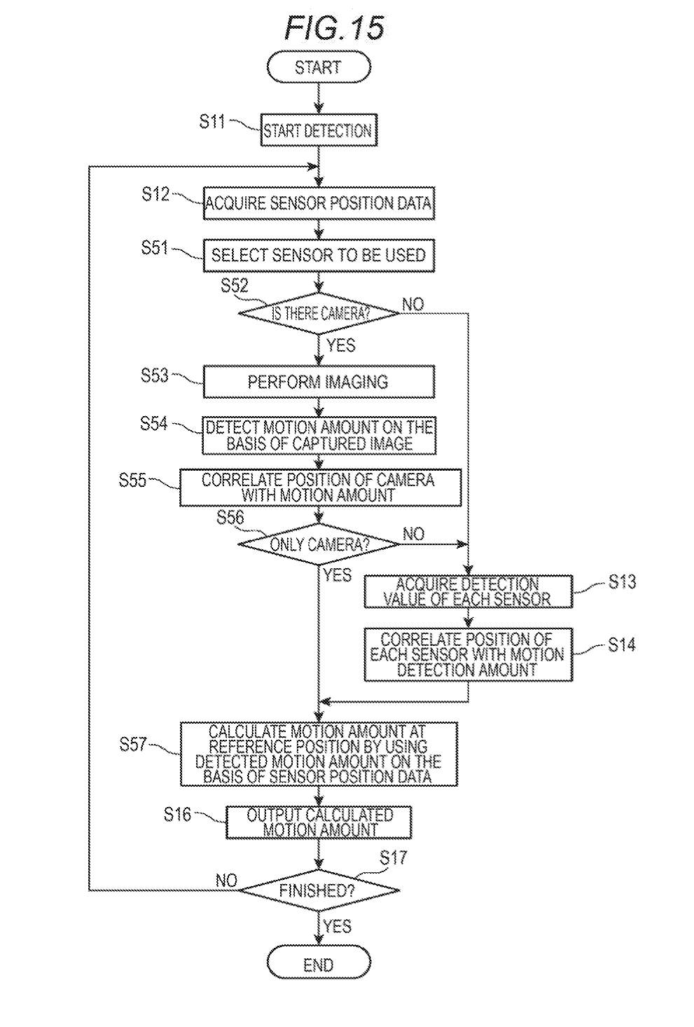

FIG. 15 is a flowchart illustrating an operation of the head mounted display apparatus 100A of the second embodiment, and, particularly, an operation in which the control unit 140 obtains a motion of the head of the user.

In the operation illustrated in FIG. 15, a description will be made of an example in which a motion sensor used for a process of obtaining a motion of the head can be selected and be set among the first camera 64, the second camera 65, the first sensor 66, and the second sensor 68. In the flowchart of FIG. 15, operations common to FIG. 8 described above are given the same step numbers, and description thereof will be omitted.

If the control unit 140 starts detection in the sensors (step S11), the motion detection unit 185 acquires the sensor position data 122 (step S12). The motion detection unit 185 selects a motion sensor used for head tracking among the motion sensors included in the head mounted display apparatus 100A according to set content of the sensor position data 122 or content set by an input operation on the operation unit 135 (step S51).

The motion detection unit 185 determines whether or not the selected sensor includes a camera (step S52). In a case where one or more of the first camera 64 and the second camera 65 are selected (YES in step S52), the imaging processing unit 181 causes the selected camera to perform imaging (step S53) so as to acquire captured image data. The motion detection unit 185 analyzes the captured image data so as to detect a direction of a motion and a motion amount at a position of the selected camera (step S54). The motion detection unit 185 performs a process of correlating the detected direction of the motion and motion amount with the position of the camera (step S55).

Here, the motion detection unit 185 may obtain a difference between a plurality of captured images which are captured at predetermined time intervals, for example, by the first camera 64, and may obtain a direction of a motion and a motion amount by using the difference. The imaging processing unit 181 may set an exposure period of time of the first camera 64 to a long period of time for detecting a motion. In this case, blurring occurs in a captured image obtained by the first camera 64 as a result of reflecting a motion of the first camera 64. The motion detection unit 185 may detect a direction of a motion and a motion amount at the position of the first camera 64 on the basis of a direction of the blurring in the captured image, a blurring amount, and the exposure time. This is also the same for a captured image obtained by the second camera 65.

The motion detection unit 185 determines whether or not only the camera is selected as the motion sensor in step S54 (step S56). In a case where neither of the motion sensors other than the camera, that is, neither of the first sensor 66 and the second sensor 68 are selected (YES in step S56), the motion detection unit 185 proceeds to step S57.

On the other hand, in a case where at least one of the first sensor 66 and the second sensor 68 is selected in step S54 (NO in step S56), the motion detection unit 185 proceeds to step S13. In a case where neither of the first camera 64 and the second camera 65 are selected in step S51 (NO in step S52), the motion detection unit 185 proceeds to step S13.

In step S13, the detection control unit 183 acquires detection values of the first sensor 66 and/or the second sensor 68 (step S13). The motion detection unit 185 correlates the detection value of the sensor acquired by the detection control unit 183 with data regarding the position of the sensor included in the sensor position data 122 (step S14). Thereafter, the control unit 140 proceeds to step S57.

In step S57, the motion detection unit 185 calculates a direction of a motion and a motion amount at the movement center on the basis of the sensor position data 122 (step S57). In step S57, the motion amount and the position correlated with each other in step S55 and/or the motion amount and the position correlated with each other in step S14 are (is) used for a calculation process. Then, the motion detection unit 185 outputs data regarding the calculated direction of the motion and motion amount to the AR display control unit 186 (step S16), and proceeds to step S17. In step S17, the control unit 140 determines whether or not a motion detection finish condition is satisfied (step S17), and finishes the present process if the finish condition is satisfied (YES in step S17). If the finish condition is not satisfied (NO in step S17), the flow returns to step S12.

As mentioned above, the head mounted display apparatus 100A is not limited to the first sensor 66 and the second sensor 68 which are inertial sensors, and obtains a motion at a movement center by using the first camera 64 and/or the second camera 65 as an optical sensor. In other words, it is possible to execute head tracking for a motion of the head of the user by using combinations of motion sensors including the optical sensors and the inertial sensors. In this case, a detection result from the sensor may be used for other applications, such as captured image data being used for detection of a target object of AR display.

In a case where only one kind of optical sensor or inertial sensor is used as a plurality of motion sensors, it is possible to rapidly perform a head tracking process with less load by using detection results from the same kind of sensor.

Also in the second embodiment, a movement center at which the motion detection unit 185 obtains a motion may be, for example, the center (position P1) of the head H or the neck joint (position P11). Results which are detected by the motion detection unit 185 using the first sensor 66 and the second sensor 68 which are inertial sensors and the first camera 64 and the second camera 65 which are optical sensors may be used for the processes illustrated in FIGS. 9 to 13.

Specifically, the motion detection unit 185 may perform the process illustrated in FIG. 11 so as to determine a mounting state of the image display section 20 on the basis of the results detected by using the first sensor 66 and the second sensor 68 which are inertial sensors and the first camera 64 and the second camera 65 which are optical sensors. The AR display control unit 186 may output a guide for prompting correction of a display position of an image which is displayed on the image display section 20, and for prompting correction of a positional deviation.

The motion detection unit 185 may perform the process illustrated in FIG. 10 so as to obtain a correspondence between an imaging region of the upper camera 61 and a visual field of the user. In a case where captured image data acquired by one of the first camera 64 and the second camera 65 is stored in the storage unit 120 or a captured image is used to be displayed on the image display section 20, a process of obtaining a correspondence to which the process illustrated in FIG. 10 can be applied, that is, a correspondence between an imaging region of the first camera 64 and a visual field of the user or a correspondence between an imaging region of the second camera 65 and the visual field of the user, may be performed.

The control unit 140 may perform the process illustrated in FIG. 13 so as to determine whether or not a motion of the head of the user is a cognitive action on the basis of results detected by using the first sensor 66 and the second sensor 68 which are inertial sensors and the first camera 64 and the second camera 65 which are optical sensors. In this case, a captured image obtained by the upper camera 61 may be corrected so as to correspond to a motion which is not a cognitive action. The control unit 140 may perform a process of correcting a captured image obtained by the first camera 64 or a captured image obtained by the second camera 65 so as to correspond to a motion which is not a cognitive action.

In the first and second embodiments, a motion is detected on the basis of detection results from the two motion sensors, and a motion of the head of the user is obtained, but detection results from three or more motion sensors may be used.

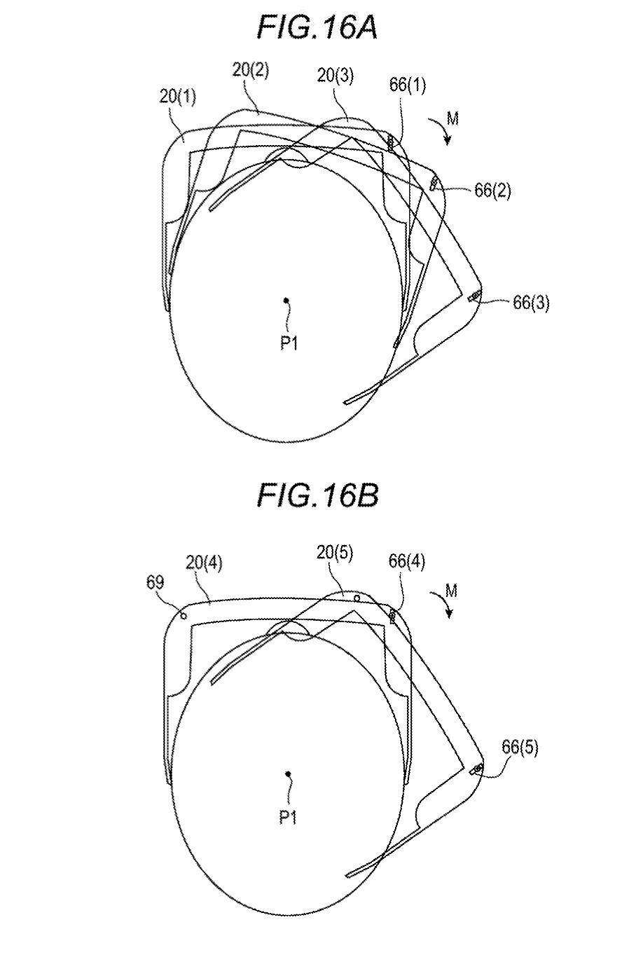

In the head mounted display apparatuses 100 and 100A, a plurality of detection results from a single motion sensor may be processed as detection values of other motion sensors. Such an example is illustrated as a modification example in FIGS. 16A and 16B.

FIGS. 16A and 16B are diagrams illustrating modification examples of the embodiments of the invention, in which FIG. 16A is a diagram illustrating a process related to a first modification example, and FIG. 16B is a diagram illustrating a process related to a second modification example.

In the example illustrated in FIG. 16A, the first sensor 66 of the image display section 20 is used. The head of the user wearing the image display section 20 is rotationally moved centering on the position P1 as indicated by an arrow M. During the rotational movement, the detection control unit 183 acquires detection values of the first sensor 66 for three times at predetermined time intervals. The movement indicated by the arrow M is continuously performed at least from the first detection to the third detection.

It is assumed that a position of the first sensor 66 in the first detection is a position (1), a position of the first sensor 66 in the second detection is a position (2), and a position of the first sensor 66 in the third detection is a position (3). The position (1) can be said to be an initial position. The positions (1), (2) and (3) are mutually different positions with respect to a reference which is not moved, such as a ground surface, a floor surface, or a wall surface in a mounting environment of the head mounted display apparatus 100.

In this case, the motion detection unit 185 correlates the first detection value with the position (1), correlates the second detection value with the position (2), and correlates the third detection value with the position (3), so as to obtain the three detection values of the sensor which is disposed at the different positions. The position (2) may be calculated on the basis of, for example, a time interval between the first and second detections, the first detection value, and the position (1). Similarly, the position (3) may also be calculated on the basis of a time interval between the second and third detections, the second detection value, and the position (2).

By using the three detection values of the sensor, a direction of the motion and a motion amount at the movement center P1 can be obtained. A calculation result obtained in this example indicates a direction of a motion and a motion amount in a case where the motions detected from the first time to the third time are regarded as a single motion.

In the example illustrated in FIG. 16B, the first sensor 66 is used in the head mounted display apparatus 100. In the first embodiment, a virtual sensor 69 is provided at a position where the second sensor 68 is provided. Data indicating a relative position between a position of the first sensor 66 and a position of the virtual sensor 69 is included in the set data 121.

The head of the user wearing the image display section 20 is rotationally moved centering on the position P1 as indicated by an arrow M. During the rotational movement, the detection control unit 183 acquires detection values of the first sensor 66 for two times at predetermined time intervals. The movement indicated by the arrow M is continuously performed at least from the first detection to the second detection. It is assumed that a position of the first sensor 66 in the first detection is a position (4), and a position of the first sensor 66 in the second detection is a position (5). The positions (4) and (5) are mutually different positions with respect to a reference which is not moved, such as a ground surface, a floor surface, or a wall surface in a mounting environment of the head mounted display apparatus 100. The position (4) can be said to be an initial position.

In this case, the motion detection unit 185 correlates the first detection value with the position (4) and correlates the second detection value with the position (5) so as to obtain the two detection values of the sensor which is disposed at the different positions. The position (5) may be calculated on the basis of, for example, a time interval between the first and second detections, the first detection value, and the position (4).

The motion detection unit 185 calculates a detection value of the virtual sensor 69 on the basis of a position of the virtual sensor 69 (an initial position of the virtual sensor 69) in the first detection. The virtual sensor 69 is a three-axis angular velocity sensor which is configured in the same manner as the first sensor 66, and the detection value of the virtual sensor 69 may be calculated on the basis of the position of the virtual sensor 69, and the first detection value of the first sensor 66.

Consequently, the motion detection unit 185 obtains three combinations of the positions and detection values of the sensors on the basis of the initial position and the detection value of the virtual sensor 69, the position (4) and the first detection value of the first sensor 66, and the position (5) and the second detection value of the first sensor 66. By using the three detection values of the sensors, a direction of the motion and a motion amount at the movement center P1 can be obtained. A calculation result obtained in this example indicates a direction of a motion and a motion amount in a case where the motions detected from the first time and the second time are regarded as a single motion.

As mentioned above, the head mounted display apparatuses 100 and 100A can obtain a direction of a motion or a motion amount at a movement center of the head by using not only a plurality of motion sensors but also a single motion sensor. Therefore, in the same manner as in the first and second embodiments, the invention is not limited to a configuration in which two or more motion sensors are used, and is applicable to a configuration in which a single motion sensor is used. In other words, some of a plurality of motion sensors of the embodiments of the invention may be virtual sensors, and may be a sensor which is implemented by shifting a time axis by using other sensors.

The results of detecting the direction of the motion and the motion amount at the movement center by using the configurations described in these modification examples may be used for the processes illustrated in FIGS. 9A to 13 as described above in the second embodiment. In the modification examples, a movement center at which the motion detection unit 185 obtains a motion may be, for example, the center (position P1) of the head H or the neck joint (position P11).

The first embodiment, the second embodiment, and the modification examples are only examples of specific embodiments of the invention. The invention is not limited to the above-described configurations and can be implemented in various aspects within the scope without departing from the spirit thereof.

In the above-described embodiments, the image display sections 20 and 200 including the frame 2 having a spectacle shape have been described, but the frame 2 may be built into a body protection tool such as a cap or a helmet. In other words, an exterior thereof is not limited as long as an optical system including the right display driving unit 22 and the left display driving unit 24, and a portion supporting motion sensors such as the first camera 64, the second camera 65, the first sensor 66, and the second sensor 68 are of a spectacle type. The camera unit 3 may be configured to be integrally provided in the frame 2. The camera unit 3 may be configured to be connected to the frame 2 via members other than the hinges 21A and 23A so as to be moved with a higher degree of freedom.

In the above-described embodiments, in the head mounted display apparatuses 100 and 100A, a description has been made of a configuration in which the image display sections 20 and 200 and the control device 10 are provided separately from each other, and are coupled to each other via the coupling unit 40. The invention is not limited thereto, and the control device 10 may be configured integrally with the image display sections 20 and 200. In the head mounted display apparatuses 100 and 100A, the image display sections 20 and 200 performing display are preferably mounted on the head of a user (a worker or a commander). A mounting state of the control device 10 is not limited. For this reason, as the control device 10, a notebook computer, a tablet computer, or a desktop computer may be used. As the control device 10, a portable electronic device such as a game machine, a mobile phone, a smart phone, or a portable media player, or other dedicated devices may be used. There may be a configuration in which the control device 10 is provided separately from the image display sections 20 and 200, and various signals are transmitted and received between the control device 10 and the image display sections 20 and 200 via wireless communication.

For example, in order to generate image light, the image display section 20 may be configured to include an organic electroluminescence (EL) display and an organic EL controller. As a configuration of generating image light, liquid crystal on silicon (LCOS; LCoS is a registered trademark), a digital micromirror device, or the like may be used.

Optical elements guiding image light to the eyes of the user are not limited to the right light guide plate 261 and the left light guide plate 262. In other words, the optical elements may be optical elements through which external light incident to the apparatus from the outside is transmitted and which allows the external light to be incident to the eyes of the user along with image light. For example, an optical element which is located in front of the eyes of the user and partially or entirely overlaps a visual field of the user may be used. A scanning type optical element which performs scanning with laser light and uses the laser light as image light may be employed. An optical element is not limited to a configuration in which image light is guided inside an optical element, and may have only a function of guiding image light to the eyes of the user by refracting and/or reflecting the image light. An optical element of the invention may use a diffraction grating, a prism, or a holography display portion.

For example, the invention is applicable to a laser retinal projective head mounted display apparatus. In other words, there may be a configuration in which a light emitting unit includes a laser light source and an optical system guiding laser light to the eyes of the user, and the retinae are scanned with laser light incident to the eyes of the user so that an image is formed on the retinae, and thus the user visually recognizes the image.

The invention is also applicable to a display apparatus which employs a scanning optical system using a MEMS mirror and uses a MEMS display technique. In other words, the light emitting unit may be provided with a signal light forming unit, a scanning optical system including a MEMS mirror which performs scanning with light emitted by the signal light forming unit, and an optical member which forms a virtual image by using the light with which scanning is performed by the scanning optical system. In this configuration, the light which is emitted by the signal light forming unit is reflected by the MEMS mirror and is incident to the optical member, and the light is guided inside the optical member and reaches a virtual image formation surface. If the MEMS mirror performs scanning with the light, a virtual image is formed on the virtual image forming surface, and an image is recognized by identifying the virtual image with the user's eye. An optical component in this case may guide light through a plurality of number of times of reflection, such as the right light guide plate 261 and the left light guide plate 262 of the embodiments, and may employ a half mirror surface.

At least some of the respective functional blocks illustrated in FIGS. 7 and 14 may be realized by hardware, may be realized in cooperation between hardware and software, and is not limited to the configuration in which the independent hardware resources are disposed as illustrated in FIGS. 7 and 14. The program executed by the control unit 140 may be stored in the storage unit 120 or a storage unit of the control device 10. The program stored in an external device may be acquired via the communication unit 117 or the interface 125 and may be executed. A constituent element provided in the control device 10 may also be provided in the image display section 20. For example, the control unit 140 illustrated in FIGS. 7 and 14 may be provided in the image display section 20 or 200, and, in this case, the control unit 140 and the control unit of the image display section 20 or 200 may share a function.

### Third Embodiment

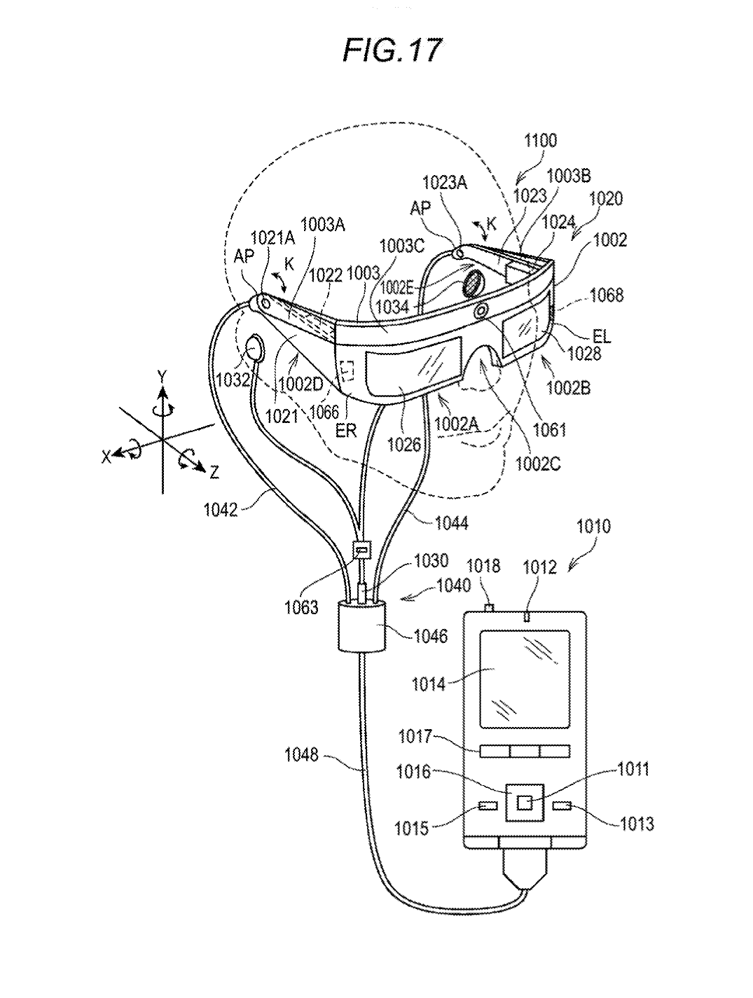

FIG. 17 is a diagram illustrating an exterior configuration of a head mounted display apparatus 1100 (display apparatus) related to an embodiment to which the invention is applied.

The head mounted display apparatus 1100 includes an image display section 1020 (display unit) which enables a user to visually recognize a virtual image in a state of being mounted on the head of the user, and a control device 1010 which controls the image display section 1020. The control device 1010 also functions as a controller used for the user to operate the head mounted display apparatus 1100.

The image display section 1020 is a mounting body which is mounted on the head of the user, and includes a spectacle type frame 1002 (main body) in the present embodiment. The frame 1002 is provided with a right holding unit 1021, and a left holding unit 1023. The right holding unit 1021 is a member which is provided so as to extend over a position corresponding to the temporal region of the user from the other end part ER which is the other end of a right optical image display unit 1026 when the user wears the image display section 1020. Similarly, the left holding unit 1023 is a member which is provided so as to extend over a position corresponding to the temporal region of the user from the other end part EL of a left optical image display unit 1028 when the user wears the image display section 1020. The right holding unit 1021 comes into contact with the right ear or the vicinity thereof on the head of the user, and the left holding unit 1023 comes into contact with the left ear or the vicinity thereof of the user, so as to hold the image display section 1020 on the head of the user. The frame 1002 constitutes a main body (display unit main body) of the image display section 1020. A main body of the head mounted display apparatus 1100 may be the frame 1002, and may be the control device 1010.

The frame 1002 is provided with a right display driving unit 1022, a left display driving unit 1024, the right optical image display unit 1026, the left optical image display unit 1028, and a microphone 1063.

In the present embodiment, as an example of a main body, the spectacle type frame 1002 will be described. A shape of the main body is not limited to a spectacle shape, and may be any shape as long as the main body is mounted on and fixed to the head of the user, and is more preferably a shape which causes the main body to be hung in front of both the eyes of the user. For example, in addition to the spectacle shape described here, a shape of the main body may be a snow goggle shape covering the upper part of the face of the user, and may be a shape which is disposed in front of each of the right and left eyes of the user, such as binoculars.

The spectacle type frame 1002 includes a right portion 1002A located in front of the right eye of the user, and a left portion 1002B located in front of the left eye of the user, and has a shape in which the right portion 1002A and the left portion 1002B are connected to each other via a bridge portion 1002C (connecting portion). The bridge portion 1002C connects the right portion 1002A to the left portion 1002B at the position corresponding to the glabella of the user when the user wears the image display section 1020.

The right portion 1002A and the left portion 1002B are respectively connected to temple portions 1002D and 1002E. The temple portions 1002D and 1002E hold the frame 1002 on the head of the user in the same manner as temples of spectacles. The temple portion 1002D of the present embodiment is formed of the right holding unit 1021, and the temple portion 1002E is formed of the left holding unit 1023.

The right optical image display unit 1026 which is disposed at the right portion 1002A and the left optical image display unit 1028 which is disposed at the left portion 1002B, are respectively located in front of the right and left eyes of the user when the user wears the image display section 1020.

The right display driving unit 1022 and the left display driving unit 1024 are disposed on sides facing the head of the user when the user wears the image display section 1020. The right display driving unit 1022 and the left display driving unit 1024 are collectively simply referred to as “display driving units”, and the right optical image display unit 1026 and the left optical image display unit 1028 are collectively simply referred to as “optical image display units”.

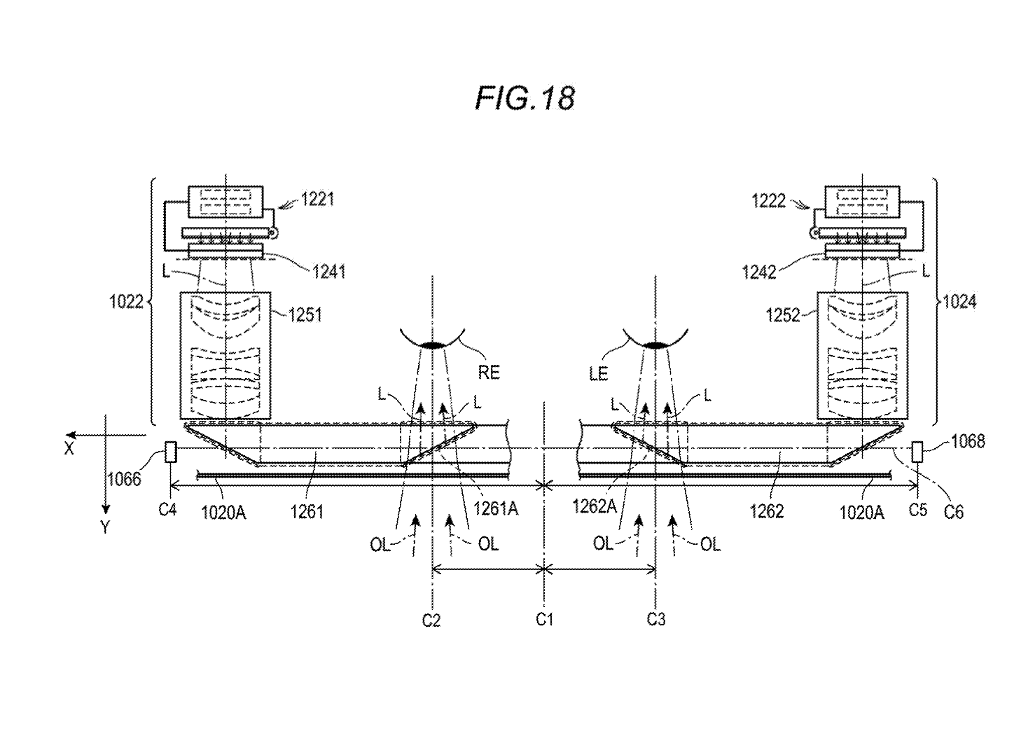

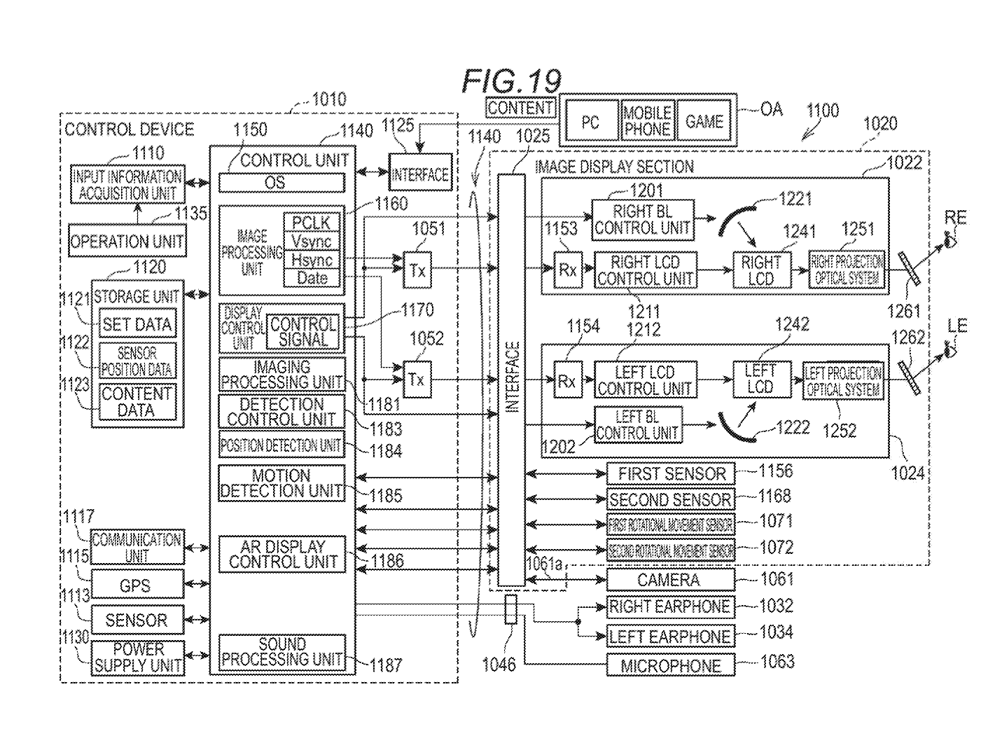

The display driving units 1022 and 1024 respectively include liquid crystal displays 1241 and 1242 (hereinafter, referred to as “LCDs 1241 and 1242”), projection optical systems 1251 and 1252 which will be described later with reference to FIGS. 18 and 19, and the like.

The right optical image display unit 1026 and left optical image display unit 1028 respectively include light guide plates 1261 and 1262 (FIG. 18) and dimming plates 1020A. The light guide plates 1261 and 1262 are made of a light-transmitting resin material or the like, and guide image light output from the display driving units 1022 and 1024 to the eyes of the user. Each of the dimming plates 1020A is a thin plate-shaped optical element, and is disposed so as to cover a surface side of the image display section 1020 which is an opposite side to the eye side of the user. As the dimming plate 1020A, various dimming plates including one which has almost no light transmittance, one which is substantially transparent, one through which light is transmitted by attenuating of an amount of light, one which attenuates or reflects light with a specific wavelength, and the like. Optical characteristics (light transmittance and the like) of the dimming plates 1020A are selected as appropriate in order to adjust an amount of external light entering the right optical image display unit 1026 and the left optical image display unit 1028, and thus the extent of visually recognizing a virtual image can be controlled. In the present embodiment, a description will be made of a case of using the dimming plates 1020A which has light transmittance to the extent to which the user wearing the image display section 1020 can visually recognize at least external scenery. The dimming plates 1020A protect the right light guide plate 1261 and the left light guide plate 1262 so as to prevent the right light guide plate 1261 and the left light guide plate 1262 from being damaged, contaminated, or the like.

The dimming plates 1020A may be attachable to and detachable from the right optical image display unit 1026 and the left optical image display unit 1028, may be attached by exchanging a plurality of dimming plates 1020A, and may be omitted.

The frame 1002 is provided with a camera unit 1003. The camera unit 1003 includes a camera pedestal portion 1003C in which a camera 1061 is disposed, and arm portions 1003A and 1003B supporting the camera pedestal portion 1003C. The arm portion 1003A is connected to the right holding unit 1021 so as to be rotationally moved via a hinge 1021A (connecting portion) provided at a tip portion AP of the right holding unit 1021. The arm portion 1003B is connected to the left holding unit 1023 so as to be rotationally moved via a hinge 1023A (connecting portion) provided at a tip portion AP of the left holding unit 1023. For this reason, the camera unit 1003 can be rotationally moved as a whole in a direction indicated by an arrow K, that is, vertically in a mounting state. The camera unit 1003 comes into contact with the frame 1002 at a lower end of a rotatable movement range. An upper end of the rotatable movement range of the camera unit 1003 is determined on the basis of a specification or the like of the hinges 1021A and 1023A.

A first rotational movement sensor 1071 (FIG. 19) which will be described later is provided at the hinge 1021A, and a second rotational movement sensor 1072 (FIG. 19) which will be described later is provided at the hinge 1023A. The first rotational movement sensor 1071 and the second rotational movement sensor 1072 function as a detection unit, and detect rotational movement positions or actions of rotational movements of the hinges 1021A and 1023A. The first rotational movement sensor 1071 and the second rotational movement sensor 1072 may be constituted of, for example, rotary encoders. Specifically, there may be a configuration in which the first rotational movement sensor 1071 and the second rotational movement sensor 1072 include optical sensors each of which is provided with a light emitting portion and a light receiving portion, and light blocking plates which are operated according to rotational movements centering on the hinges 1021A and 1023A, and detect light transmitted through slits of the light blocking plates. In this case, the first rotational movement sensor 1071 can detect an operation in which an angle between the temple portion 1002D and the arm portion 1003A at the hinge 1021A is increased, and an angle therebetween is reduced, and can count an operation amount. The second rotational movement sensor 1072 performs the same detection for the hinge 1023A. The first rotational movement sensor 1071 and the second rotational movement sensor 1072 may respectively detect an angle between the temple portion 1002D and the arm portion 1003A at the hinge 1021A and an angle between the temple portion 1002E and the arm portion 1003B at the hinge 1023A, by using a variable resistor or a magnetic sensor.

In the present embodiment, the first rotational movement sensor 1071 and the second rotational movement sensor 1072 are constituted of rotary encoders which perform optical detection. If the arm portion 1003A is rotationally moved with respect to the temple portion 1002D at the hinge 1021A, the first rotational movement sensor 1071 outputs a pulse whenever a rotational movement is performed with a predetermined angle. If the arm portion 1003B is rotationally moved with respect to the temple portion 1002E at the hinge 1023A, the second rotational movement sensor 1072 outputs a pulse whenever a rotational movement is performed with a predetermined angle. The first rotational movement sensor 1071 and the second rotational movement sensor 1072 may output a signal indicating a rotational movement direction.

The first rotational movement sensor 1071 and the second rotational movement sensor 1072 may have a function of counting pulses from the rotary encoders, and may output angles of the hinges 1021A and 1023A on the basis of a pulse count value and a rotation direction.

The camera pedestal portion 1003C is a plate-like or rod-like member located on upper parts of the right portion 1002A, the left portion 1002B, and the bridge portion 1002C, and a camera 1061 is provided in an embedded manner at a position corresponding to the upper part of the bridge portion 1002C. The camera 1061 (imaging unit) is a digital camera including an imaging element such as a CCD or a CMOS, and an imaging lens, and may be a monocular camera and may be a stereo camera.

The camera 1061 images at least a part of external scenery in the surface side of the head mounted display apparatus 1100, that is, in a visual field direction of the user in a state in which the user wears the image display section 1020. An imaging region of the camera 1061 may be set as appropriate, but an imaging region of the camera 1061 preferably includes the external world which is visually recognized by the user through the right optical image display unit 1026 and the left optical image display unit 1028 at the lower end of the rotatable movement range of the camera unit 1003, for example. More preferably, an imaging region of the camera 1061 is set to image the entire visual field of the user through the dimming plates 1020A.

The camera 1061 performs imaging under the control of an imaging processing unit 1181 (FIG. 19) included in the control unit 1140, and outputs captured image data to the imaging processing unit 1181.

The image display section 1020 is connected to the control device 1010 via a coupling unit 1040. The coupling unit 1040 includes a main cord 1048 that is coupled to the control device 1010, right cord 1042, a left cord 1044, and a connecting member 1046. The right cord 1042 and the left cord 1044 are two cords into which the main cord 1048 branches. The right cord 1042 is inserted into a chassis of the right holding unit 1021 from the tip portion AP in the extending direction of the right holding unit 1021 and is coupled to the right display driving unit 1022. Similarly, the left cord 1044 is inserted into a chassis of the left holding unit 1023 from the tip portion AP in the extending direction of the left holding unit 1023 and is coupled to the left display driving unit 1024.

The connecting member 1046 is provided at a branching point of the main cord 1048, the right cord 1042, and the left cord 1044, and includes a jack for coupling to an earphone plug 1030. A right earphone 1032 and a left earphone 1034 extend from the earphone plug 1030. The microphone 1063 is provided near the earphone plug 1030. The earphone plug 1030 and the microphone 1063 are put together in a single cord, and cords into which the cord from the microphone 1063 branches are respectively connected to the right earphone 1032 and the left earphone 1034.

For example, as illustrated in FIG. 17, a sound collecting unit of the microphone 1063 is disposed so as to be directed in the visual line direction of the user, and the microphone 1063 collects sound and outputs an audio signal to a sound processing unit 1187 (FIG. 19). For example, the microphone 1063 may be a monaural microphone, a stereo microphone, a directive microphone, or a non-directive microphone.

The right cord 1042, the left cord 1044, and the main cord 1048 may be ones which can transmit digital data, and may be formed of, for example, a metal cable or an optical fiber. The right cord 1042 and the left cord 1044 may be collected as a single cord.

The image display section 1020 and the control device 1010 transmit various signals via the coupling unit 1040. An end portion of the main cord 1048 opposite to the connecting member 1046 and the control device 1010 are provided with connectors (not illustrated) engaging with each other, respectively. The control device 1010 and the image display section 1020 are connected to or disconnected from each other by engagement or disengagement between the connector of the main cord 1048 and the connector of the control device 1010.

The control device 1010 controls the head mounted display apparatus 1100. The control device 1010 is provided with switches including a determination key 1011, a lighting unit 1012, a display change key 1013, a luminance change key 1015, a direction key 1016, a menu key 1017, and a power switch 1018. The control device 1010 also includes a track pad 1014 on which the user performs a touch operation with the user's finger.

The determination key 1011 detects a pressing operation and outputs a signal for determining content which is operated in the control device 1010. The lighting unit 1012 includes a light source such as a light emitting diode (LED), and performs a notification of an operation state (for example, ON and OFF states of the supply of power) of the head mounted display apparatus 1100 by using its lighting state. The display change key 1013 outputs, for example, a signal for switching image display modes according to a pressing operation.

The track pad 1014 has an operation surface for detecting a touch operation, and outputs a signal according to an operation on the operation surface. A detection method on the operation surface is not limited, and may employ an electrostatic type, a pressure detection type, an optical type, and the like. The luminance change key 1015 outputs a signal for changing luminance of the image display section 1020 according to a pressing operation. The direction key 1016 outputs an operation signal according to a pressing operation on a key corresponding to upper, lower, left, and right directions. The power switch 1018 is a switch for switching turning-on and turning-off and the supply of power to the head mounted display apparatus 1100.

FIG. 18 is a main portion plan view illustrating a configuration of an optical system included in the image display section 1020. For description, FIG. 18 illustrates the left eye LE and the right eye RE of the user.

The left display driving unit 1024 includes a left backlight 1222, a left LCD 1242, and a left projection optical system 1252. The left backlight 1222 includes a light source such as an LED, and a diffusion plate. The left LCD 1242 is disposed on an optical path of light emitted from the diffusion plate of the left backlight 1222, and is a transmissive liquid crystal panel in which a plurality of pixels are arranged in a matrix. The left projection optical system 1252 includes a lens group and the like which guide image light L having been transmitted through the left LCD 1242.

The left projection optical system 1252 includes a collimator lens which converts the image light L emitted from the left LCD 1242 into parallel light beams. The image light L converted into the parallel light beams by the collimator lens is incident to the left light guide plate 1262 (optical element). The left light guide plate 1262 is a prism in which a plurality of reflective surfaces reflecting the image light L are formed, and the image light L is guided to the left eye LE through reflection performed for multiple times inside the left light guide plate 1262. The left light guide plate 1262 is provided with a half mirror 1262A (reflective surface) located in front of the left eye LE.

The image light L reflected by the half mirror 1262A is emitted from the left optical image display unit 1028 toward the left eye LE, and the image light L forms an image on the retina of the left eye LE so that the user visually recognizes the image.

The right display driving unit 1022 is configured symmetrically to the left display driving unit 1024. The right display driving unit 1022 includes a right backlight 1221, a right LCD 1241, and a right projection optical system 1251. The right backlight 1221 includes a light source such as an LED, and a diffusion plate. The right LCD 1241 is disposed on an optical path of light emitted from the diffusion plate of the right backlight 1221, and is a transmissive liquid crystal panel in which a plurality of pixels are arranged in a matrix. The right projection optical system 1251 includes a lens group and the like which guide image light L having been transmitted through the right LCD 1241.

The right projection optical system 1251 includes a collimator lens which converts the image light L emitted from the right LCD 1241 into parallel light beams. The image light L converted into the parallel light beams by the collimator lens is incident to the right light guide plate 1261 (optical element). The right light guide plate 1261 is a prism in which a plurality of reflective surfaces reflecting the image light L are formed, and the image light L is guided to the right eye RE through reflection performed for multiple times inside the right light guide plate 1261. The right light guide plate 1261 is provided with a half mirror 1261A (reflective surface) located in front of the right eye RE.

The image light L reflected by the half mirror 1261A is emitted from the right optical image display unit 1026 toward the right eye RE, and the image light L forms an image on the retina of the right eye RE so that the user visually recognizes the image.

The image light L reflected by the half mirror 1261A and external light OL having been transmitted through the dimming plate 1020A are incident to the right eye RE of the user. The image light L reflected by the half mirror 1262A and external light OL having been transmitted through the dimming plate 1020A are incident to the left eye LE of the user. As mentioned above, the head mounted display apparatus 1100 causes the image light L of an image which is processed therein and the external light OL to overlap each other and to be incident to the eyes of the user, and the user observes external scenery through the dimming plates 1020A and visually recognizes the image based on the image light L overlapped on the external scenery. As mentioned above, the head mounted display apparatus 1100 functions as a see-through type display apparatus.

The left projection optical system 1252 and the left light guide plate 1262 are collectively referred to as a “left light guide unit”, and the right projection optical system 1251 and the right light guide plate 1261 are collectively referred to as a “right light guide unit”. Configurations of the right light guide unit and the left light guide unit are not limited to the above-described examples, and any method may be used as long as a virtual image is formed in front of the eyes of the user. For example, a diffraction grating may be used, and a transflective film may be used.

Two motion sensors are attached to the frame 1002. The motion sensors are inertial sensors, and are specifically a first sensor 1066 and a second sensor 1068. The first sensor 1066 and the second sensor 1068 as motion sensors are disposed at positions which are deviated relative to the user's body in the head mounted display apparatus 1100. More specifically, the first sensor 1066 is disposed at an end of the right portion 1002A on the temple portion 1002D side, and the second sensor 1068 is disposed at an end of the left portion 1002B on the temple portion 1002E side. The first sensor 1066 and the second sensor 1068 are inertial sensors such as acceleration sensors or angular velocity sensors (gyro sensors), and are three-axis gyro sensors in the present embodiment. The first sensor 1066 and the second sensor 1068 detect a rotation (pitch) around an X axis, a rotation (yaw) around a Y axis, and a rotation (roll) around a Z axis which will be described later, at measurement reference points of detection mechanisms built therein. Positions of the first sensor 1066 and the second sensor 1068 indicate positions of the measurement reference points.

The first sensor 1066 and the second sensor 1068 respectively correspond to the first sensor 66 and the second sensor 68 described in the first and second embodiment, and installation positions thereof are also the same as in the first and second embodiments. In other words, one of the first sensor 1066 and the second sensor 1068 is disposed on one side of the center of the head of the user, and the other sensor is disposed on the other side of the center of the head of the user. Specifically, the first sensor 1066 is disposed on the right side of the head of the user, and the second sensor 1068 is disposed on the left side thereof. Here, the center of the head indicates the center of the head on a horizontal plane perpendicular to the height of the user. Regarding positions of the first sensor 1066 and the second sensor 1068 on the horizontal plane, the first sensor 1066 and the second sensor 1068 are located on the right side and the left side with the center of the head interposed therebetween on the horizontal plane. The center of the head is the same as described in the first and second embodiments.

More preferably, as illustrated in FIG. 18, in the present embodiment, the first sensor 1066 is disposed on the lateral side of the right light guide plate 1261, and the second sensor 1068 is disposed on the lateral side of the left light guide plate 1262. If a central position of the frame 1002 in the left and right directions is set to C1, a center C2 of the half mirror 1261A as a display region and a center C3 of the half mirror 1262A as a display region are located at positions which symmetrical to each other with respect to the central position C1. In other words, the central position C1 is located at a middle point between the center C2 of the half mirror 1261A and the center C3 of the half mirror 1262A.

As described above, the first sensor 1066 and the second sensor 1068 are preferably disposed at the positions which are symmetrical to each other with respect to the central position C1. A straight line connecting the position of the first sensor 1066 to the position of the second sensor 1068 passes through the half mirrors 1261A and 1262A. In other words, the position of the first sensor 1066, the position of the second sensor 1068, the center C2 of the half mirror 1261A, and the center C3 of the half mirror 1262A are arranged on the same straight line.

The positional relationship in the horizontal plane including the centers of the half mirrors 1261A and 1262A has been described, but a positional relationship in a vertical direction (height direction) perpendicular to the horizontal plane is not particularly limited. The positions of the first sensor 1066 and the second sensor 1068 and the centers of the half mirrors 1261A and 1262A are preferably close to each other in the vertical direction. For example, the first sensor 1066 and the second sensor 1068 may be located on the lateral sides of the half mirrors 1261A and 1262A. The first sensor 1066 and the second sensor 1068 and the centers of the half mirrors 1261A and 1262A are more preferably located at the same positions in the height direction.

As illustrated in FIG. 17, as axes for the first sensor 1066 to detect angular velocity, with respect to the head of the user on which the image display section 1020 is mounted, an axis in left and right directions is set to an X axis, an axis in front and rear directions is set to a Y axis, and an axis in upper and lower directions is set to a Z axis. The X axis, the Y axis, and the Z axis form an orthogonal coordinate system which is virtually set to correspond to the head of the user as described in the first and second embodiment. More specifically, the image display section 1020 is located at a horizontal position perceived by the user with respect to the right and left eyes in a mounting state of the head mounted display apparatus 1100. In this mounting state, the detection axes (the X axis, the Y axis, and the Z axis) of the first sensor 1066 and the second sensor 1068 respectively match the left and right sides, the front and rear sides, and the upper and lower sides perceived by the user. If the position where the image display section 1020 is mounted is tilted or deviated relative to the head of the user, the detection axes of the first sensor 1066 and the second sensor 1068 are deviated relative to the left and right sides, the front and rear sides, and the upper and lower sides, but this problem is easily removed by the user adjusting tilt or deviation of the image display section 1020.

The head mounted display apparatus 1100 detects motions of the head of the user by using the first sensor 1066 and the second sensor 1068 in a mounting state of the image display section 1020. The motions detected by the motion sensors are a motion at the measurement reference point (P3 in FIGS. 3A and 3B) of the first sensor 1066 and a motion at the measurement reference point (P4 in FIGS. 3A and 3B) of the second sensor 1068.

In a case of displaying AR content by using a function of an AR display control unit 1186 which will be described later, the head mounted display apparatus 1100 performs detection (head tracking) of a motion of the head of the user, and changes a display aspect so as to correspond to the detected motion of the head of the user.

In this case, in the head tracking, preferably, a reference location of a movement (motion) of the head is assumed, and a motion at the reference location is obtained. As described above, when a human moves the head thereof, the center (corresponding to a position P1 in FIGS. 3A and 3B) of the head or a front portion (corresponding to a position P2 in FIGS. 3A and 3B) of the head serves as the center or a motion or a reference for the most part. Here, the center of a motion, or a location used as a reference is referred to as a movement center.

In a process of the head tracking, a motion at the movement center is obtained. In order to directly detect a motion at the movement center, the sensor is required to be disposed at a location which tends to be the movement center, for example, the position P1 or the position P2, and thus this is not realistic. Therefore, the head mounted display apparatus 1100 calculates a motion at the movement center through a calculation process based on detection results from the first sensor 1066 and the second sensor 1068. A calculation expression, a table, a parameter, and the like used for the calculation process are stored in advance as sensor position data 1122 which will be described later.

In a case where positions of the first sensor 1066 and the second sensor 1068 satisfy a certain type of condition, the calculation process of calculating a motion at the movement center is facilitated and can thus be performed with a reduced load so that a motion at the movement center (for example, the position P1 or P2) can be calculated more accurately.

This condition is that, as described above, one of the first sensor 1066 and the second sensor 1068 is located on one side of the center of the head of the user and the other sensor is located on the other side of the center of the head of the user. In this case, if a movement having the center of the head as the movement center is performed, it is possible to easily calculate a motion at the movement center.

More preferably, the first sensor 1066 is disposed on the lateral side of the right light guide plate 1261, and the second sensor 1068 is disposed on the lateral side of the left light guide plate 1262. The first sensor 1066 and the second sensor 1068 are more preferably disposed at positions which are symmetrical to each other with respect to the central position C1. The position of the first sensor 1066, the position of the second sensor 1068, the center C2 of the half mirror 1261A, and the center C3 of the half mirror 1262A are further preferably arranged on the same straight line. In this case, if a movement having the center of the head or the front center as the movement center is performed, it is possible to easily calculate a motion at the movement center.

In terms of a positional relationship in the vertical direction (height direction), the positions of the first sensor 1066 and the second sensor 1068 and the centers of the half mirrors 1261A and 1262A are preferably close to each other in the vertical direction. More preferably, the first sensor 1066 and the second sensor 1068 and the centers of the half mirrors 1261A and 1262A are located at the same position in the height direction.

Arrangement states of the first sensor 1066 and the second sensor 1068 are not limited to the examples illustrated in FIGS. 17 and 18. For example, the first sensor 1066 and the second sensor 1068 may be disposed at the positions of the first sensor 66 and the second sensor 68 illustrated in FIGS. 5A to 6B in the first embodiment.

FIG. 19 is a functional block diagram of the respective sections constituting the head mounted display apparatus 1100.

The head mounted display apparatus 1100 includes an interface 1125 which couples the control device 1010 to the various external apparatuses OA which are content supply sources. As the interface 1125, for example, an interface associated with wired connection, such as a USB interface, a micro-USB interface, or a memory card interface may be used, and the interface 1125 may be configured as a wireless communication interface. The external apparatuses OA are image supply apparatuses which supply images to the head mounted display apparatus 1100, and include, for example, a personal computer (PC), a mobile phone, and a portable game machine.

The control device 1010 includes a control unit 1140, an input information acquisition unit 1110, a storage unit 1120, a transmission unit (Tx) 1051, and a transmission unit (Tx) 1052.

The input information acquisition unit 1110 is coupled to an operation unit 1135. The operation unit 1135 includes the track pad 1014, the direction key 1016, the power switch 1018, and the like, and the input information acquisition unit 1110 acquires input content on the basis of a signal which is input from the operation unit 1135. The control device 1010 includes a power source unit 1130, and supplies power to each unit of the control device 1010 and the image display section 1020.

The storage unit 1120 is a nonvolatile storage device, and stores various computer programs and data related to the programs. The storage unit 1120 may store data regarding still images or moving images which are displayed on the image display section 1020.

The storage unit 1120 stores set data 1121. The set data 1121 includes set values related to various processes performed by the control unit 1140. For example, the set data 1121 includes a set value such as a resolution in a case where an image processing unit 1160 and a display control unit 1170 process image signals. Set values included in the set data 1121 may be a value which is input through an operation on the operation unit 1135 in advance, and set values may be received from the external apparatuses OA or other apparatuses (not illustrated) via a communication unit 1117 or the interface 1125 and may be stored.

The storage unit 1120 stores sensor position data 1122 and content data 1123. The sensor position data 1122 includes calculation expressions, parameters, and the like used for a calculation process in the motion detection unit 1185 which will be described later. The content data 1123 includes image (still image or moving image) data for content which is AR-displayed by the AR display control unit 1186, and/or audio data.

The control unit 1140 is connected to a sensor 1113, a GPS 1115, and the communication unit 1117. The sensor 1113 includes an inertial sensor such as an acceleration sensor or an angular velocity sensor, and the control unit 1140 acquires a detection value of the sensor 1113. The sensor 1113 may be constituted of, for example, a three-axis acceleration sensor, or a nine-axis sensor including a three-axis acceleration sensor, a three-axis angular velocity sensor, and a three-axis magnetic sensor.

The GPS 1115 includes an antenna (not illustrated), receives a global positioning system (GPS) signal, and calculates a current position of the control device 1010. The GPS 1115 outputs the current position or the current time obtained on the basis of a GPS signal, to the control unit 1140. The GPS 1115 may have a function of acquiring the current time on the basis of information included in a GPS signal, and of correcting a time point counted by the control unit 1140.

The communication unit 1117 performs wireless data communication conforming to a wireless communication standard such as a wireless LAN (WiFi (registered trademark)), Miracast (registered trademark), or Bluetooth (registered trademark).

In a case where the external apparatuses OA are wirelessly connected to the communication unit 1117, the control unit 1140 acquires the content data 1123 from the communication unit 1117 and displays an image on the image display section 1020. On the other hand, in a case where the external apparatuses OA are connected to the interface 1125 in a wired manner, the control unit 1140 acquires the content data 1123 from the interface 1125 and displays an image on the image display section 1020. Therefore, the communication unit 1117 and the interface 1125 are hereinafter collectively referred to as a data acquisition unit DA which acquires the content data 1123.

The control unit 1140 includes a CPU (not illustrated) which executes a program, a RAM (not illustrated) which temporarily stores the program executed by the CPU or data, and a ROM (not illustrated) which stores a fundamental control program executed by the CPU or data in a nonvolatile manner. The control unit 1140 controls each unit of the head mounted display apparatus 1100 by the CPU executing a control program. The control unit 1140 reads a computer program stored in the storage unit 1120 and executes the computer program, so as to realize various functions of the control unit 1140. In other words, the control unit 1140 functions as an operating system (OS) 1150, the image processing unit 1160, and the display control unit 1170. The control unit 1140 also functions as the imaging processing unit 1181, the detection control unit 1183, a position detection unit 1184 (control unit), the motion detection unit 1185, the AR display control unit 1186 (display processing unit), and the sound processing unit 1187.

The image processing unit 1160 acquires an image signal included in the content. The image processing unit 1160 separates a synchronization signal such as the vertical synchronization signal VSync or the horizontal synchronization signal HSync from the acquired image signal. The image processing unit 1160 generates a clock signal PCLK through the use of a PLL circuit or the like (not illustrated) on the basis of a cycle of the separated vertical synchronization signal VSync or horizontal synchronization signal HSync. The image processing unit 1160 converts an analog image signal from which the synchronization signal is separated into a digital image signal by the use of an A/D conversion circuit or the like (not illustrated). The image processing unit 1160 stores the converted digital image signal as image data (Data in FIG. 19) of a target image in the RAM of the control unit 1140 for each frame. The image data is, for example, RGB data.

The image processing unit 1160 may perform a resolution conversion process of converting a resolution of the image data into a resolution suitable for the right display driving unit 1022 and the left display driving unit 1024 as necessary. The image processing unit 1160 may perform an image adjustment process of adjusting luminance or chroma of the image data, and a 2D/3D conversion process of creating 2D image data from 3D image data or creating 3D image data from 2D image data.

The image processing unit 1160 transmits the clock signal PCLK, the vertical synchronization signal VSync, the horizontal synchronization signal HSync, and the image data Data stored in the RAM via the transmission units 1051 and 1052. The transmission units 1051 and 1052 function as transceivers for performing serial transmission between the control device 1010 and the image display section 1020. The image data Data transmitted via the transmission unit 1051 is referred to as “right eye image data” and the image data Data transmitted via the transmission unit 1052 is referred to as “left eye image data”.

The display control unit 1170 generates a control signal for controlling the right display driving unit 1022 and the left display driving unit 1024, and controls generation and emission of image light of each of the right display driving unit 1022 and the left display driving unit 1024 by using the control signal. Specifically, the display control unit 1170 controls the right LCD control portion 1211 to control ON and OFF of driving of the right LCD 1241 and controls the right backlight control portion 1201 to control ON and OFF of driving of the right backlight 1221. The display control unit 1170 controls the left LCD control portion 1212 to control ON and OFF of driving of the left LCD 1242 and controls the left backlight control portion 1202 to control ON and OFF of driving of the left backlight 1222.

The imaging processing unit 1181 controls the camera 1061 to perform imaging so as to acquire captured image data.

The position detection unit 1184 is coupled to the first rotational movement sensor 1071 and the second rotational movement sensor 1072, and detects an angle between the temple portion 1002D and the arm portion 1003A at the hinge 1021A and an angle between the temple portion 1002E and the arm portion 1003B at the hinge 1023A.

The detection control unit 1183 drives each of the first sensor 1066 and the second sensor 1068 so as to acquire detection values therefrom. For example, the first sensor 1066 and the second sensor 1068 are initialized so as to be brought into a detection possible state when power starts to be supplied to the head mounted display apparatus 1100. The detection control unit 1183 acquires a detection value of each of the first sensor 1066 and the second sensor 1068 in a preset sampling cycle. In the present embodiment, each of the first sensor 1066 and the second sensor 1068 outputs detection values of angular velocity of a rotation (pitch) around the X axis, a rotation (yaw) around the Y axis, and a rotation (roll) around the Z axis. The detection values may include a size and a rotation direction of angular velocity.

The motion detection unit 1185 calculates a motion amount at a movement center on the basis of the detection values of the first sensor 1066 and the second sensor 1068, acquired by the detection control unit 1183. The movement center is the same as described above, and may be the center of the head of the user, the center of the neck, or the like.

The motion detection unit 1185 performs calculation of head tracking by using the sensor position data 1122 stored in the storage unit 1120. The sensor position data 1122 includes data indicating a relative positional relationship between or absolute positions of the position of the first sensor 1066 and the position of the second sensor 1068. The sensor position data 1122 corresponds to the above-described sensor position data 122. Here, the motion detection unit 1185 may calculate a position of a movement center on the basis of detection results from the first sensor 1066 and the second sensor 1068. Alternatively, a motion amount at a movement center may be calculated instead of calculating the position of the movement center. The motion amount may be velocity, may include velocity and time, and may be a movement amount.

For example, the motion detection unit 1185 obtains a component around the X axis, a component around the Y axis, and a component around the Z axis on the basis of the detection values of the angular velocity from the first sensor 1066 and the second sensor 1068. The motion detection unit 1185 obtains the center of the rotation around the X axis, the center of the rotation around the Y axis, and the center of the rotation around the Z axis on the basis of the detection values of the first sensor 1066 and the second sensor 1068, and the positions of the first sensor 1066 and the second sensor 1068 of the sensor position data 1122. The motion detection unit 1185 obtains the center of a three-dimensional motion, that is, a position of a movement center, a direction of the motion at the movement center, and the magnitude (or strength) of the motion at the movement center.

The motion detection unit 1185 may obtain not only a direction and a magnitude of a motion at a movement center but also a direction and/or a magnitude of a motion at a predefined point.

The AR display control unit 1186 reads the content data 1123 stored in the storage unit 1120, and controls the image processing unit 1160 and the display control unit 1170 so that the image display section 1020 displays an AR display image. In a case where the content data 1123 includes audio data, the AR display control unit 1186 controls the sound processing unit 1187 so that the right earphone 1032 and the left earphone 1034 output audio content.

The AR display control unit 1186 controls display of AR content on the basis of rotational movement positions at the hinges 1021A and 1023A, detected by the position detection unit 1184.

The AR display control unit 1186 displays the AR content in a state in which the user sees a target object through the image display section 1020. The AR display control unit 1186 performs AR display for displaying an image or text at a position corresponding to the target object so as to provide information regarding the target object, or so as to change the way of viewing a shape of the target object which is seen through the image display section 1020. The AR content includes data regarding an image or text displayed at the position corresponding to the target object. The AR content may include data for specifying a target object, data regarding a display position of an image or text, and the like. The display position of the AR content may be a position where the AR content overlaps the target object, and may be the vicinity of the target object. The target object may be an object, a real estate such as a building, a moving object such as an automobile or an electric train, or a living thing such as a human or an animal. The AR display control unit 1186 detects a target object located in a visual field of the user from captured image data acquired by the imaging processing unit 1181. The AR display control unit 1186 determines a display position of AR content corresponding to the detected target object, and displays the AR content at the position.

The AR content is preferably displayed so as to overlap a position where the user visually recognizes a target object or so as to match a position where the user visually recognizes the target object. For this reason, the AR display control unit 1186 detects an image of the target object from captured image data obtained by the imaging processing unit 1181, and specifies a position of the target object in the imaging region of the camera 1061 on the basis of a positional relationship between the detected image of the target object and the entire captured image. The AR display control unit 1186 determines a display position of the AR content corresponding to the position of the target object on the basis of a positional relationship between the imaging region of the camera 1061 and the display region of the image display section 1020.

In addition, the AR display control unit 1186 detects an image of the target object from captured image data obtained by the imaging processing unit 1181, and specifies a position of the target object in the imaging region of the camera 1061 on the basis of a positional relationship between the detected image of the target object and the entire captured image. The AR display control unit 1186 determines a display position of the AR content corresponding to the position of the target object on the basis of a positional relationship between the imaging region of the camera 1061 and the display region of the image display section 1020.

A method in which the AR display control unit 1186 changes a display aspect of the AR content so as to correspond to a motion of the head of the user may be set in advance by a set value included in the set data 1121. The method may be set by a program executed by the control unit 1140.

Here, display control performed by the AR display control unit 1186 is designed to be performed according to a process corresponding to a motion at the center of the head of the user, the center of the front portion of the head, or the cervical vertebra. This is because, if the control is performed in accordance with a motion at the center of the head, the center of the front portion of the head, or the cervical vertebra, a display change can be easily generated as an image when the display change is designed, the control is simple and thus an error is unlikely to occur, and an effective display change can be designed. For this reason, a set value of a motion at the center of the head of the user, the center of the front portion of the head, or the cervical vertebra is set in the set data 1121. The AR display control unit 1186 processes a motion at the center of the head of the user, the center of the front portion of the head, or the cervical vertebra, calculated by the motion detection unit 1185, through comparison and contrast with the set data 1121.

As a method which is different from the above-described method, display control performed by the AR display control unit 1186 may be designed so as to correspond to a motion at the positions of the first sensor 1066 and the second sensor 1068 which actually detect a motion. For example, set values regarding detection values of the first sensor 1066 and the second sensor 1068 are set in the set data 1121, and the AR display control unit 1186 performs a process on the basis of the set values. Also in this case, display can be controlled so as to correspond to a motion of the head of the user. However, these set values are values fixed to the positions of the first sensor 1066 and the second sensor 1068, and new set values are necessary in a case where the positions or the number of the sensors are changed due to a specification change of the head mounted display apparatus 1100. In contrast, in the method of calculating a reference location for a motion, and a motion at the reference location on the basis of detection values of the first sensor 1066 and the second sensor 1068, set values are not specific to the apparatus and are generally used. Therefore, there is an advantage in that control of a display aspect of the AR content is facilitated, and thus effective AR display can be performed.

The head mounted display apparatus 1100 includes constituent elements common to the head mounted display apparatus 100 described in the first and second embodiment. In other words, the reference numeral 1002 corresponds to the frame 2 described in the first embodiment, the reference numeral 1002A corresponds to the right portion 2A, the reference numeral 1002B corresponds to the left portion 2B, the reference numeral 1002C corresponds to the bridge portion 2C, the reference numeral 1002D corresponds to the temple portion 2D, and the reference numeral 1002E corresponds to the temple portion 2E.

The reference numeral 1003 corresponds to the camera unit 3, the reference numeral 1003A corresponds to the arm portion 3A, the reference numeral 1003B corresponds to the arm portion 3B, and the reference numeral 1003C corresponds to the camera pedestal portion 3C.

The reference numeral 1010 corresponds to the control device 10, the reference numeral 1011 corresponds to the determination key 11, the reference numeral 1012 corresponds to the lighting unit 12, the reference numeral 1014 corresponds to the track pad 14, and the reference numeral 1015 corresponds to the luminance change key 15. The reference numeral 1016 corresponds to the direction key 16, the reference numeral 1017 corresponds to the menu key 17, and the reference numeral 1018 corresponds to the power switch 18.

The reference numeral 1020 corresponds to the image display section 20, the reference numeral 1020A corresponds to the dimming plate 20A, the reference numeral 1021 corresponds to the right holding unit 21, the reference numeral 1021A corresponds to the hinge 21A, and the reference numeral 1022 corresponds to the right display driving unit 22. The reference numeral 1023 corresponds to the left holding unit 23, and the reference numeral 1023A corresponds to the hinge 23A.

The reference numeral 1024 corresponds to the left display driving unit 24, the reference numeral 1025 corresponds to the interface 25, the reference numeral 1026 corresponds to the right optical image display unit 26, the reference numeral 1028 corresponds to the left optical image display unit 28, and the reference numeral 1030 corresponds to the earphone plug 30. The reference numeral 1032 corresponds to the right earphone 32, and the reference numeral 1034 corresponds to the left earphone 34.

The reference numeral 1040 corresponds to the coupling unit 40, the reference numeral 1042 corresponds to the right cord 42, the reference numeral 1044 corresponds to the left cord 44, the reference numeral 1046 corresponds to the connecting member 46, and the reference numeral 1048 corresponds to the main cord 48.

The reference numeral 1051 corresponds to the transmission unit 51, the reference numeral 1052 corresponds to the transmission unit 52, the reference numeral 1053 corresponds to the reception portion 53, the reference numeral 1054 corresponds to the reception portion 54, and the reference numeral 1061 corresponds to the upper camera 61. The reference numeral 1063 corresponds to the microphone 63.

The reference numeral 1110 corresponds to the input information acquisition unit 110, the reference numeral 1113 corresponds to the sensor 113, the reference numeral 1115 corresponds to the GPS 115, the reference numeral 1117 corresponds to the communication unit 117, and the reference numeral 1120 corresponds to the storage unit 120.

The reference numeral 1121 corresponds to the set data 121, the reference numeral 1122 corresponds to the sensor position data 122, the reference numeral 1123 corresponds to the content data 123, the reference numeral 1125 corresponds to the interface 125, the reference numeral 1130 corresponds to the power source unit 130, and the reference numeral 1135 corresponds to the operation unit 135.

The reference numeral 1140 corresponds to the control unit 140, the reference numeral 1150 corresponds to the OS 150, the reference numeral 1160 corresponds to the image processing unit 160, the reference numeral 1181 corresponds to the imaging processing unit 181, and the reference numeral 1183 corresponds to the detection control unit 183.

The reference numeral 1185 corresponds to the motion detection unit 185, the reference numeral 1186 corresponds to the AR display control unit 186, and the reference numeral 1187 corresponds to the sound processing unit 187.

The reference numeral 1201 corresponds to the right backlight control portion 201, the reference numeral 1202 corresponds to the left backlight control portion 202, the reference numeral 1211 corresponds to the right LCD control portion 211, and the reference numeral 1212 corresponds to the left LCD control portion 212.

The reference numeral 1221 corresponds to the right backlight 221, the reference numeral 1222 corresponds to the left backlight 222, the reference numeral 1241 corresponds to the right LCD 241, the reference numeral 1242 corresponds to the left LCD 242, the reference numeral 1251 corresponds to the right projection optical system 251, and the reference numeral 1252 corresponds to the left projection optical system 252.

The reference numeral 1261 corresponds to the right light guide plate 261, the reference numeral 1261A corresponds to the half mirror 261A, the reference numeral 1262 corresponds to the left light guide plate 262, and the reference numeral 1262A corresponds to the half mirror 262A.

Other constituent elements common to the first embodiment are given the same reference numerals.

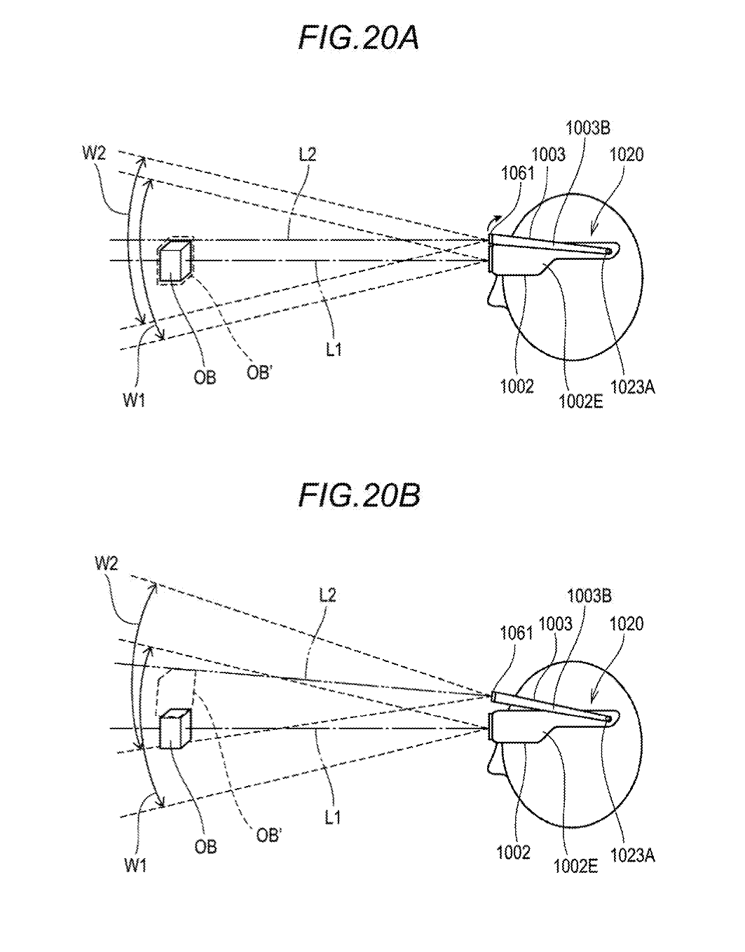

FIGS. 20A and 20B are side views illustrating a mounting state of the head mounted display apparatus 1100, in which FIG. 20A illustrates a state in which the camera unit 1003 is not rotationally moved, and FIG. 20B illustrates a state in which the camera unit 1003 is rotationally moved upward with respect to the frame 1002.

In FIG. 20A, a dot chain line L1 indicates a visual line of the user, and a visual field of the user is indicated by the reference sign W1. A two-dot chain line L2 indicates an imaging direction of the camera 1061, that is, an optical axis of an imaging optical system (not illustrated) included in the camera 1061. In FIGS. 20A and 20B, an imaging region of the camera 1061 is indicated by the reference sign W2.

In a case where a target object OB is located in the visual line direction of the user, the AR display control unit 1186 displays AR content OB′ so as to match a position of the target object OB. The AR content OB′ is an image which is viewed so as to overlap the target object OB, and is a virtual image which is formed by image light L emitted toward the eyes of the user by the image display section 1020. In FIG. 20A, the virtual position where the user visually recognizes (perceives) the AR content OB′ is indicated by a dashed line.

In the state illustrated in FIG. 20A, the AR content OB′ is visually recognized by the user so as to overlap the target object OB. In contrast, if the camera unit 1003 is rotationally moved upward with respect to the frame 1002, as illustrated in FIG. 20B, the imaging direction L2 and the imaging region W2 of the camera 1061 are moved upward. In this case, a correspondence relationship between the imaging region W2 of the camera 1061 and the visual field W1 of the user is changed. Specifically, since the position of the target object OB in the imaging region W2 of the camera 1061 is changed, a position of the target object OB detected by the AR display control unit 1186 is changed. Therefore, although a relative position between the target object OB and the user is not changed, the position of the target object OB obtained by the AR display control unit 1186 is changed. The AR display control unit 1186 determines a display position of the AR content OB′ on the basis of the changed position of the target object OB. For this reason, as illustrated in FIG. 20B, the display position of the AR content OB′ appears not to correspond to the position of the target object OB to the user.

Not only in a case where the camera unit 1003 is moved upward with respect to the frame 1002, but also in a case where the frame 1002 is moved downward, a change occurs. In this case, since the visual field W1 of the user is moved downward, a position of the target object OB detected by the AR display control unit 1186 is deviated relative to a position of the target object OB visually recognized by the user in the visual field W1 of the user. Therefore, in the same manner as in the case illustrated in FIG. 20B, the display position of the AR content OB′ appears not to correspond to the position of the target object OB to the user.

In a case where the camera unit 1003 or the frame 1002 is rotationally moved as illustrated in FIGS. 20A and 20B, the AR display control unit 1186 has a function of adjusting a display position of the AR content OB′ in accordance with the rotational movement. The AR display control unit 1186 determines a display position of the AR content corresponding to a position of the target object on the basis of a positional relationship between the imaging region of the camera 1061 and a display region of the image display section 1020, and then adjusts the display position.

In other words, the AR display control unit 1186 obtains a deviation amount between a central axis of the visual field visually recognized by the user through the image display section 1020 and the optical axis of the camera 1061, and corrects the display position of the AR content so as to correct the deviation amount. The adjustment (correction) of the display position is performed on the basis of detection values of the first rotational movement sensor 1071 and the second rotational movement sensor 1072, detected by the position detection unit 1184. The adjustment will be described later.

The sound processing unit 1187 acquires a sound signal included in the content, amplifies the acquired sound signal, and supplies the amplified sound signal to the right earphone 1032 and the left earphone 1034 under the control of the AR display control unit 1186. The sound processing unit 1187 acquires sound collected by the microphone 1063 and converts the sound into digital audio data. The sound processing unit 1187 may perform a preset process on the digital audio data.

The image display section 1020 includes an interface 1025, the right display driving unit 1022, the left display driving unit 1024, the right light guide plate 1261 as the right optical image display unit 1026, and the left light guide plate 1262 as the left optical image display unit 1028. The image display section 1020 includes the camera 1061, the first rotational movement sensor 1071, and the second rotational movement sensor 1072 described above. The camera 1061 is provided in the camera unit 1003 separately from the frame 1002 (FIG. 17), but is coupled to the interface 1025.

The interface 1025 includes a connector to which the right cord 1042 and the left cord 1044 are connected. The interface 1025 outputs the clock signal PCLK, the vertical synchronization signal VSync, the horizontal synchronization signal HSync, and the image data Data transmitted from the transmission unit 1051, to corresponding reception portions (Rx) 1053 and 1054. The interface 1025 outputs the control signal transmitted from the display control unit 1170 to the corresponding reception portions 1053 and 1054, and the right backlight control portion 1201 or the left backlight control portion 1202.

The interface 1025 is an interface which couples the camera 1061, first rotational movement sensor 1071, and the second rotational movement sensor 1072 to each other. Captured image data or an imaging signal from the camera 1061, detection results from the first rotational movement sensor 1071 and the second rotational movement sensor 1072, and the like are sent to the control unit 1140 via the interface 1025.

The camera 1061 is coupled to the interface 1025 via a camera coupling portion 1061a. The camera coupling portion 1061a is a cable disposed, for example, through the insides of the camera pedestal portion 1003C, and the arm portions 1003A and 1003B, or along outer surfaces thereof, and is coupled to the interface 1025 disposed inside the frame 1002 in a wired manner. The camera coupling portion 1061a constitutes a coupling unit which couples the camera 1061 to the control unit 1140 along with the coupling unit 1040 and the interface 1025.

The camera coupling portion 1061a may be replaced with a wireless communication line. In this case, there may be a configuration in which a wireless communication unit is provided on the camera 1061 side, a wireless communication unit is provided in the frame 1002, and the wireless communication units transmit and receive captured image data or control data in a wireless manner such as WiFi. The wireless communication unit of the camera 1061 side may perform communication with the communication unit 1117.

The right display driving unit 1022 includes the right backlight 1221, the right LCD 1241, and the right projection optical system 1251 described above. The right display driving unit 1022 includes the reception portion 1053, a right backlight (BL) control portion 1201 which controls the right backlight (BL) 1221, and a right LCD control portion 1211 which controls the right LCD 1241.

The reception portion 1053 operates as a receiver corresponding to the transmission unit 1051 so as to perform serial transmission between the control device 1010 and the image display section 1020. The right backlight control portion 1201 drives the right backlight 1221 on the basis of an input control signal. The right LCD control portion 1211 drives the right LCD 1241 on the basis of the clock signal PCLK, the vertical synchronization signal VSync, the horizontal synchronization signal HSync, and the right eye image data Data, which are input via the reception portion 1053.

The left display driving unit 1024 has the same configuration as that of the right display driving unit 1022. The left display driving unit 1024 includes the left backlight 1222, the left LCD 1242, and the left projection optical system 1252 described above. The left display driving unit 1024 includes the reception portion 1054, a left backlight control portion 1202 which drives the left backlight 1222, and a left LCD control portion 1212 which drives the left LCD 1242.

The reception portion 1054 operates as a receiver corresponding to the transmission unit 1052 so as to perform serial transmission between the control device 1010 and the image display section 1020. The left backlight control portion 1202 drives the left backlight 1222 on the basis of an input control signal. The left LCD control portion 1212 drives the left LCD 1242 on the basis of the clock signal PCLK, the vertical synchronization signal VSync, the horizontal synchronization signal HSync, and the right eye image data Data, which are input via the reception portion 1054.

The right backlight control portion 1201, the right LCD control portion 1211, the right backlight 1221, and the right LCD 1241 are collectively referred to as a right “image light generation unit”. Similarly, the left backlight control portion 1202, the left LCD control portion 1212, the left backlight 1222, and the left LCD 1242 are collectively referred to as a left “image light generation unit”.

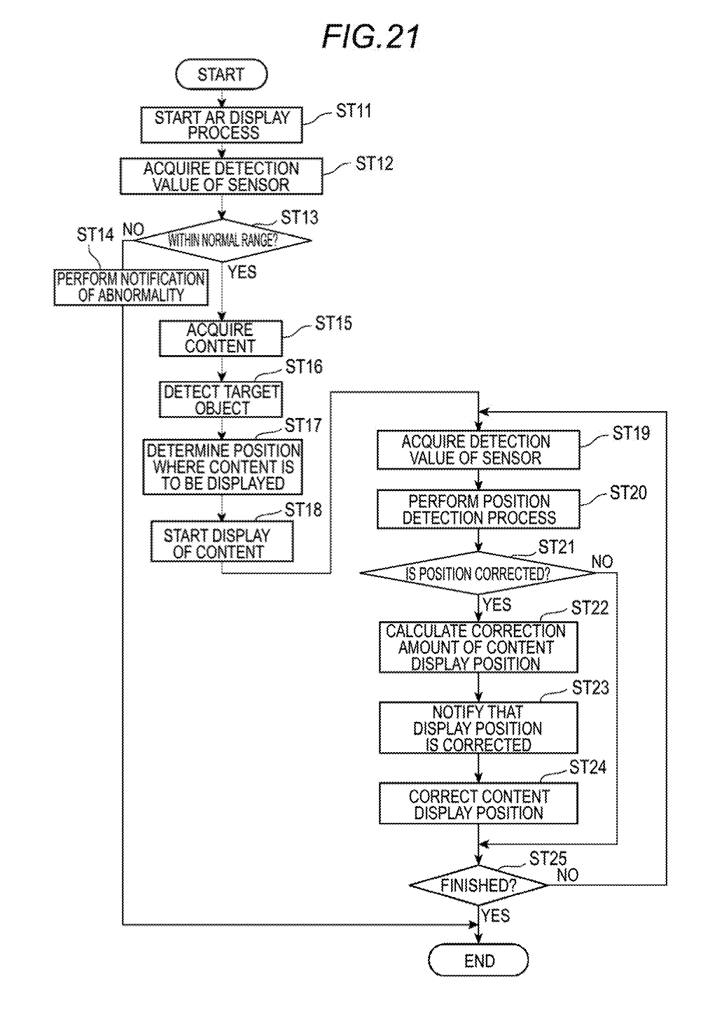

FIG. 21 is a flowchart illustrating an operation of the head mounted display apparatus 1100, and, particularly illustrates an operation in which the control unit 1140 displays the AR content OB′.

The control unit 1140 starts display of AR content in response to an instruction which is input via the operation unit 1135 or the like (step ST11), and the position detection unit 1184 acquires detection values of the first rotational movement sensor 1071 and the second rotational movement sensor 1072 (step ST12). The position detection unit 1184 determines whether or not both of the detection values of the first rotational movement sensor 1071 and the second rotational movement sensor 1072 are values within a normal range (step ST13). In other words, it is determined whether or not the camera unit 1003 or the frame 1002 is rotationally moved to exceed movable ranges of the hinges 1021A and 1023A. This is aimed at rapidly stopping the operation in order to prevent failures thereof in a case where the hinges 1021A and 1023A are in a state of exceeding the movable ranges thereof.

In a case where one or both of the detection values of the first rotational movement sensor 1071 and the second rotational movement sensor 1072 is or are out of the normal range (NO in step ST13), the position detection unit 1184 performs an operation for a notification of abnormality (step ST14), and finishes the operation. The notification of abnormality in step ST14 may be performed, for example, by causing the image display section 1020 to display a message, by lighting the lighting unit 1012 or causing the lighting unit 1012 to blink, or by outputting warning sound or sound of a notification message from the right earphone 1032 and the left earphone 1034.

In a case where the position detection unit 1184 determines that the detection values of the first rotational movement sensor 1071 and the second rotational movement sensor 1072 are within the normal range (YES in step ST13), the AR display control unit 1186 acquires the content data 1123 from the storage unit 1120 (step ST15). Next, the imaging processing unit 1181 causes the camera 1061 to perform imaging, and the AR display control unit 1186 detects a target object from captured image data (step ST16). The AR display control unit 1186 determines a display position of the AR content on the basis of a position of the target object (step ST17), and starts display of the AR content (step ST18).

After the display of the AR content is started, the position detection unit 1184 acquires detection values of the first rotational movement sensor 1071 and the second rotational movement sensor 1072 (step ST19), and performs a position detection process (step ST20). The position detection process of the third embodiment is a process in which the position detection unit 1184 obtains an angle between the arm portion 1003A and the temple portion 1002D at the hinge 1021A and an angle between the arm portion 1003B and the temple portion 1002E at the hinge 1023A. The position detection unit 1184 may obtain a difference between an imaging direction of the camera 1061 and an imaging direction of a reference location. The reference location is a preset position in a rotational movement range of the camera unit 1003. For example, the reference location is a position where an angle between the arm portion 1003A and the temple portion 1002D at the hinge 1021A and an angle between the arm portion 1003B and the temple portion 1002E at the hinge 1023A are smallest. For example, the reference location is a position where the camera unit 1003 is closest to the frame 1002 side.

The AR display control unit 1186 determines whether or not correction of the display position of the AR content is necessary on the basis of the angles detected by the position detection unit 1184 (step ST21). For example, in a case where the angles detected by the position detection unit 1184 exceed threshold values included in the set data 1121, it is determined that correction of the display position is necessary.

In a case where it is determined that correction of the display position is necessary (YES in step ST21), the AR display control unit 1186 calculates a correction amount of the display position of the AR content (step ST22). In step ST22, the correction amount is calculated on the basis of the position detected in step ST20 by using a calculation expression, a function, a table, a parameter, and the like included in the set data 1121.

The AR display control unit 1186 performs a notification that correction of the display position is performed (step ST23). In step ST23, for example, the image display section 1020 displays a notification message or image. The message or the image may be displayed so as to match a position of the target object in the same manner as the AR content, and the notification message or image may be displayed at a corrected display position of the AR content. Here, the AR display control unit 1186 may proceed to step ST24 without performing a notification in step ST23, and may automatically proceed to step ST24 after a predetermined time elapses from a notification in step ST23. Alternatively, the AR display control unit 1186 waits for a user's operation after a notification is performed in step ST23, and may proceed to step ST24 when the user performs an operation of giving an instruction for execution.

In a case where the correction amount calculated in step ST22 exceeds an amount which can be corrected by the AR display control unit 1186, the AR display control unit 1186 may perform a notification of abnormality. For example, in a case where an upper limit value of a correction amount of the AR content is preset for each correction direction, and a correction amount exceeding the upper limit value is calculated, a notification may be performed. In step ST21, it may be determined whether or not an angle detected by the position detection unit 1184 is not included in a range which is set in advance as a range of a correctable angle. In a case where it is determined that a detected angle is not included in the correctable range, a notification may be performed. A method of the notification may be the same as the method of the notification performed in step ST14.

The AR display control unit 1186 corrects the display position of the AR content according to the correction amount calculated in step ST22 (step ST24), and determines whether or not a finish condition is satisfied (step ST25). In a case where the display position is not to be corrected on the basis of the angles at the hinges 1021A and 1023A detected by the position detection unit 1184 (NO in step ST21), the control unit 1140 proceeds to step ST25 and determines whether or not the finish condition is satisfied.

In a case where the finish condition is satisfied (YES in step ST25), the control unit 1140 finishes the present process. In a case where the finish condition is not satisfied (NO in step ST25), the flow returns to step ST19. The finish condition is that, for example, the AR content is displayed to the end, display is completed, an instruction for ending of display of the AR content is given through an operation on the operation unit 1135, an instruction for finishing an operation is given from an external apparatus via the interface 1125, and the like.

In the process illustrated in FIG. 21, in a case where an instruction for correction of the display position is given through an operation on the operation unit 1135, the AR display control unit 1186 determines whether or not correction of the display position is necessary in step ST21. In this case, after the instruction for correction of the display position is given through an operation on the operation unit 1135, the processes in steps ST19, ST20 and ST22 are performed, and thus a correction amount is calculated. In a case where a correction amount is designated through an operation on the operation unit 1135, correction is performed on the basis of the designated correction amount. In a case where an instruction for a direction of correction is given through an operation on the operation unit 1135, the display position may be corrected in a preset correction amount in the direction for which the instruction is given. This series of processes may be performed through interruption control with an operation on the operation unit 1135 as a trigger during execution of the process illustrated in FIG. 21.

In the process illustrated in FIG. 21, the processes in steps ST19 to ST25 are not limited to flow control. For example, if the position detection unit 1184 detects a rotational movement on the basis of output values from the first rotational movement sensor 1071 and the second rotational movement sensor 1072, the processes in steps ST19 to ST25 may be performed through interruption control with the detection of the rotational movement as a trigger.

The head mounted display apparatus 1100 may include a deviation amount detection unit (not illustrated) which acquires detection values of the first rotational movement sensor 1071 and the second rotational movement sensor 1072 and obtains a deviation amount between the central axis (visual line direction) of the visual field of the user and the optical axis of the camera 1061, separately from the position detection unit 1184. The deviation amount detection unit may be realized as a processing unit which can perform a process separately from the position detection unit 1184 by the CPU of the control unit 1140 executing a program. The deviation amount detection unit may be provided separately from the control unit 1140. The deviation amount detection unit obtains an angle between the arm portion 1003A and the temple portion 1002D at the hinge 1021A and an angle between the arm portion 1003B and the temple portion 1002E at the hinge 1023A, separately from the process in the position detection unit 1184. In this case, the position detection unit 1184 acquires, from the deviation amount detection unit, a position or a displacement amount of the camera 1061 relative to the frame 1002 or a deviation amount between the central axis of the visual field of the user and the optical axis of the camera 1061 when the AR display control unit 1186 displays the AR content. There may be a configuration in which, when the deviation amount detection unit detects a deviation amount exceeding a set threshold value, the deviation amount is input to the control unit 1140 through interruption.

In the head mounted display apparatus 1100, the motion detection unit 1185 may perform a process of obtaining a direction of a motion and a motion amount at a movement center on the basis of detection values of the first sensor 1066 and the second sensor 1068. Specifically, the process illustrated in FIG. 8 described in the first embodiment or the process illustrated in FIG. 15 described in the second embodiment may be performed.

In the head mounted display apparatus 1100, the motion detection unit 1185 and the AR display control unit 1186 may perform processes on the basis of the direction of the motion and the motion amount detected by the motion detection unit 1185. Specifically, the processes illustrated in FIGS. 10, 11 and 13 described in the first embodiment may be performed.

In this case, the head mounted display apparatus 1100 may perform head tracking so as to obtain a direction of a motion and a motion amount at a movement center by using the center of the head or a movable portion of the neck of the user as the movement center. The head mounted display apparatus 1100 may obtain a relative position between the visual field of the user and the imaging region (angle of view) of the camera 1061 on the basis of a result of the head tracking. The head mounted display apparatus 1100 may obtain a relative position between a mounting position of the image display section 1020 and positions of the eyes of the user on the basis of the result of the head tracking, and may determine whether or not a mounting state of the image display section 1020 is appropriate. The head mounted display apparatus 1100 may perform a process of outputting a message which prompts the user to correct the mounting position of the image display section 1020, or a process of correcting a captured image obtained by the camera 1061 on the basis of the result of the head tracking. In a case where the head of the user is moved, the head mounted display apparatus 1100 may determine whether or not the motion is a motion based on a cognitive action on the basis of the result of the head tracking. The head mounted display apparatus 1100 may perform a process of correcting a captured image obtained by the camera 1061 in relation to a motion which is not based on the cognitive action.

As described above, the head mounted display apparatus 1100 mounted on the head of the user includes the frame 1002 mounted on the head of the user. The head mounted display apparatus 1100 includes the image display section 1020 provided on the frame 1002, the camera 1061 which can be connected to the frame 1002 so as to be displaced, and the first rotational movement sensor 1071 and the second rotational movement sensor 1072 which detect a position or displacement of the camera 1061 relative to the frame 1002. The head mounted display apparatus 1100 includes the position detection unit 1184 which obtains a relative position between the frame 1002 and the camera 1061 by using the first rotational movement sensor 1071 and the second rotational movement sensor 1072. Consequently, since the camera 1061 which can be displaced with respect to the image display section 1020 is provided, an imaging region can be changed, and thus it is possible to correct a display position of AR content according to a motion of the camera 1061 as necessary in a case where the camera 1061 is moved.

For example, as disclosed in JP-A-2011-2753, in the related art, a display apparatus mounted on the head is known. The display disclosed in JP-A-2011-2753 is a display in which a see-through light guide element is provided on a spectacle type frame, and an imaging device is attached to the frame. The display matches an image captured by the imaging device with an image of a target object visually recognized by a user through the light guide element, so as to generate correction data, and matches imaging data with a visual field of the user on the basis of the correction data. Consequently, an augmented reality (AR) technique is realized so that various data regarding the target object is display so as to overlap the image of the target object. The imaging device included in the display disclosed in JP-A-2011-2753 is provided on and fixed to the frame, and thus the user is required to move the head thereof in order to change an imaging region of the imaging device. In light of this fact, the head mounted display apparatus of the third embodiment having an imaging function can change an imaging region. As described above, since the head mounted display apparatus 1100 includes the camera 1061 which can be displaced with respect to the image display section 1020 and can thus change the imaging region, in a case where the camera 1061 is moved, it is possible to correct a display position of AR content as necessary according to the motion of the camera 1061.

The head mounted display apparatus 1100 includes the hinges 1021A and 1023A via which the camera 1061 is connected to the frame 1002 so as to be rotationally moved. The first rotational movement sensor 1071 and the second rotational movement sensor 1072 detect the magnitudes of angles or changes in the angles at the hinges 1021A and 1023A. Here, the detected angles are, for example, angles between the frame 1002 and the camera unit 1003 at the hinges 1021A and 1023A. For this reason, it is possible to easily realize a configuration in which the camera 1061 is connected to the frame 1002 so as to be movable and thus a position or displacement of the camera 1061 is detected.

The head mounted display apparatus 1100 includes the first rotational movement sensor 1071 and the second rotational movement sensor 1072 which are a plurality of sensors as a detection unit. The position detection unit 1184 obtains a relative position between the frame 1002 and the camera 1061 on the basis of detection values of the plurality of sensors, and can thus more accurately detect a position or displacement of the camera 1061.

The head mounted display apparatus 1100 includes the AR display control unit 1186 which displays AR content on the display section on the basis of a captured image obtained by the camera 1061, and can thus display the content on the basis of an image captured by the camera 1061. It is possible to change an imaging region by displacing the camera 1061.

The AR display control unit 1186 may adjust a display position of the content on the basis of a relative position between the frame 1002 and the camera 1061 obtained by the position detection unit 1184. For this reason, it is possible to maintain display matching by adjusting the display position in a case where the camera 1061 is displaced. Therefore, it is possible to displace the camera 1061 in a state in which the display of the content is continuously being performed. The AR display control unit 1186 can improve a user's convenience since a notification is performed before adjusting the display position of the content.

The AR display control unit 1186 adjusts the display position of the AR content so as to compensate for a deviation between the central axis of the visual field of the user and the optical axis of the camera 1061 on the basis of the relative position between the frame 1002 and the camera 1061. Thus, it is possible to correct a position of the AR content which is displayed on the basis of an image captured by the camera 1061, to a position suitable for the visual line of the user.

Since the AR display control unit 1186 determines whether or not adjustment of the display position of the AR content is necessary on the basis of detection results from the position detection unit 1184, it is possible to control the display position of the AR content with appropriate accuracy.

The head mounted display apparatus 1100 is provided with the coupling unit including the camera coupling portion 1061a which couples the camera 1061 to the control unit 1140 in a wired manner and via which a captured image obtained by the camera 1061 is transmitted to the control unit, and the coupling unit is disposed along the connecting portion which connects the camera 1061 to the frame 1002. Thus, it is possible to more reliably transmit an image captured by the camera 1061 to the control unit.

The head mounted display apparatus 1100 may include a wireless transmission unit which transmits a captured image obtained by the camera 1061 to the control unit in a wireless manner, and, in this case, the camera 1061 can be displaced with a higher degree of freedom.

In the third embodiment, a rotational movement of the camera unit 1003 or a relative position between the camera unit 1003 and the frame 1002 is detected by using the first rotational movement sensor 1071 and the second rotational movement sensor 1072, such as rotary encoders, provided at the hinges 1021A and 1023A. The invention is not limited thereto, and a relative position between the frame 1002 and the camera unit 1003 may be detected according to other methods. Specific examples will be described as a fourth embodiment and a fifth embodiment.

### Fourth Embodiment

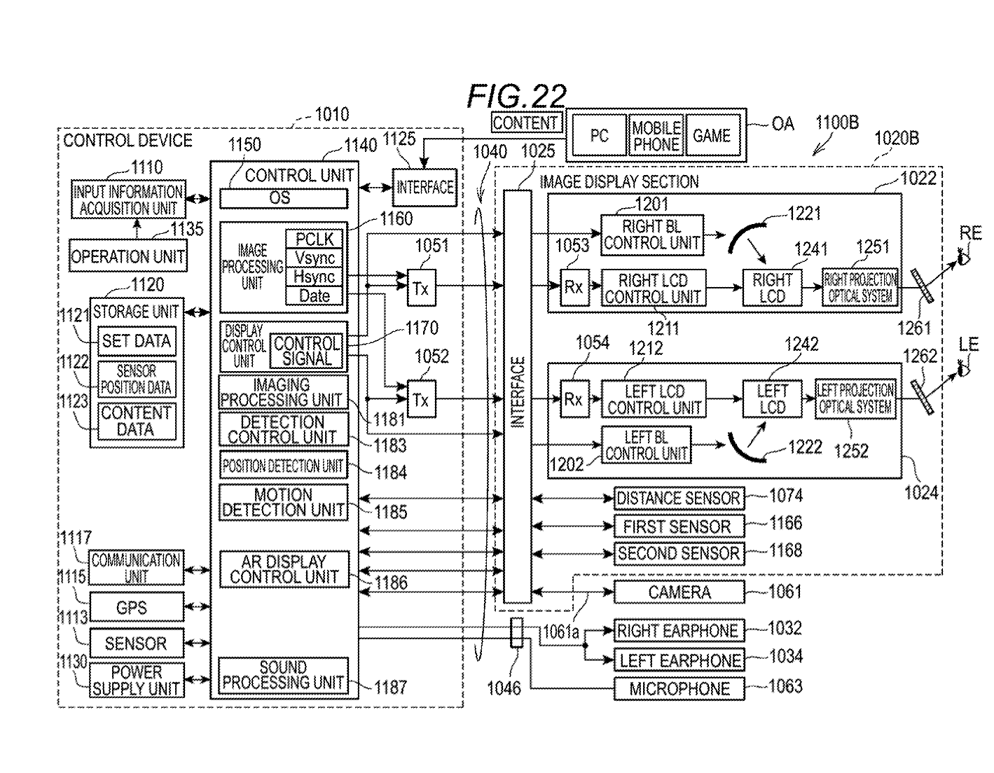

FIG. 22 is a functional block diagram of each unit constituting a head mounted display apparatus 1100B according to the fourth embodiment.

The head mounted display apparatus 1100B of the fourth embodiment includes an image display section 1020B instead of the image display section 1020. The image display section 1020B has a configuration in which a distance sensor 1074 instead of the first rotational movement sensor 1071 and the second rotational movement sensor 1072 of the image display section 1020, and the remaining units have common configurations. Therefore, in the head mounted display apparatus 1100B, constituent elements common to the head mounted display apparatus 1100 of the third embodiment are given the same reference numerals, and illustration and description thereof will be omitted.

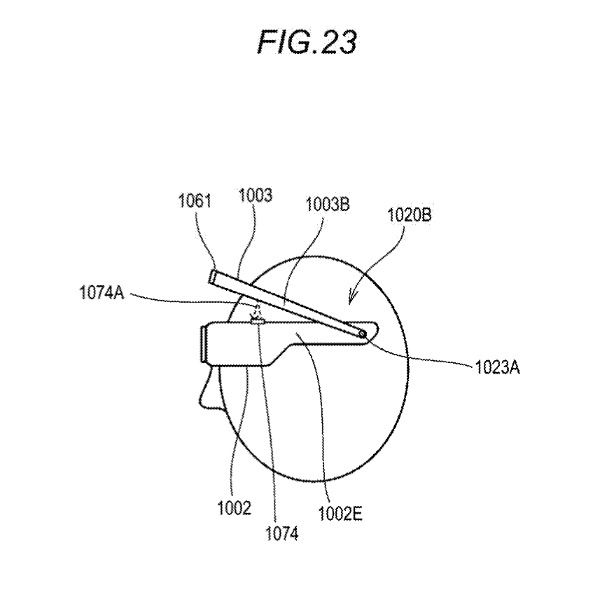

FIG. 23 is a diagram illustrating a schematic configuration of the head mounted display apparatus 1100B of the fourth embodiment, and is a side view illustrating the head mounted display apparatus 1100B.

The distance sensor 1074 (detection unit) is disposed to be directed toward the arm portion 1003B side of the camera unit 1003 at the temple portion 1002E of the frame 1002. The distance sensor 1074 is an electronic discharge meter, and includes, specifically, a light source such as an LED or a laser light source, a light receiving element, and an optical element such as a prism. The distance sensor 1074 emits light from the light source toward the bottom of the arm portion 1003B, and detects reflected light 1074A. The distance sensor 1074 detects a distance between the temple portion 1002E to the arm portion 1003B on the basis of a frequency or a phase difference from emission of light until the reflected light 1074A is received. The position detection unit 1184 of the control unit 1140 acquires a distance detection value in the distance sensor 1074, and obtains an angle between the temple portion 1002E and the arm portion 1003B at the hinge 1023A on the basis of the distance.

Both of the hinges 1021A and 1023A are connecting portions with a low degree of freedom, which can be rotationally moved in one direction, and thus the distance sensor 1074 may be provided at one of the hinges 1021A and 1023A. In the example illustrated in FIG. 23, the distance sensor 1074 is disposed around the hinge 1023A, but may be disposed on the hinge 1021A. A reflective plate which reflects light emitted from the distance sensor 1074 may be provided on the bottom of the arm portion 1003B. The distance sensor 1074 may be provided at the arm portion 1003B, light may be emitted from the arm portion 1003B toward the temple portion 1002E, and reflected light thereof may be detected. The distance sensor 1074 may be provided at the right portion 1002A, the left portion 1002B, or the bridge portion 1002C (FIG. 17). The distance sensor 1074 may be disposed so that a distance between the distance sensor 1074 and the camera unit 1003 or a distance between the distance sensor 1074 and the frame 1002 is changed in a case where the camera unit 1003 is moved.

The head mounted display apparatus 1100B of the fourth embodiment performs the operation described with reference to FIG. 21 in the same manner as the head mounted display apparatus 1100 of the third embodiment. In this case, in step ST12 of FIG. 21, the position detection unit 1184 acquires a detection value of the distance sensor 1074, and obtains angles of the hinges 1021A and 1023A, or a rotational movement amount of the camera unit 1003. Also in the position detection process in step ST20 of FIG. 21, the position detection unit 1184 obtains angles of the hinges 1021A and 1023A, or a rotational movement amount of the camera unit 1003 on the basis of a detection value of the distance sensor 1074.

As mentioned above, in the configuration in which the camera 1061 which can be connected to the frame 1002 so as to be displaced, the first rotational movement sensor 1071 and the second rotational movement sensor 1072 are provided at the hinges 1021A and 1023A, and thus it is possible to correct a display position corresponding to a position of the camera 1061. Also in a configuration of measuring or detecting a distance between a part of the camera unit 1003 and a part of the frame 1002 facing the part of the camera unit 1003 by using the distance sensor 1074, it is possible to correct a display position corresponding to a position of the camera 1061.

### Fifth Embodiment

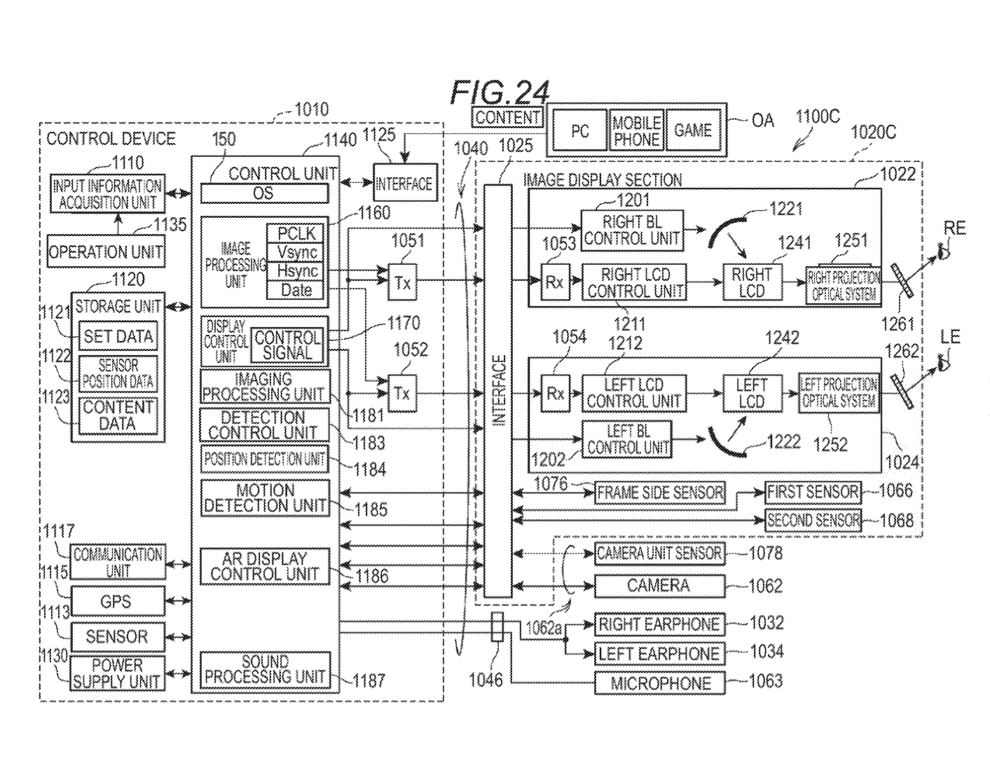

FIG. 24 is a functional block diagram of each unit constituting a head mounted display apparatus 1100C according to the fifth embodiment.

The head mounted display apparatus 1100C of the fifth embodiment includes an image display section 1020C instead of the image display section 1020. Therefore, in the head mounted display apparatus 1100C, constituent elements common to the head mounted display apparatus 1100 of the third embodiment are given the same reference numerals, and illustration and description thereof will be omitted.

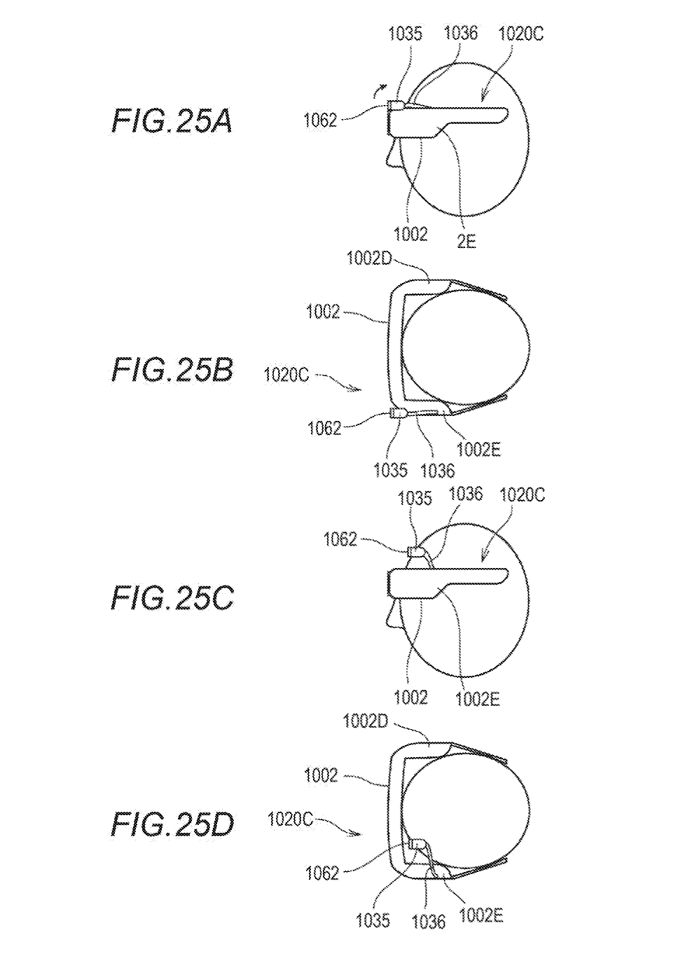

FIGS. 25A to 25D are diagrams illustrating mounting states of the head mounted display apparatus 1100C of the fifth embodiment, in which FIGS. 25A and 25C are side views, and FIGS. 25B and 25D are plan views.

The image display section 1020C has a configuration in which a camera 1062 is connected to the image display section 1020 having the frame 1002 via a flexible arm 1036 (connecting portion). The flexible arm 1036 is a metallic or synthetic resin arm which can be freely bent, and a basal end of the flexible arm 1036 is fixed to the temple portion 1002E. A camera case 1035 accommodating the camera 1062 is attached to a distal end of the flexible arm 1036.

For example, as illustrated in FIGS. 25A and 25B, the camera 1062 may be used so that the camera 1062 is disposed at a position close to the frame 1002 and thus an imaging region of the camera 1062 becomes close to a visual field of the user wearing the image display section 1020C. As illustrated in FIG. 25C, the image display section 1020C may be used by moving the camera case 1035 upward. In this case, as illustrated in FIG. 25D, the camera case 1035 may be moved in the right and left directions with respect to the user. In the example illustrated in FIG. 25D, the camera case 1035 is located inside the temple portion 1002D and the temple portion 1002E. At this position, an imaging region of the camera 1062 extends over both of a visual field of the right eye and a visual field of a left eye of the user.

As illustrated in FIG. 24, in the head mounted display apparatus 1100C, the image display section 1020C includes a frame side sensor 1076 and a camera unit sensor 1078.

The frame side sensor 1076 and the camera unit sensor 1078 are motion sensors, and are, for example, acceleration sensors or angular velocity sensors (gyro sensors). The flexible arm 1036 can move the camera case 1035 in a three-dimensional manner, and thus the frame side sensor 1076 and the camera unit sensor 1078 are preferably three-axis sensors. The frame side sensor 1076 and the camera unit sensor 1078 are respectively complex sensors which are configured to include three-axis acceleration sensors and three-axis gyro sensors. The frame side sensor 1076 and the camera unit sensor 1078 may include magnetic sensors or the like.

The frame side sensor 1076 is provided at the frame 1002, and outputs a detection value regarding a motion of the frame 1002. The frame side sensor 1076 may be fixed to the frame 1002, and a position of the frame side sensor 1076 at the frame 1002 is not limited. In a case where the frame 1002 has a portion which can be displaced, the frame side sensor 1076 may be provided at the portion which is displaced along with the flexible arm 1036. For example, in a case where the temple portion 1002E is configured to be rotatably moved with respect to the left portion 1002B at the frame 1002, the frame side sensor 1076 is preferably provided at the temple portion 1002E to which the flexible arm 1036 is fixed. In other words, the frame side sensor 1076 is preferably disposed so that a relative position with the flexible arm 1036 is not changed.

The camera unit sensor 1078 is provided at the camera case 1035 and outputs a detection value regarding a motion of the camera 1062. The camera unit sensor 1078 is attached to or built into the camera case 1035 so that a relative position with the camera 1062 is not changed.

The camera 1062 and the camera unit sensor 1078 are coupled to the interface 1025 via a camera coupling portion 1062a. The camera coupling portion 1062a is a cable which is disposed, for example, through a hollow portion inside the flexible arm 1036 or along an outer surface of the flexible arm 1036. The camera coupling portion 1062a is coupled to the interface 1025 disposed inside the frame 1002, in a wired manner. The camera coupling portion 1062a constitutes a coupling unit which couples the camera 1062 to the control unit 1140 along with the coupling unit 1040 and the interface 1025.

The camera coupling portion 1062a may be replaced with a wireless communication line. In this case, there may be a configuration in which a wireless communication unit coupled to the camera 1062 and the camera unit sensor 1078 is provided in the camera case 1035, a wireless communication unit is provided in the frame 1002, and the wireless communication units transmit and receive captured image data, data regarding a detection value of the sensor, and control data in a wireless manner such as WiFi. The wireless communication unit in the camera case 1035 may perform communication with the communication unit 1117.

In the same manner as the camera 1061, the camera 1062 (imaging unit) is a digital camera including an imaging element such as a CCD or a CMOS, and an imaging lens, and may be a monocular camera and may be a stereo camera. The camera 1062 images at least a part of external scenery in the surface side of the head mounted display apparatus 1100C, that is, in a visual field direction of the user in a state in which the user wears the image display section 1020C, at the reference location illustrated in FIGS. 25A and 25B. An imaging region of the camera 1062 may be set as appropriate, but an imaging region of the camera 1061 preferably includes the external world which is visually recognized by the user through the right optical image display unit 1026 and the left optical image display unit 1028 at the reference location, for example. More preferably, an imaging region of the camera 1062 is set to image the entire visual field of the user through the dimming plates 1020A. The camera 1062 performs imaging under the control of an imaging processing unit 1181 included in the control unit 1140, and outputs captured image data to the imaging processing unit 1181.

The position detection unit 1184 of the control unit 1140 detects a motion of the camera case 1035 on the basis of a detection value of the camera unit sensor 1078. It is possible to obtain a displacement amount and a displacement direction in which the camera 1062 is displaced from the reference location by integrating the motion of the camera case 1035 in a three-dimensional manner. The position detection unit 1184 can obtain a position of the camera 1062 and an imaging direction of the camera 1062.

Here, the motion detected by the camera unit sensor 1078 includes all motion components of the image display section 1020C. Therefore, the position detection unit 1184 detects a motion of the image display section 1020C on the basis of the detection value of the frame side sensor 1076, and obtains a difference between the motion of the image display section 1020C and a motion of the camera case 1035 detected by the camera unit sensor 1078. The difference corresponds to displacement of the camera case 1035 with respect to the frame 1002. As mentioned above, the position detection unit 1184 can detect displacement of the camera 1062 relative to the frame 1002 by removing an influence of displacement of the entire image display section 1020C.

If the user wearing the image display section 1020C does not move the frame 1002 and the head on which the frame 1002 is mounted while moving the camera case 1035, it is possible to accurately detect displacement of the camera 1062 on the basis of a detection value of the camera unit sensor 1078.

The head mounted display apparatus 1100C of the fifth embodiment performs the operation described with reference to FIG. 21 in the same manner as the head mounted display apparatus 1100 of the third embodiment.

In this case, the position detection unit 1184 acquires detection values of the frame side sensor 1076 and the camera unit sensor 1078 at all times. The camera case 1035 is preferably located at the reference location illustrated in FIGS. 25A and 25B or other reference locations at the time when the position detection unit 1184 starts to acquire the detection values. For this reason, the head mounted display apparatus 1100C may perform a notification or a guide so that the camera case 1035 is disposed at the reference location before the position detection unit 1184 starts to acquire the detection values.

The position detection unit 1184 acquires detection values of the frame side sensor 1076 and the camera unit sensor 1078 at all times so as to obtain a position of the camera case 1035 relative to the frame 1002. The position detection unit 1184 may determine whether or not the position of the camera case 1035 relative to the frame 1002 is deviated from a normal range. In a case where the position is deviated from the normal range, a notification may be performed in the same manner as in step ST14 of FIG. 21.

In step ST21 of FIG. 21, the AR display control unit 1186 may determine whether or not correction of a position is to be performed on the basis of the position of the camera case 1035 which is detected by the position detection unit 1184 at all times.

As mentioned above, also in the configuration in which the camera 1062 is connected to the frame 1002 so as to be freely displaced via the flexible arm 1036, displacement of the camera 1062 relative to the frame 1002 can be detected, and a display position can be corrected so as to match an amount of the detected displacement or a direction of the displacement.

### Sixth Embodiment

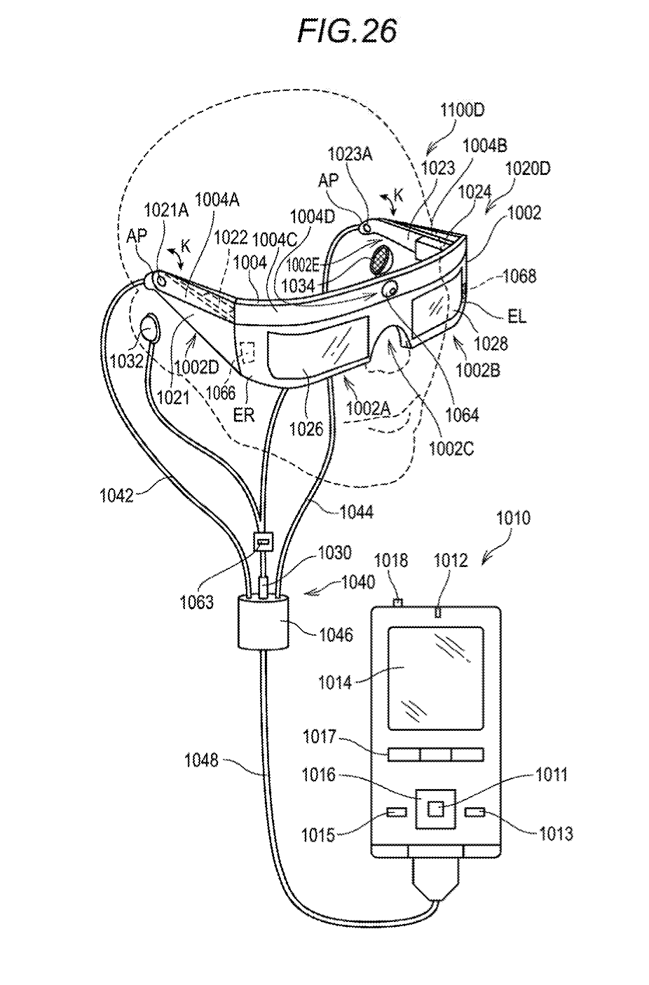

FIG. 26 is a diagram illustrating an exterior configuration of a head mounted display apparatus 1100D according to the sixth embodiment.

The head mounted display apparatus 1100D of the sixth embodiment has a configuration in which the image display section 1020 of the head mounted display apparatus 1100 of the third embodiment is replaced with a image display section 1020D (display unit) which enables a user to visually recognize a virtual image in a state of being mounted on the head of the user. The image display section 1020D is coupled to the control device 1010 described in each of the third to fifth embodiments.

The image display section 1020D has a configuration in which a camera unit 1004 is provided at the frame 1002. In the same manner as the camera unit 1003, the camera unit 1004 is connected to the frame 1002 so as to be rotationally moved via the hinges 1021A and 1023A, can be rotationally moved vertically with respect to the frame 1002, and comes into contact with the frame 1002 at a lower end position of a rotational movement range.

The camera unit 1004 includes arm portions 1004A and 1004B corresponding to the arm portions 1003A and 1003B. The arm portions 1004A and 1004B are located on the temporal regions of the user, and are connected to the frame 1002 via the hinges 1021A and 1023A.

A camera pedestal portion 1004C is a plate-like or rod-like member located on upper parts of the right portion 1002A, the left portion 1002B, and the bridge portion 1002C, and a camera 1064 is provided in an embedded manner at a position corresponding to the upper part of the bridge portion 1002C.

In the same manner as the camera 1061, the camera 1064 (imaging unit) is a digital camera including an imaging element such as a CCD or a CMOS, and an imaging lens, and may be a monocular camera and may be a stereo camera.

The camera 1064 has a spherical case. The camera 1064 is embedded in a camera joint portion 1004D formed at the center of the camera pedestal portion 1004C. The camera joint portion 1004D has a spherical recess, and the case of the camera 1064 is joined to the camera joint portion 1004D via a ball joint. For this reason, the camera 1064 can be rotationally moved in any directions including the upper, lower, right, and left directions in a mounting state of the head mounted display apparatus 1100D. A range in which the camera 1064 is rotationally moved is restricted in the camera joint portion 1004D, and the camera 1064 can be rotationally moved, for example, in a range in which an imaging lens exposed to the case of the camera 1064 does not enter the recess of the camera joint portion 1004D.

The camera 1064 may be directed in a direction in which an optical axis of the camera 1064 overlaps or is parallel to a visual line direction in which the user visually recognizes external scenery through the image display section 1020D. In this state, regarding an imaging region of the camera 1064, in the same manner as the camera 1061, the camera 1064 images at least a part of external scenery in the surface side of the head mounted display apparatus 1100, that is, in a visual field direction of the user in a state in which the user wears the image display section 1020D. An imaging region (angle of view) of the camera 1064 may be set as appropriate, but an imaging region of the camera 1064 preferably includes the external world which is visually recognized by the user through the right optical image display unit 1026 and the left optical image display unit 1028 at the lower end of the rotatable movement range of the camera unit 1004, for example. More preferably, an imaging region of the camera 1064 is set to image the entire visual field of the user through the dimming plates 1020A.

The camera 1064 may be a wide angle lens such as a fish-eye lens. Specifically, a visual line direction of the user may be included in the imaging region of the camera 1064 in a state in which the camera 1064 is located at an end of a rotationally moved range in the camera joint portion 1004D.

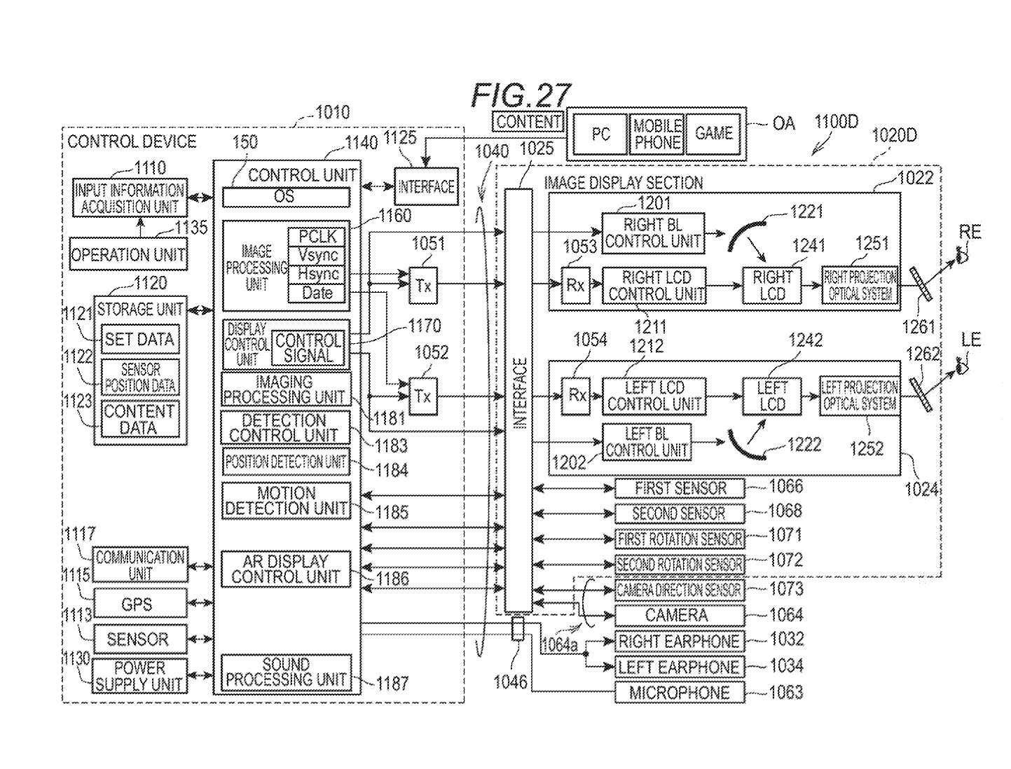

The camera 1064 performs imaging under the control of an imaging processing unit 1181 (FIG. 27) included in the control unit 1140, and outputs captured image data to the imaging processing unit 1181.

FIG. 27 is a functional block diagram of each unit constituting the head mounted display apparatus 1100D.

In the head mounted display apparatus 1100D, the control unit 1140 of the control device 1010 is coupled to the camera 1064 and a camera direction sensor 1073. The camera direction sensor 1073 is provided toward the camera joint portion 1004D inside the camera joint portion 1004D illustrated in FIG. 26 or inside the camera pedestal portion 1004C. The camera direction sensor 1073 detects an optical axis direction or a change in the optical axis direction of the camera 1064 and outputs a detection value to the control unit 1140. The camera direction sensor 1073 may, for example, optically detect a motion of the case of the camera 1064 by using an optical sensor, or may detect a motion of the case of the camera 1064 by using a magnetic sensor. There may be a configuration in which a conductor is provided at the case of the camera 1064, the camera direction sensor 1073 is provided with an electrode which comes into contact with the case of the camera 1064, and the camera direction sensor 1073 electrically detects a motion of the case of the camera 1064.

The image display section 1020D includes the first rotational movement sensor 1071 and the second rotational movement sensor 1072 in the same manner as the image display section 1020 of the third embodiment. The position detection unit 1184 detects rotational movement amounts or an angle formed between the frame 1002 and the camera unit 1004 at the hinges 1021A and 1023A on the basis of detection values of the first rotational movement sensor 1071 and the second rotational movement sensor 1072. The position detection unit 1184 detects a direction of an optical axis of the camera 1064 on the basis of the detection value of the camera direction sensor 1073. The control unit 1140 performs the operation illustrated in FIG. 21 so as to correct a display position of the AR content.

The camera 1064 and the camera direction sensor 1073 are coupled to the interface 1025 via a camera coupling portion 1064a. The camera coupling portion 1064a is a cable disposed, for example, through the insides of the camera pedestal portion 1004C, and the arm portions 1004A and 1004B, or along outer surfaces thereof. The camera coupling portion 1064a is coupled to the interface 1025 disposed inside the frame 1002 in a wired manner. The camera coupling portion 1064a constitutes a coupling unit which couples the camera 1064 to the control unit 1140 along with the coupling unit 1040 and the interface 1025.

The camera coupling portion 1064a may be replaced with a wireless communication line. In this case, there may be a configuration in which a wireless communication unit coupled to the camera 1064 and the camera direction sensor 1073 is provided on the camera 1064 side, a wireless communication unit is provided in the frame 1002, and the wireless communication units transmit and receive captured image data, data regarding a detection value of the sensor, and control data in a wireless manner such as WiFi. The wireless communication unit on the camera 1064 side may perform communication with the communication unit 1117.

According to the head mounted display apparatus 1100D of the sixth embodiment, the optical axis of the camera 1064 can be directed in directions including the upper, lower, right, and left directions, and an imaging direction of the camera 1064 can be specified so as to match a vertical rotational movement of the camera pedestal portion 1004C supporting the camera 1064. For this reason, it is possible to accurately correct a display position of the AR content on the basis of a relative position between a visual line direction of the user, an optical axis direction of the camera 1064, and the display position of the AR content. Therefore, also in the configuration illustrated in FIGS. 26 and 27, it is possible to achieve the same effect as in the third to fifth embodiments. Since a range of the optical axis of the camera 1064 being displaced is wide, there is an advantage in that a region which cannot be directly viewed by the user can be imaged by the camera 1064.

### Seventh Embodiment

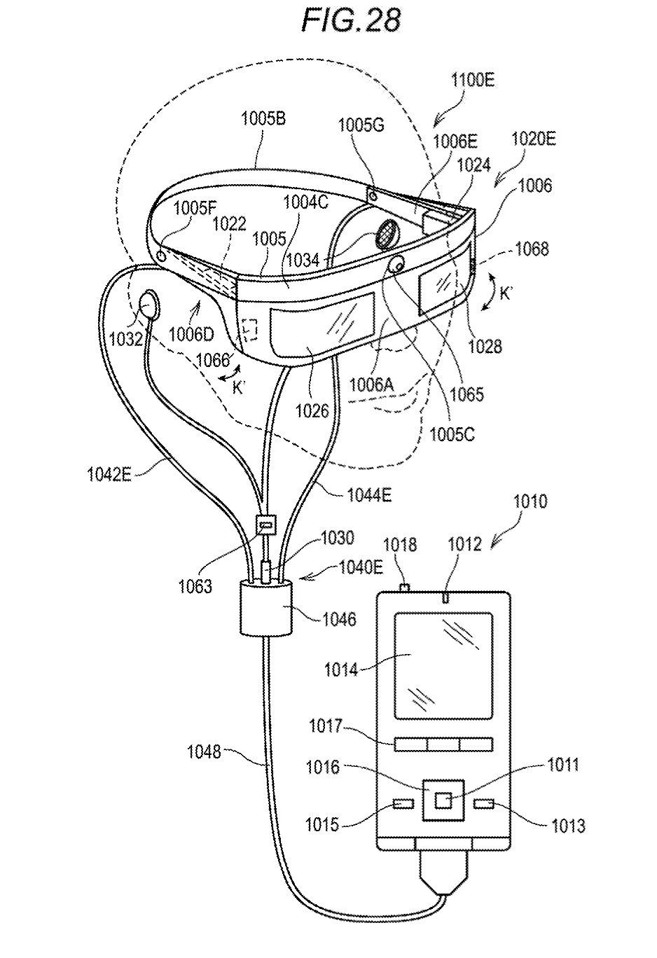

FIG. 28 is a diagram illustrating an exterior configuration of a head mounted display apparatus 1100E according to a seventh embodiment to which the invention is applied.

The head mounted display apparatus 1100E of the seventh embodiment has a configuration in which the image display section 1020 of the head mounted display apparatus 1100 of the third embodiment is replaced with a image display section 1020E (display unit) which enables a user to visually recognize a virtual image in a state of being mounted on the head of the user. The image display section 1020E is coupled to the control device 1010 described in each of the third to sixth embodiments.

The image display section 1020E is a mounting body which is mounted on the head of the user, includes a head held unit 1005 which is mounted on and fixed to the head of the user, and a display section frame 1006 which is connected to the head held unit 1005, and has a spectacle shape as a whole.

The head held unit 1005 is fixed to the head of the user, and the display section frame 1006 is connected to the head held unit 1005 so as to be rotationally moved. The head held unit 1005 includes a camera 1065 (imaging unit) which will be described later, and the display section frame 1006 includes a constituent element displaying an image.

The head held unit 1005 includes a camera pedestal portion 1005A located in front of the face of the user, and a band portion 1005B connected to the camera pedestal portion 1005A. The band portion 1005B is a belt-like member which comes into contact with the temporal region to the back of the head of the user, and supports the head held unit 1005 on the head of the user.

The head held unit 1005 includes hinges 1005F and 1005G and the display section frame 1006 is connected thereto so as to be rotationally moved via the hinges 1005F and 1005G.

The display section frame 1006 is provided with the right display driving unit 1022, the left display driving unit 1024, the right optical image display unit 1026, the left optical image display unit 1028, and the microphone 1063.

The display section frame 1006 includes a display unit 1006A which is located over the front side of the right eye and the front side of the left eye of the user. Arm portions 1006D and 1006E which extend over positions corresponding to the temporal regions of the user when the user wears the image display section 1020E are coupled to both left and right ends of the display unit 1006A. The arm portions 1006D and 1006E are connected to the head held unit 1005 so as to be rotationally moved via the hinges 1005F and 1005G, respectively. Consequently, the display section frame 1006 can be rotationally moved so that the display unit 1006A is vertically moved as indicated by an arrow K′ in FIG. 28.

In the display unit 1006A, the right optical image display unit 1026 is disposed in front of the right eye of the user, and the left optical image display unit 1028 is disposed in front of the left eye of the user. The right optical image display unit 1026 and the left optical image display unit 1028 display an image along with the right display driving unit 1022, the left display driving unit 1024, the LCDs 1241 and 1242, and the projection optical systems 1251 and 1252 provided in the display section frame 1006.

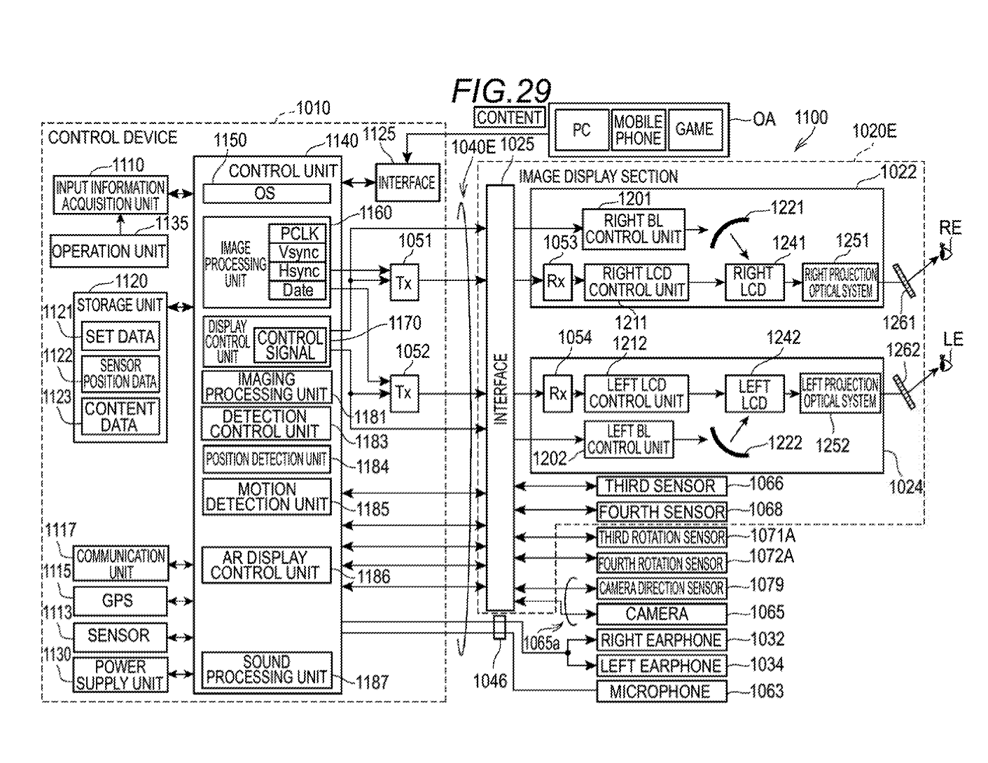

A third rotational movement sensor 1071A (FIG. 29) which will be described later is provided at the hinge 1005F, and a fourth rotational movement sensor 1072A (FIG. 29) which will be described later is provided at the hinge 1005G The third rotational movement sensor 1071A and the fourth rotational movement sensor 1072A function as a detection unit, and detect rotational movement positions or actions of rotational movements of the hinges 1005F and 1005E The third rotational movement sensor 1071A and the fourth rotational movement sensor 1072A may be constituted of, for example, rotary encoders. Specifically, there may be a configuration in which the third rotational movement sensor 1071A and the fourth rotational movement sensor 1072A include optical sensors each of which is provided with a light emitting portion and a light receiving portion, and light blocking plates which are operated according to rotational movements centering on the hinges 1005F and 1005G, and detect light transmitted through slits of the light blocking plates. In this case, the third rotational movement sensor 1071A can detect an operation in which an angle between the head held unit 1005 and the arm portion 1006D at the hinge 1005F is increased, and an angle therebetween is reduced, and can count an operation amount. The fourth rotational movement sensor 1072A performs the same detection for the hinge 1005G The third rotational movement sensor 1071A and the fourth rotational movement sensor 1072A may respectively detect an angle between the head held unit 1005 and the arm portion 1006D at the hinge 1005F and an angle between the head held unit 1005 and the arm portion 1006E at the hinge 1005G by using a variable resistor or a magnetic sensor. In the present embodiment, the third rotational movement sensor 1071A and the fourth rotational movement sensor 1072A are constituted of rotary encoders which perform optical detection. If the arm portion 1006D is rotationally moved with respect to the head held unit 1005 at the hinge 1005F, the third rotational movement sensor 1071A outputs a pulse whenever a rotational movement is performed with a predetermined angle. If the arm portion 1006E is rotationally moved with respect to the head held unit 1005 at the hinge 1005G the fourth rotational movement sensor 1072A outputs a pulse whenever a rotational movement is performed with a predetermined angle. The third rotational movement sensor 1071A and the fourth rotational movement sensor 1072A may output a signal indicating a rotational movement direction.

The image display section 1020E is connected to the control device 1010 via a coupling unit 1040E. The coupling unit 1040E is constituted of a cable via which control data, video data, audio data, and the like are transmitted in the same manner as the coupling unit 1040 (FIG. 17). The coupling unit 1040E includes a right cord 1042E and a left cord 1044E coupled to the head held unit 1005. The right cord 1042E and the left cord 1044E are coupled to the head held unit 1005, and then reach the inside of the display section frame 1006 through the inside of the head held unit 1005. Consequently, each unit of the head held unit 1005 and each unit of the display section frame 1006 are coupled to the control device 1010.

With this configuration, the image display section 1020E displays an image on the display section frame 1006 under the control of the control device 1010 so that the user can visually recognize the image. The image display section 1020E is a see-through display section through which external scenery can be visually recognized.

The display section frame 1006 can be rotationally moved downward, for example, by the user pressing the display unit 1006A with the user's hand. For this reason, the user can directly visually recognize external scenery by moving the display unit 1006A downward. As described above, the user can view an image displayed on the image display section 1020E by locating the display unit 1006A in front of the eyes.

In the same manner as the camera 1061, the camera 1065 is a digital camera including an imaging element such as a CCD or a CMOS, and an imaging lens, and may be a monocular camera and may be a stereo camera. The camera 1065 has a spherical case. The camera 1065 is embedded in a camera joint portion 1005C formed at the center of the camera pedestal portion 1005A. The camera joint portion 1005C has a spherical recess, and the case of the camera 1065 is joined to the camera joint portion 1005C via a ball joint. For this reason, the camera 1065 can be rotationally moved in any directions including the upper, lower, right, and left directions in a mounting state of the head mounted display apparatus 1100E. A range in which the camera 1065 is rotationally moved is restricted in the camera joint portion 1005C, and the camera 1065 can be rotationally moved, for example, in a range in which an imaging lens exposed to the case of the camera 1065 does not enter the recess of the camera joint portion 1005C.

The camera 1065 may be directed in a direction in which an optical axis of the camera 1065 overlaps or is parallel to a visual line direction in which the user visually recognizes external scenery through the image display section 1020E. In this state, regarding an imaging region of the camera 1065, in the same manner as the camera 1061, the camera 1065 images at least a part of external scenery in the surface side of the head mounted display apparatus 1100, that is, in a visual field direction of the user in a state in which the user wears the image display section 1020E. An imaging region (angle of view) of the camera 1065 may be set as appropriate, but an imaging region of the camera 1065 preferably includes the external world which is visually recognized by the user through the right optical image display unit 1026 and the left optical image display unit 1028 at the lower end of the rotatable movement range of the camera unit 1004, for example. More preferably, an imaging region of the camera 1065 is set to image the entire visual field of the user through the dimming plates 1020A.

The camera 1065 may be a wide angle lens such as a fish-eye lens. Specifically, a visual line direction of the user may be included in the imaging region of the camera 1065 in a state in which the camera 1065 is located at an end of a rotationally moved range in the camera joint portion 1005C.

The camera 1065 performs imaging under the control of an imaging processing unit 1181 (FIG. 29) included in the control unit 1140, and outputs captured image data to the imaging processing unit 1181.

FIG. 29 is a functional block diagram of each unit constituting the head mounted display apparatus 1100E.

In the head mounted display apparatus 1100E, the control unit 1140 of the control device 1010 is coupled to the camera 1065 and a camera direction sensor 1079. The camera direction sensor 1079 is provided toward the camera joint portion 1005C inside the camera joint portion 1005C illustrated in FIG. 28 or inside the camera pedestal portion 1005A. The camera direction sensor 1079 detects an optical axis direction or a change in the optical axis direction of the camera 1065 and outputs a detection value to the control unit 1140. The camera direction sensor 1079 may, for example, optically detect a motion of the case of the camera 1065 by using an optical sensor, or may detect a motion of the case of the camera 1065 by using a magnetic sensor. There may be a configuration in which a conductor is provided at the case of the camera 1065, the camera direction sensor 1079 is provided with an electrode which comes into contact with the case of the camera 1065, and the camera direction sensor 1079 electrically detects a motion of the case of the camera 1065.

The camera 1065 and the camera direction sensor 1079 are coupled to the interface 1025 via a camera coupling portion 1065a. The camera coupling portion 1065a is a cable disposed, for example, through the insides of the camera pedestal portion 1004C, and the arm portion 1006D or 1006E, or along outer surfaces thereof. The camera coupling portion 1065a is coupled to the interface 1025 disposed inside the display section frame 1006 in a wired manner. The camera coupling portion 1065a constitutes a coupling unit which couples the camera 1065 to the control unit 1140 along with the coupling unit 1040E and the interface 1025.

The camera coupling portion 1065a may be replaced with a wireless communication line. In this case, there may be a configuration in which a wireless communication unit coupled to the camera 1065 and the camera direction sensor 1079 is provided on the camera 1065 side, a wireless communication unit is provided in the display section frame 1006, and the wireless communication units transmit and receive captured image data, data regarding a detection value of the sensor, and control data in a wireless manner such as WiFi. The wireless communication unit on the camera 1065 side may perform communication with the communication unit 1117.

The image display section 1020E includes the third rotational movement sensor 1071A which is provided at the hinge 1005F, and the fourth rotational movement sensor 1072A which is provided at the hinge 1005E The position detection unit 1184 detects rotational movement amounts or angles formed between the head held unit 1005 and the arm portions 1006D and 1006E at the hinges 1005F and 1005G on the basis of detection values of the third rotational movement sensor 1071A and the fourth rotational movement sensor 1072A. The position detection unit 1184 detects a direction of an optical axis of the camera 1065 on the basis of the detection value of the camera direction sensor 1079. The control unit 1140 performs the operation illustrated in FIG. 21 so as to correct a display position of the AR content.

According to the head mounted display apparatus 1100E of the seventh embodiment, the optical axis of the camera 1065 can be directed in directions including the upper, lower, right, and left directions, and an imaging direction of the camera 1065 can be specified so as to match a vertical rotational movement of the camera pedestal portion 1005A supporting the camera 1065. For this reason, it is possible to accurately correct a display position of the AR content on the basis of a relative position between a visual line direction of the user, an optical axis direction of the camera 1065, and the display position of the AR content. Therefore, also in the configuration illustrated in FIGS. 28 and 29, it is possible to achieve the same effect as in the third to sixth embodiments. Since a range of the optical axis of the camera 1065 being displaced is wide, there is an advantage in that a region which cannot be directly viewed by the user can be imaged by the camera 1065.

In the head mounted display apparatus 1100E, it is possible to displace positions of the right optical image display unit 1026 and the left optical image display unit 1028 with respect to the eyes of the user by rotationally moving the display section frame 1006 of the image display section 1020E downward. For this reason, the user can view external scenery. In this configuration, the position detection unit 1184 detects rotational movement amounts or an angle formed between the head held unit 1005 and the display section frame 1006 at the hinges 1005F and 1005G. Consequently, it is possible to appropriately adjust a display position of the AR content even if a relative position of the display section frame 1006 relative to the head held unit 1005.

In the configurations related to the fourth to seventh embodiments, the head mounted display apparatuses 1100B, 1100C, 1100D and 1100E can perform head tracking by using the motion detection unit 1185 in the same manner as the head mounted display apparatus 1100. The processes illustrated in FIGS. 10, 11 and 13 described in the first embodiment can be performed on the basis of a result of the head tracking.

The third to seventh embodiments are only examples of specific embodiments of the invention. The invention is not limited to the above-described configurations and can be implemented in various aspects within the scope without departing from the spirit thereof.

In the above-described embodiments, the image display sections 1020, 1020B and 1020C including the frame 1002 having a spectacle shape have been described, but the frame 1002 may be built into a body protection tool such as a cap or a helmet. The camera unit 1003 may be configured to be integrally provided in the frame 1002. The camera unit 1003 may be configured to be connected to the frame 1002 via members other than the hinges 1021A and 1023A so as to be moved with a higher degree of freedom.

For example, in the third to seventh embodiments, a description has been made of an example in which a relative position or a change in the relative position of the imaging unit is detected by using one or two motion sensors as the detection unit, but three or more sensors may be used.

A description has been made of a configuration in which the single camera 1061 or 1062 is provided as the imaging unit, but a plurality of imaging units may be provided. In this case, in the plurality of imaging units, mutual relative positions may not be changed, and each imaging unit may be displaced separately with respect to the frame 1002. A plurality of imaging units may be provided at a single portion of the frame 1002 or the camera unit 1003. A plurality of imaging units may be provided at each of a plurality of portions of the frame 1002 or the camera unit 1003. In this case, the position detection unit 1184 may detect displacement or a displacement amount in relation to at least one imaging unit according to the content which is set in advance. The AR display control unit 1186 may correct a display position so as to a position of one imaging unit which is selected in advance, and may correct a display position on the basis of a result of averaging or combining positions of both imaging units.

In the above-described embodiments, in the head mounted display apparatuses 1100, 1100B and 1100C, a description has been made of a configuration in which the image display sections 1020, 1020B, and 1020C and the control device 1010 are provided separately from each other, and are coupled to each other via the coupling unit 1040. The invention is not limited thereto, and the control device 1010 may be configured integrally with the image display sections 1020, 1020B, and 1020C. In the head mounted display apparatuses 1100, 1100B and 1100C, at least the image display sections 1020, 1020B, and 1020C performing display are preferably mounted on the head of a user (a worker or a commander). A mounting state of the control device 1010 is not limited. For this reason, as the control device 1010, a notebook computer, a tablet computer, or a desktop computer may be used. As the control device 1010, a portable electronic device such as a game machine, a mobile phone, a smart phone, or a portable media player, or other dedicated devices may be used. There may be a configuration in which the control device 1010 is provided separately from the image display sections 1020, 1020B, and 1020C, and various signals are transmitted and received between the control device 1010 and the image display sections 1020, 1020B, and 1020C via wireless communication.

For example, in order to generate image light, the image display section 1020 may be configured to include an organic electroluminescence (EL) display and an organic EL controller. As a configuration of generating image light, liquid crystal on silicon (LCOS; LCoS is a registered trademark), a digital micromirror device, or the like may be used.

Optical elements guiding image light to the eyes of the user are not limited to the right light guide plate 1261 and the left light guide plate 1262. In other words, the optical elements may be optical elements through which external light incident to the apparatus from the outside is transmitted and which allows the external light to be incident to the eyes of the user along with image light. For example, an optical element which is located in front of the eyes of the user and partially or entirely overlaps a visual field of the user may be used. A scanning type optical element which performs scanning with laser light and uses the laser light as image light may be employed. An optical element is not limited to a configuration in which image light is guided inside an optical element, and may have only a function of guiding image light to the eyes of the user by refracting and/or reflecting the image light. An optical element of the invention may use a diffraction grating, a prism, or a holography display portion.

For example, the invention is applicable to a laser retinal projective head mounted display. In other words, there may be a configuration in which a light emitting unit includes a laser light source and an optical system guiding laser light to the eyes of the user, and the retinae are scanned with laser light incident to the eyes of the user so that an image is formed on the retinae, and thus the user visually recognizes the image.

The invention is also applicable to a display apparatus which employs a scanning optical system using a MEMS mirror and uses a MEMS display technique. In other words, the light emitting unit may be provided with a signal light forming unit, a scanning optical system including a MEMS mirror which performs scanning with light emitted by the signal light forming unit, and an optical member which forms a virtual image by using the light with which scanning is performed by the scanning optical system. In this configuration, the light which is emitted by the signal light forming unit is reflected by the MEMS mirror and is incident to the optical member, and the light is guided inside the optical member and reaches a virtual image formation surface. If the MEMS mirror performs scanning with the light, a virtual image is formed on the virtual image forming surface, and an image is recognized by identifying the virtual image with the user's eye. An optical component in this case may guide light through a plurality of number of times of reflection, such as the right light guide plate 1261 and the left light guide plate 1262 of the embodiments, and may employ a half mirror surface.

At least some of the respective functional blocks illustrated in FIGS. 19, 22 and 24 may be realized by hardware, may be realized in cooperation between hardware and software, and arrangement of hardware sources is not limited to the block diagrams. The program executed by the control unit 1140 may be stored in the storage unit 1120 or a storage unit of the control device 1010. The program stored in an external device may be acquired via the communication unit 1117 or the interface 1125 and may be executed. A constituent element provided in the control device 1010 may also be provided in the image display sections 1020, 1020B and 1020C. For example, the control unit 1140 illustrated in FIGS. 20A and 20B and 22 may be provided in the image display section 1020, 1020B, or 1020C, and, in this case, the control unit 1140 and the control unit of the image display section 1020, 1020B, or 1020C may share a function.

The entire disclosure of Japanese Patent Application No.: 2014-253100, filed Dec. 15, 2014 and 2015-038654, filed Feb. 27, 2015 and 2015-218180, filed Nov. 6, 2015 are expressly incorporated by reference herein.

What is claimed is:

1. A head mounted display apparatus mounted on the head of a user, the display apparatus comprising:
a display unit that irradiates the eyes of the user with image light; and
a plurality of motion sensors that are disposed at positions deviated relative to the user's body in a mounting state of the display apparatus.

2. The display apparatus according to claim 1,
wherein one of the motion sensors is located on one side of the center of the head, and the other motion sensor is located on the other side of the center of the head, in the mounting state.

3. The display apparatus according to claim 2,
wherein one of the motion sensors is located on the left side of the center of the head, and the other motion sensor is located on the right side of the center of the head, in the mounting state.

4. The display apparatus according to claim 1,
wherein, in the mounting state of the display apparatus, one of the motion sensors is located on one side of a movable portion serving as the center of a motion of the head of the user, and the other motion sensor is located on the other side of the movable portion.

5. The display apparatus according to claim 4,
wherein the movable portion is a location which is set assuming a neck joint of the user.

6. The display apparatus according to claim 4,
wherein the plurality of motion sensors are disposed so that a distance between one of the motion sensors and the movable portion is different from a distance between the other motion sensor and the movable portion in the mounting state of the display apparatus.

7. The display apparatus according to claim 1,
wherein the display unit includes an optical element having a display region which emits image light toward the eyes of the user, and
wherein the plurality of motion sensors and a central position of the display region of the optical element are linearly arranged.

8. The display apparatus according to claim 1,
wherein the plurality of motion sensors include at least an optical sensor and an inertial sensor.

9. The display apparatus according to claim 1, further comprising:
a motion detection unit that obtains a motion at the center of the motion in relation to the motion of the user on the basis of detection values of the plurality of motion sensors.

10. The display apparatus according to claim 9,
wherein the motion detection unit obtains a motion at the center of the motion on the basis of each of the detection values of the plurality of motion sensors and a position of the motion sensor.

11. The display apparatus according to claim 9, further comprising:
an imaging unit that images an imaging region which includes at least a part of a visual field of the user,
wherein the motion detection unit specifies a position of the center of a motion of the user on the basis of detection values of the plurality of motion sensors, and obtains a relative position between the imaging region of the imaging unit and a visual field of the user on the basis of the specified position of the center of the motion.

12. The display apparatus according to claim 9,
wherein the motion detection unit determines whether or not the motion at the center of the motion is a motion based on a cognitive action of the user, and corrects a captured image obtained by the imaging unit in a case where it is determined that the motion is not a motion based on the cognitive action of the user.

13. The display apparatus according to claim 9,
wherein the motion detection unit
specifies a position of the center of the motion of the user on the basis of the detection values of the plurality of motion sensors,
estimates positions of the eyes of the user on the basis of the specified position of the center of the motion,
specifies a position of the display unit on the basis of a position of the motion sensor, and
obtains a relative position between the display unit and the positions of the eyes of the user on the basis of the specified position of the display unit and the estimated positions of the eyes of the user.

14. The display apparatus according to claim 1, further comprising:
a display unit main body that is mounted on the head of the user and includes the display unit;
an imaging unit that is connected to the display unit main body so as to be displaced as the motion sensor;
a detection unit that detects a position or displacement of the imaging unit relative to the display unit main body; and
a control unit that obtains a relative position between the display unit main body and the imaging unit by using the detection unit.

15. The display apparatus according to claim 14, further comprising:
a display processing unit that displays the content on the display unit on the basis of a captured image obtained by the imaging unit.

16. The display apparatus according to claim 15,
wherein the display processing unit adjusts a display position of the content on the basis of the relative position between the display unit main body and the imaging unit, obtained by the control unit.

17. The display apparatus according to claim 15,
wherein the display processing unit adjusts a display position of the content so as to compensate for a deviation between a central axis of a visual field of the user and an optical axis of the imaging unit on the basis of the relative position between the display unit main body and the imaging unit.

18. A control method for a display apparatus which is mounted on the head of a user, and includes a display unit that irradiates the eyes of the user with image light, and a plurality of motion sensors, the method comprising:
causing the display apparatus to obtain a motion at a movement center of the head on the basis of detection values of the plurality of motion sensors.

19. The control method for a display apparatus according to claim 18,
wherein a motion at the center of the motion is obtained on the basis of a detection value of each of the plurality of motion sensors and a position of the motion sensor.

20. The controlling method for a display apparatus, according to claim 18,
wherein the display apparatus further includes an imaging unit that is connected to a display unit main body so as to be displaced, the display unit main body being mounted on the head of the user and including the display unit, and
wherein the display apparatus obtains a relative position between the display unit main body and the imaging unit by detecting a position or displacement of the imaging unit relative to the display unit main body.
